(19) United States
(12) Patent Application Publication
(10) Pub. No.: US 2025/0045601 A1
(43) Pub. Date: Feb. 6, 2025

(54) ADAPTIVE TRAINING AND DEPLOYMENT OF COUPLED MACHINE-LEARNING AND EXPLAINABILITY PROCESSES WITHIN DISTRIBUTED COMPUTING ENVIRONMENTS

(71) Applicant: The Toronto-Dominion Bank, Toronto (CA)

(72) Inventors: Saba ZUBERI, Toronto (CA); Kin Kwan Leung, Toronto (CA); Alexander Jacob Labach, Toronto (CA); Chao Yin, Oakville (CA); Artem Burmistrv, Toronto (CA)

(21) Appl. No.: 18/793,782

(22) Filed: Aug. 3, 2024

Related U.S. Application Data
(60) Provisional application No. 63/530,925, filed on Aug. 4, 2023.

(51) Int. Cl. G06N 5/01; G06N 5/045

(52) U.S. Cl. CPC G06N 5/01; G06N 5/045

(57) ABSTRACT

The disclosed embodiments include computer-implemented systems and processes that train adaptively and deployment of coupled machine-learning and explainability processes within distributed computing environments. By way of example, an apparatus may receive first interaction data associated with a first temporal interval from a computing system. Based on an application of a first and a second trained artificial-intelligence process to an input dataset that includes at least a subset of the first interaction data, the apparatus may generate output data indicative of a predicted likelihood of an occurrence of a target event during a second temporal interval, and may generate explainability data that characterizes the predicted likelihood. The apparatus may also transmit portions the output and explainability data to the computing system, and the computing system may modify an operation of an executed application program in accordance with at least one the output or explainability data.

### CROSS-REFERENCE TO RELATED APPLICATION

This application claims the benefit of priority under 35 U.S.C. § 119 (e) to U.S. Application No. 63/530,925, filed Aug. 4, 2023, the disclosure of which is incorporated herein by reference to its entirety.

### TECHNICAL FIELD

The disclosed embodiments generally relate to computer-implemented systems and processes that facilitate an adaptive training and deployment of coupled machine-learning and explainability processes within distributed computing environments.

### BACKGROUND

Today, machine-learning processes are widely adopted throughout many organizations and enterprises, and inform both user- or customer-facing decisions and back-end decisions. Many machine-learning processes operate, however, as “black boxes,” and lack transparency regarding the importance and relative impact of certain input features, or combinations of certain input features, on the operations of these machine-learning processes and on the output generated by these machine-learning and processes.

### SUMMARY

In some examples, an apparatus includes a memory storing instructions, a communications interface, and at least one processor coupled to the memory and to the communications interface. The at least one processor is configured to execute the instructions to receive first interaction data from a computing system via the communications interface. The first interaction data is associated with a first temporal interval. The at least one processor is further configured to execute the instructions to, based on an application of a first trained artificial-intelligence process to an input dataset that includes at least a subset of the first interaction data, generate output data indicative of a predicted likelihood of an occurrence of a target event during a second temporal interval, and based on an application of a second trained artificial-intelligence process to the input dataset, generate explainability data that characterizes the predicted likelihood of the occurrence of the targeted event. The at least one processor is further configured to execute the instructions to transmit, via the communications interface, notification data that includes the output data and the explainability data to the computing system. The notification data causes the computing system to modify an operation of an executed application program in accordance with at least one of a portion of the output data or a portion of the explainability data.

In other examples, a computer-implemented method includes receiving, using at least one processor, first interaction data from a computing system. The first interaction data is associated with a first temporal interval. The computer-implemented method also includes, based on an application of a first trained artificial-intelligence process to an input dataset that includes at least a subset of the first interaction data, generating, using the at least one processor, output data indicative of a predicted likelihood of an occurrence of a target event during a second temporal interval, and based on an application of a second trained artificial-intelligence process to the input dataset, generating, using the at least one processor, explainability data that characterizes the predicted likelihood of the occurrence of the targeted event. The computer-implemented method also includes transmitting, using the at least one processor, notification data that includes the output data and the explainability data to the computing system. The notification data causes the computing system to modify an operation of an executed application program in accordance with at least one of a portion of the output data or a portion of the explainability data.

Further, in some examples, an apparatus includes a memory storing instructions, a communications interface, and at least one processor coupled to the memory and to the communications interface. The at least one processor is configured to execute the instructions to transmit interaction data to a computing system via the communications interface. The interaction data is associated with a first temporal interval. The at least one processor is further configured to execute the instructions to receive, from the computing system via the communications interface, (i) output data indicative of a predicted likelihood of an occurrence of a target event during a second temporal interval and (ii) explainability data that characterizes the predicted likelihood of the occurrence of the targeted event. The computing system generates the output data based on an application of a first trained artificial-intelligence process to an input dataset that includes at least a subset of the interaction data, and the computing system generates the explainability data based on an application of a second trained artificial-intelligence process to the input dataset. The at least one processor is configured to execute the instructions to perform operations that modify an operation of an executed application program in accordance with the portion of the output data and the explainability data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A, 1B, and 2A are block diagrams illustrating portions of an exemplary computing environment, in accordance with some exemplary embodiments.

FIG. 2B is a diagram of an exemplary timeline for adaptively training a machine-learning or artificial intelligence process, in accordance with some exemplary embodiments.

FIGS. 2C, 2D, 3A, 3B, 4A, 4B, and 5 are block diagrams illustrating additional portions of an exemplary computing environment, in accordance with some exemplary embodiments.

FIGS. 6A and 6B are flowcharts of an exemplary process for training adaptively machine-learning or artificial-intelligence processes, in accordance with some exemplary embodiments.

FIG. 7 is a flowchart of an exemplary process for applying trained, machine-learning processes and trained explainability processes to input datasets, in accordance with some exemplary embodiments.

Like reference numbers and designations in the various drawings indicate like elements.

### DETAILED DESCRIPTION

Many organizations rely on a predicted output of machine-learning processes to support and inform a variety of decisions and strategies. These organizations may include, among other things, operators of distributed and cloud-based computing environments, financial institutions, physical or digital retailers, or entities in the entertainment or loading industries. Further, in some instances, the decisions and strategies informed by the predicted output of machine-learning processes may include customer- or user-facing decisions, such as decisions associated with the provisioning of resources, products or services in response to customer- or user-specific requests, and back-end decisions, such as decisions associated with an allocation of physical, digital, or computational resources among geographically dispersed users or customers, and decisions associated with a determined use, or misuse, of these allocated resources.

These organizations, such as those described herein, often provision sets of targeted, customer-specific services to selected groups of participating customers (e.g., “participants”). By way of example, the customers of a financial institution may customers that own or operate small businesses (e.g., “small-business banking” customers), and the financial institution may target specific services (e.g., “small-business banking” services) to these small-business banking customers, such as, not limited to, a provisioning of business checking or savings accounts, a provisioning and management of secured or unsecured credit products, or a provisioning or other financial products.

In many instances, these organizations, including the financial institution, experience attrition among the participants in these targeted, customer-specific services, e.g., when one or more of the participants cease participation in the targeted, customer-specific services. For example, the attrition of these participants in the targeted, customer-specific services may be attributable to changes in corresponding national or local economic conditions. In other examples, the attrition of these participants in the targeted, customer-specific services, such as the small-business banking customers described herein, may be attributable to a limited interaction of these participants with, or a limited use, of the targeted, customer-specific services provisioned by the organization, a limited interaction between the participants and the organization across digital channels, and additionally, or alternatively, a seasonal character of the underlying interactions between the participants and the organization.

In some instances, representatives of the organizations may attempt to identify proactively one or more of the participants that are likely to cease participation in the targeted, customer-specific services, e.g., that will “attrite” from these targeted, customer-specific services during a future temporal interval. For example, the representatives may attempt to identify potentially attriting participants based on, among other things, perceived similarities between these potentially attriting participants and other participants that ceased participating in the targeted, customer-specific services, e.g., based on the subjective knowledge or experience of the representatives. These subjective processes may, in many instances, incapable of identifying often-subtle changes in a behavior of a participant, that, in real-time, would signal a likelihood of that these potentially attriting participants will cease participation in the targeted, customer-specific services during a future temporal interval, and that would enable the organizations to apply one or more treatments to reduce the likelihood of any future attrition involving these participants.

In other examples, described herein, one or more computing systems of the organization may train adaptively a machine-learning or artificial-intelligence process to predict, at a temporal prediction point, a likelihood of an occurrence of an attrition event involving a participant and a targeted service during a target, future temporal interval based on in-sample training data and out-of-sample validation data associated with a first prior temporal interval, and based on testing data associated with a second, and distinct, prior temporal interval. As described herein, and for a corresponding participant in a targeted service, an attrition event may occur when that participant ceases participation in the targeted service during the target, future temporal interval, which may be disposed subsequent to a temporal prediction point and separated from that temporal prediction point by a corresponding buffer interval (e.g., a two-month interval disposed between two and four months subsequent to the temporal prediction point). The first machine-learning or artificial-intelligence process may include an ensemble or decision-tree process, such as a gradient-boosted decision-tree process (e.g., an XGBoost process), and the training, validation, and testing data may include, but are not limited to, elements of interaction data characterizing participants in the targeted services during prior temporal intervals (e.g., the small-business banking customers of the financial institution that participate in the provisioned, small-business banking services).

Further, in some examples, the one or more computing systems of the organization may also train adaptively a second machine-learning or artificial-intelligence process to generate elements of explainability data that characterize the predicted likelihood of an occurrence of an attrition event involving the participant and the targeted service during the target, future temporal interval based on, among other things, contribution values that characterize a relative importance of one or more feature values to the predicted output of the trained, first machine-learning or artificial-intelligence process. In some instances, the contribution values may include Shapley values, which may be generated during the adaptive training of the first machine-learning or artificial-intelligence process using any of the exemplary processes described herein. The second machine-learning or artificial-intelligence process may, in some instances, include an unsupervised machine-learning process, such as a clustering process, and based on an output of the trained clustering process may facilitate an assignment of the participant to one or a plurality of clustered groups characterized by descriptive, and interpretable, feature values or ranges of feature values.

Through a performance of the exemplary processes described herein, the one or more computing systems of the organization may perform operations that (i) generate elements of predictive output that characterize an expected likelihood of an occurrence of a target event involving corresponding ones of the participants (e.g., the organization—specific attrition event described herein) during the future temporal interval based on the application of the trained, first machine-learning or artificial-intelligence process to corresponding element elements of the input data; and that (iii) assign at least the subset of the participants associated with likely occurrences of the future target events to clustered groups associated with descriptive, and interpretable, contribution values or ranges of contribution values based on the application of the trained, second machine-learning or artificial-intelligence process to feature values of the corresponding elements of the input data. In some instances, described herein, data characterizing the assigned, clustered groups and characterizing the descriptive, and interpretable, feature values or ranges of future values may, when provisioned to a computing system of an organization, facilitate a programmatic modification of an operation of one or more applications programs executed at the computing system, and an enhanced programmatic communication between the executed application program and devices operable by corresponding ones of the participants, which may reduce the likelihood of the occurrence of attrition events involving these participants. These exemplary processes may, for example, be implemented in addition to, or as alternative to, existing processes through which the one or more computing systems of the organizations identify potentially attriting participants based on experience-based, subjective processes or based on fixed, rules-based processes.

### A. Exemplary Processes for Adaptively Training Coupled Machine-Learning or Artificial-Intelligence Processes in a Distributed Computing Environment

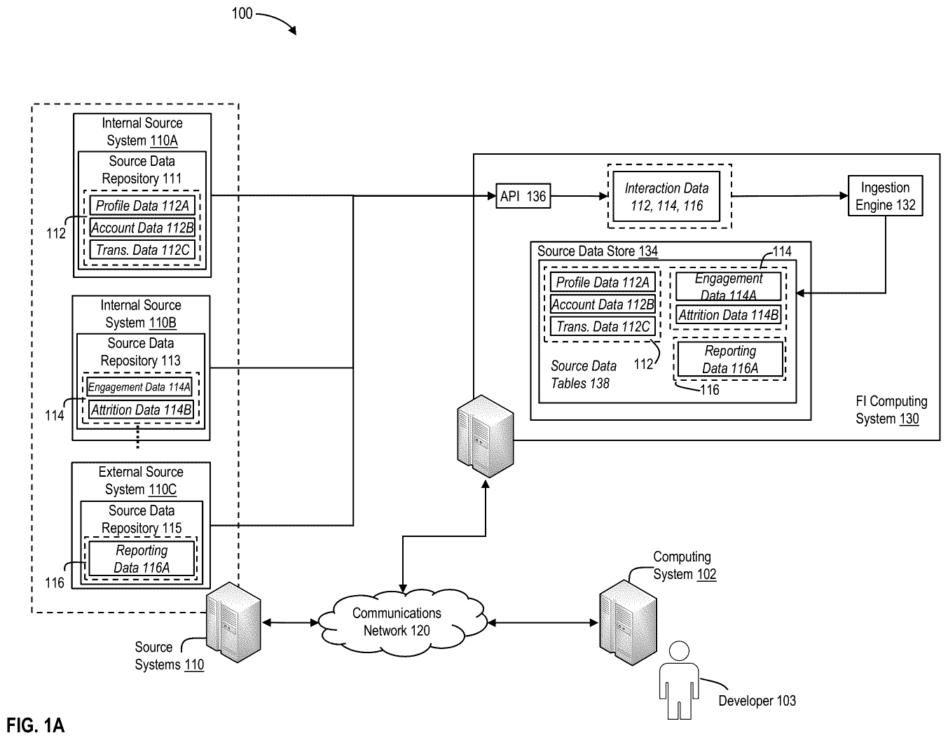

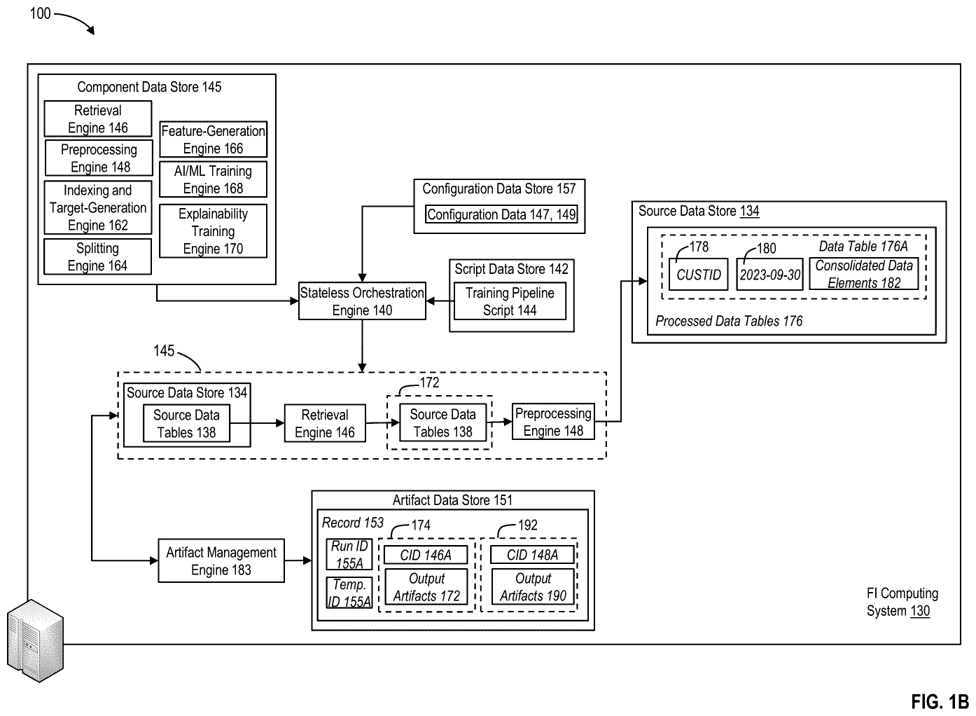

FIG. 1A illustrates components of an exemplary computing environment 100, in accordance with some exemplary embodiments. For example, as illustrated in FIG. 1A, environment 100 may include one or more source systems 110, such as, but not limited to, source system 110A, source system 110B, and source system 110C and a computing system associated with, or operable by, an organization or an enterprise, such as developer system 102 and computing system 130. In some instances, each of source systems 110 (including source systems 110A, 110B, and source system 110C), and computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Developer system 102 may include a computing system or device having one or more tangible, non-transitory memories that store data and/or software instructions, and one or more processors configured to execute the software instructions. For example, the one or more tangible, non-transitory memories may store one or more software applications, application engines, and other elements of code executable by one or more processor(s) 106, such as, but not limited to, an executable web browser 108 (e.g., Google Chrome™, Apple Safari™, etc.) capable of interacting with one or more web servers established programmatically by computing system 130. By way of example, and upon execution by the one or more processors, the web browser may interact programmatically with the one or more web servers of computing system 130 via a web-based interactive computational environment, such as a Juypter™ notebook or a Databricks™ notebook. Developer system 102 may also include a display device configured to present interface elements to a corresponding user, such as a developer 103, and an input device configured to receive input from developer 103, e.g., in response to the interface elements presented through the display device. Developer system 102 may also include a communications interface, such as a wireless transceiver device, coupled to the one or more processors and configured by the one or more processors to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Each of source systems 110 (including source systems 110A, 110B, and 110C) and computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of source systems 110 (including source systems 110A, 110B, and 110C) and computing system 130 may also include a communications interface, such as one or more wireless transceivers, coupled to the one or more processors for accommodating wired or wireless internet communication with other computing systems and devices operating within environment 100.

Further, in some instances, source systems 110 (including source systems 110A, 110B, and 110C) and computing system 130 may each be incorporated into a respective, discrete computing system. In additional, or alternate, instances, one or more of source systems 110 (including source systems 110A, 110B, and 110C) and computing system 130 may correspond to a distributed computing system having a plurality of interconnected, computing components distributed across an appropriate computing network, such as communications network 120 of FIG. 1. Computing system 130 may also correspond to a distributed or cloud-based computing cluster associated with, and maintained by, the organization or enterprise, although in other examples, computing system 130 may correspond to a publicly accessible, distributed or cloud-based computing cluster, such as a computing cluster maintained by Microsoft Azure™, Amazon Web Services™, Google Cloud™, or another third-party provider.

For example, computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Through an implementation of the parallelized, fault-tolerant distributed computing and analytical protocols described herein, the distributed computing components of computing system 130 may perform any of the exemplary processes described herein, in accordance with a predetermined temporal schedule, to ingest elements of source data associated with, and characterizing, customers of the organization or enterprise and corresponding attrition events involving these customers and corresponding products or services provisioned by the organization or enterprise, and to store the source data tables within an accessible data repository, e.g., as source data tables within a portion of a distributed file system, such as a Hadoop distributed file system (HDFS). Further, and through an implementation of the parallelized, fault-tolerant distributed computing and analytical protocols described herein, the distributed or cloud-based computing components of computing system 130 may perform any of the exemplary processes described herein to implement a generalized and modular computational framework that facilitates an end-to-end training, validation, and deployment of an artificial-intelligence or machine-learning processes based on a sequential execution of application engines in accordance with established, and in some instances, configurable, pipeline-specific scripts.

The executable, and configurable, pipeline-specific scripts may include, but are not limited to, executable scripts that establish a training pipeline of a first, sequentially executed subset of the application engines (e.g., a training pipeline script) and an inferencing pipeline of a second, sequentially executed subset of the application engines (e.g., an inferencing pipeline script). By way of example, the one or more processors of computing system 130 may execute one or more application programs, such as an orchestration engine (not illustrated in FIG. 1A), that establishes the training pipeline and triggers a sequential execution of each of the first subset of the application engines in accordance with the training pipeline script. In some instances, the execution of the first subset of the application engines in accordance with the training pipeline script may cause the distributed computing components of computing system 130 to perform any of the exemplary processes described herein to adaptively train a first machine-learning or artificial-intelligence process to predict, for one or more customers of the organization, a likelihood of an occurrence of a target event during a predetermined, future temporal interval (e.g., an occurrence of an attrition event, as described herein), and to adaptively train a second, and coupled, machine-learning or artificial-intelligence process to assign at least a subset of the customers associated with likely occurrences of the future target events to clustered groups associated with descriptive, and interpretable, contribution values or ranges of contribution values, e.g., based on descriptive, and interpretable, explainability data characterizing an output of the trained first machine-learning or artificial-intelligence process.

Further, the executed orchestration engine may also establish the inferencing pipeline and trigger a sequential execution of each of the second subset of the application engines by the one or more processors of computing system 130 and in accordance with an inferencing pipeline script. In some instances, the execution of the first subset of the application engines in accordance with the training pipeline script may cause the distributed computing components of computing system 130 to perform any of the exemplary processes described herein to: (i) generate, for corresponding ones of the customers of the organization, elements of input data consistent with one or more customized feature-engineering operations; (ii) generate elements of predictive output that characterize an expected likelihood of an occurrence of a targeted event involving corresponding ones of the customers (e.g., the attrition event described herein) during the future temporal interval based on the application of the trained, first machine-learning or artificial-intelligence process to corresponding element elements of the input data; and (iii) assign at least the subset of the customers associated with likely occurrences of the future target events to clustered groups associated with descriptive, and interpretable, feature values or ranges of feature values based on the application of the trained, second machine-learning or artificial-intelligence process to feature values of the corresponding elements of the input data.

In some examples, upon completion of the sequential execution of the second subset of the application engines by the one or more processors of computing system 130 within the established inferencing pipeline, the one or more processors of computing system 130 may perform operations, described herein, that provision the generated elements of predictive output for at least the subset of the customers, and data characterizing the clustered groups (e.g., the descriptive, and interpretable, feature values or ranges of feature values, etc.) assigned to the subset of the customers, to an additional computing system associated with the organization. For instance, the additional computing system may receive the elements of predictive output and the data characterizing the assigned, clustered groups across network 120 via a programmatic channel of communications established between computing system 130 and an application program executed by the additional computing system, and the elements of predictive output and the data characterizing the assigned, clustered groups may cause one or more processors of the additional computing system to modify an operation of the executed application program, e.g., to facilitate a proactive and programmatic engagement with computing systems or devices operable by these customers in accordance with the elements of predictive output and the assigned, clustered groups.

To facilitate a performance of one or more of the exemplary processes described herein, a data ingestion engine 132 executed by the one or more processors of computing system 130 may cause computing system 130 to establish a secure, programmatic channel of communications with one or more of source systems 110 (e.g., source systems 110A, 110B, and 110C) across network 120, and to perform operations that obtain elements of source data maintained by the one or more of source systems 110, and that to store the obtained source data elements within an accessible data repository (e.g., as source data tables within a portion of a distributed file system, such as a Hadoop distributed file system (HDFS)), in accordance with a predetermined, temporal schedule (e.g., on a daily basis, a weekly basis, a monthly basis, etc.) or on a continuous, streaming basis.

As illustrated in FIG. 1A, each of source systems 110 may maintain, within corresponding tangible, non-transitory memories, a data repository that includes elements of source data associated with, and characterizing, customers of the organization, interactions between these customers and the organization (e.g., across various digital channels of interactions, such as web pages or mobile applications), and corresponding attrition events involving these customers and corresponding products or services provisioned by the organization. The organization may, for instance, correspond to a financial institution, and the customers of the organization may include one or more customers that own or operate of small businesses (e.g., “small-business banking” customers), and that participate in one or more small-business banking services provisioned by the financial institution. As described herein, examples of these small-business banking services may include, but are not limited to, a provisioning of business checking or savings accounts, a provisioning and management of secured or unsecured credit products, or a provisioning or other financial products.

In some instances, source system 110A may be associated with or operated by the organization and may maintain, within the one or more tangible, non-transitory memories, a source data repository 111 that includes elements of interaction data 112 associated with, and characterizing, the customers of the organization. For example, the elements of interaction data 112 may include, include, but are not limited to, profile data 112A, account data 112B, and transaction data 112C that maintain discrete data tables that identify and characterize corresponding ones of the customers of the organization, such as, but not limited to, the small-business customers of the financial institution described herein.

By way of example, and for a particular one of the customers, the data tables of profile data 112A may maintain, among other things, one or more unique customer identifiers (e.g., an alphanumeric character string, such as a login credential, a customer name, etc.), residence data (e.g., a street address, a postal code, one or more elements of global positioning system (GPS) data, etc.), other elements of contact data associated with the particular customer (e.g., a mobile number, an email address, etc.). Further, account data 112B may also include a plurality of data tables that identify and characterize one or more financial products or financial instruments issued by the financial institution to corresponding ones of the customers, such as, but not limited to, small-business savings accounts, small-business deposit accounts, or secured or unsecured credit products (e.g., small-business credit card accounts or lines-of-credit) provisioned to a corresponding, small-business customer by the financial institution.

For example, the data tables of account data 112B may maintain, for each of the financial products or instruments issued to corresponding ones of the customers, one or more identifiers of the financial product or instrument (e.g., an account number, expiration data, card-security-code, etc.), one or more unique customer identifiers (e.g., an alphanumeric character string, such as a login credential, a customer name, etc.), information identifying a product type that characterizes the financial product or instrument, and additional information characterizing a balance or current status of the financial product or instrument (e.g., payment due dates or amounts, delinquent accounts statuses, etc.).

Transaction data 112C may include data tables that identify, and characterize one or more initiated, settled, or cleared transactions involving respective ones of the customers and corresponding ones of the financial products or instruments. For instance, and for a particular transaction involving a corresponding customer and corresponding financial product or instrument, the data tables of transaction data 112C may include, but are limited to, a customer identifier associated with the corresponding customer (e.g., the alphanumeric character string described herein, etc.), a counterparty identifier associated with a counterparty to the particular transaction (e.g., a counterparty name, a counterparty identifier, etc.); an identifier of a financial product or instrument involved in the particular transaction and held by the corresponding customer (e.g., a portion of a tokenized or actual account number, bank routing number, an expiration date, a card security code, etc.), and values of one or more parameters that characterize the particular transaction. In some instances, the transaction parameters may include, but are not limited, to a transaction amount, associated with the particular transaction, a transaction date or time, an identifier of one or more products or services involved in the purchase transaction (e.g., a product name, etc.), or additional counterparty information.

Further, as illustrated in FIG. 1A, source system 110B may also be associated with, or operated by, the organization, and may maintain, within the corresponding one or more tangible, non-transitory memories, a source data repository 113 that includes one or more additional elements of interaction data 114, which may include engagement data 114A and attrition data 114B. In some instances, engagement data 114A may include one or more data tables maintaining data that identifies and characterizes an engagement of customers with the organization via corresponding digital channels of engagement (e.g., via web-based interfaces, via mobile applications, etc.), via corresponding voice-based channels of engagement (e.g., via interaction with a call center, etc.), or via in-person interactions (e.g., via in-person visits to a physical branch of the financial institution, etc.).

Each of the data tables of engagement data 114A may be associated with a corresponding one of the customers (e.g., a small-business customer of the financial institution, as described herein) and with a corresponding engagement between that customer and the organization (e.g., the financial institution, as described herein). For example, and for a particular one of the customers, the data tables of engagement data 114A may include a unique identifier of the particular customer (e.g., an alphanumeric identifier or login credential, a customer name, etc.), data characterizing an engagement type of the corresponding engagement (e.g., digital, telephone, or in-person engagement, etc.), temporal data characterizing the corresponding engagement of the particular customer with the organization (e.g., a time or date of the corresponding engagement, a duration of the corresponding engagement, etc.) and/or additional information that characterizes the corresponding engagement of the particular customer with the organization (e.g., a type of digital engagement, such as a web-based interface or a mobile application, etc.).

Further, attrition data 114B may include one or more data tables that identify and characterize occurrences of attrition events associated with current or prior customers of the organization, such as, but not limited to, current or prior small-business customers of the financial institution. As described herein, each attrition event may be associated with, and involve, a corresponding customer of the organization and with one more provisioned services, and each attrition event may be associated with a corresponding attrition date (e.g., a date on which the corresponding customer ceases participating in, or “attrites” from, the one more provisioned services). By way of example, an attrition event involving a small-business customer of the financial institution may occur when that small-business customer ceases participation in one or more of the small-business banking services provisioned to that small-business banking customer by the financial institution, e.g., on a corresponding attrition date. In some instances, each of the data tables of attrition data 114B may be associated with a corresponding occurrence of an attrition event, and may maintain, for that corresponding attrition event, a unique identifier of a customer involved in the corresponding occurrence of the attrition event (e.g., an alphanumeric identifier or login credential, a customer name, etc.), a temporal data characterizing the corresponding occurrence of the attrition event and/or a duration of the relationship between the customer and the organization (e.g., an attrition date, a relationship duration in days or months, etc.), and data characterizing the one or more provisioned services involved in the attrition event (e.g., the one or more small-business banking services described herein, etc.).

Source system 110C may be associated with, or operated by, one or more judicial, regulatory, governmental, or reporting entities external to, and unrelated to, the organization, and source system 110C may maintain, within the corresponding one or more tangible, non-transitory memories, a source data repository 115 that includes one or more elements of interaction data 116. By way of example, source system 110C may be associated with, or operated by, a reporting entity, such as a credit bureau, and interaction data 116 may include reporting data 116A that identifies and characterizes corresponding customers of the organization, such as elements of credit-bureau data characterizing the small-business customers of the financial institution. The disclosed embodiments are, however, not limited to these exemplary elements of interaction data 116, and in other instances, interaction data 116 may include any additional or alternate elements of data associated with the customer and generated by the judicial, regulatory, governmental, or regulatory entities.

As described herein, computing system 130 may perform operations that establish and maintain one or more centralized data repositories within a corresponding ones of the tangible, non-transitory memories. For example, as illustrated in FIG. 1A, computing system 130 may establish an source data store 134, which maintains, among other things, elements of the profile, account, transaction, engagement, attrition, and/or reporting data associated with one or more of the customers of the organization, which may be ingested by computing system 130 (e.g., from one or more of source systems 110) using any of the exemplary processes described herein.

For instance, computing system 130 may execute one or more application programs, elements of code, or code modules, such as ingestion engine 132, that, in conjunction with the corresponding communications interface, cause computing system 130 to establish a secure, programmatic channel of communication with each of source systems 110 (including source systems 110A, 110B, and 110C) across communications network 120, and to perform operations that access and obtain all, or a selected portion, of the elements of profile, account, transaction, engagement, attrition, and/or reporting data maintained by corresponding ones of source systems 110. As illustrated in FIG. 1A, source system 110A may perform operations that obtain all, or a selected portion, of interaction data 112, including the data tables of profile data 112A, account data 112B, and transaction data 112C, from source data repository 111, and transmit the obtained portions of interaction data 112 across communications network 120 to computing system 130. Further, source system 110B may also perform operations that obtain all, or a selected portion, of interaction data 114, including the data tables of engagement data 114A and attrition data 114B, from source data repository 113, and transmit the obtained portions of interaction data 114 across communications network 120 to computing system 130. Additionally, in some instances, source system 110C may also perform operations that obtain all, or a selected portion, of interaction data 116, including the data tables of reporting data 116A, from source data repository 115, and transmit the obtained portions of interaction data 116 across communications network 120 to computing system 130.

A programmatic interface established and maintained by computing system 130, such as application programming interface (API) 136, may receive the portions of interaction data 112, 114, and 116, and as illustrated in FIG. 1A, API 136 may route the portions of interaction data 112 (including the data tables of profile data 112A, account data 112B, and transaction data 112C), interaction data 114 (including the data tables of engagement data 114A and attrition data 114B), and interaction data 116 (including the data tables of reporting data 116A) to executed data ingestion engine 132. In some instances, the portions of interaction data 112, 114, and 116 may be encrypted, and executed data ingestion engine 132 may perform operations that decrypt each of the encrypted portions of interaction data 112, 114, and 116 using a corresponding decryption key, e.g., a private cryptographic key associated with computing system 130.

Executed data ingestion engine 132 may also perform operations that store the portions of interaction data 112 (including the data tables of profile data 112A, account data 112B, and transaction data 112C), interaction data 114 (including the data tables of engagement data 114A and attrition data 114B), and interaction data 116 (including the data tables of reporting data 116A) within source data store 134, e.g., as source data tables 138. Further, although not illustrated in FIG. 1A, source data store 134 may also store one or more additional source data tables associated with corresponding ones of the customers of the organization (e.g., the small-business banking customers of the financial institution, as described herein, etc.), which may be ingested by executed data ingestion engine 132 during one or more prior temporal intervals. In some instances, executed data ingestion engine 132 may perform one or more synchronization operations (not illustrated in FIG. 1A), that merge one or more of source data tables 138 with the previously ingested source data tables, and that eliminate any duplicate tables existing among the one or more of source data tables 138 with the previously ingested source data tables (e.g., through an invocation of an appropriate Java-based SQL “merge” command).

Further, and to facilitate an implementation of the generalized and modular computational framework, which facilitates the end-to-end training, validation, and deployment of the artificial-intelligence or machine-learning process and the coupled, clustering-based explainability process described herein, the one or more processors of computing system 130 may access and execute a stateless execution engine, such as orchestration engine 140. In some instances, upon execution by the one or more processors of computing system 130, executed orchestration engine 140 may access a script data store 142 maintained within the one or more tangible, non-transitory memories of computing system 130 and obtain training pipeline script 144.

Training pipeline script 144 may, for example, be maintained in a Python™ format within script data store 142, and training pipeline script 144 may specify an order of sequential execution of each of a plurality of application engines (e.g., the first subset described herein), which may establish a corresponding “training pipeline” of sequentially executed application engines within the generalized and modular computational framework described herein. By way of example, the training pipeline may include a retrieval engine 146, a preprocessing engine 148, an indexing and target-generation engine 162, a splitting engine 164, a feature-generation engine 166, an AI/ML training engine 168, and an explainability training engine 170, which may be maintained with corresponding portions of the one or more tangible, non-transitory memories of computing system 130 (e.g., within component data store 145), and which may be executed sequentially by the one or more processors of computing system 130 in accordance with the execution flow of the training pipeline (e.g., as specified by training pipeline script 144). Training pipeline script 144 may also include, for each of the sequentially executed application engines, data identifying corresponding elements of engine-specific configuration data, one or more input artifacts ingested by the sequentially executed application engine, and additionally, or alternatively, one or more output artifacts generated by the sequentially executed application engines.

In some instances, executed orchestration engine 140 may trigger an execution of training pipeline script 144 by the one or more processors of computing system 130, which may establish the training pipeline, e.g., training pipeline 145. Upon execution of training pipeline script 144, and establishment of training pipeline 145, executed orchestration engine 140 may generate a unique, alphanumeric identifier, e.g., run identifier 155A, for a current implementation, or “run,” of training pipeline 145, and executed orchestration engine 140 may provision run identifier 155A to an artifact management engine 183 executed by the one or more processors of computing system 130, e.g., via a corresponding programmatic interface, such as an artifact application programming interface (API). Executed artifact management engine 183 may perform operations that, based on run identifier 155A, associate a data record 153 of an artifact data store 151 (e.g., maintained within the one or more tangible, non-transitory memories of computing system 130) with the current run of training pipeline 145, and that store run identifier 155A within data record 153 along with a temporal identifier 164B indicative of a date om which executed orchestration engine 140 established training pipeline 145 (e.g., on Aug. 31, 2024).

In some instances, upon execution by the one or more processors of computing system 130, each of retrieval engine 146, preprocessing engine 148, indexing and target-generation engine 162, splitting engine 164, feature-generation engine 166, AI/ML training engine 168, and explainability training engine 170 may ingest one or more input artifacts and corresponding elements of configuration data specified within executed training pipeline script 144, and may generate one or more output artifacts. In some instances, executed artifact management engine 183 may obtain the output artifacts generated by corresponding ones of executed retrieval engine 146, preprocessing engine 148, indexing and target-generation engine 162, splitting engine 164, feature-generation engine 166, AI/ML training engine 168, and explainability training engine 170, and store the obtained output artifacts within portions of data record 153, e.g., in conjunction within a unique, alphanumeric component identifier.

Further, in some instances, executed artifact management engine 183 may also maintain, in conjunction with the component identifier and corresponding output artifacts within data record 153, data characterizing input artifacts ingested by one, or more, of executed retrieval engine 146, preprocessing engine 148, indexing and target-generation engine 162, splitting engine 164, feature-generation engine 166, AI/ML training engine 168, and explainability training engine 170. The inclusion of the data characterizing the input artifacts ingested by a corresponding one of these executed application engines within training pipeline 145, and the association of the data characterizing the ingested input artifacts with the corresponding component identifier and run identifier 155A, may establish an artifact lineage that facilitates an audit of a provenance of an artifact ingested by the corresponding one of the executed application engines during the current implementation of run of training pipeline 145 (e.g., associated with run identifier 155A), and recursive tracking of the generation or ingestion of that artifact across the current run of training pipeline 145 (e.g., associated with run identifier 155A) and one or more prior runs of training pipeline 145 (or of the default inferencing and target-generation pipelines described herein).

Referring back to FIG. 1B, executed training pipeline script 144 may trigger an execution of retrieval engine 146 by the one or more one or more processors of computing system 130, and orchestration engine 140 may provision, to a programmatic interface associated with executed retrieval engine 146 (e.g., as input artifacts, one or more elements of configuration data 147 maintained within the one or more tangible, non-transitory memories of computing system 130, e.g., within configuration data store 157. In some instances, the programmatic interface may perform operations that establish a consistency of the ingested input artifacts with one or more engine- and pipeline-specific operational constraints. Based on an established consistency of the input artifacts with the imposed engine- and pipeline-specific operational constraints, executed retrieval engine 146 may obtain, from the elements of configuration data 147, the unique identifier of all, or a selected subset, of source data tables 138, the primary key or composite primary key of each of the source data tables (e.g., the unique customer identifiers described herein), and the network address of an accessible data repository that maintains each of the source data tables, such as, but not limited to, source data store 134. Executed retrieval engine 146 may access source data store 134, and obtain the one or more of source data tables 138 based on the obtained identifiers and on the network address of source data store 134.

In some instances, executed retrieval engine 146 may perform operations that provision source data tables 138, or the identifiers of source data tables 138 (e.g., an alphanumeric file name or a file path, etc.) to executed artifact management engine 183, e.g., as output artifacts 172 of executed retrieval engine 146. Executed artifact management engine 183 may receive each of output artifacts 172 via the artifact API, and may package each of output artifacts 172 into a corresponding portion of retrieval artifact data 307, along with a unique, alphanumeric component identifier 156A of executed retrieval engine 146, and executed artifact management engine 183 may store retrieval artifact data 174 within a corresponding portion of artifact data store 151, e.g., within data record 153 associated with training pipeline 145 and run identifier 155A.

Further, and in accordance with training pipeline 145, executed retrieval engine 146 may provide output artifacts 172, including source data tables 138, as inputs to preprocessing engine 148 executed by the one or more processors of computing system 130, and executed orchestration engine 140 may provision one or more elements of configuration data 149 maintained within configuration data store 157 to executed preprocessing engine 158, e.g., in accordance with executed training pipeline script 150. A programmatic interface associated with executed preprocessing engine 148 may, for example, ingest each of source data tables 138 and the elements of preprocessing configuration data 159 (e.g., as corresponding input artifacts), and may perform any of the exemplary processes described herein to establish a consistency of the corresponding input artifacts with one or more imposed engine- and pipeline-specific operational constraints.

Based on an established consistency of the input artifacts with the imposed engine- and pipeline-specific operational constraints, executed preprocessing engine 148 may perform operations that apply one or more preprocessing operations to corresponding ones of source data tables 138 in accordance with the elements of preprocessing configuration data 149 (e.g., through an execution or invocation of each of the helper scripts within the namespace of executed preprocessing engine 158, etc.). Examples of these preprocessing operations may include, but are not limited to, a temporal or customer-specific filtration operation, a table flattening or de-normalizing operation, and a table joining operation (e.g., an inner- or outer-join operations, etc.). Further, and based on the application of each of the default preprocessing operations to source data tables 138, executed preprocessing engine 158 may also generate processed data tables 176 having customer and/or temporal identifiers, and structures or formats, consistent with the identifiers, and structures or formats, specified within the elements of preprocessing configuration data 159. In some instances, each of processed data tables 176 may characterize corresponding ones of the customers of the organization (e.g., the small-business banking customers of the financial institution, as described herein, etc.), their interactions with the organization and with other related or unrelated organizations, and any associated attrition events during a corresponding temporal interval associated with the ingestion of interaction data 112, 114, and 116.

As described herein, each of source data tables 138 may include an identifier of corresponding customer of the organization, such as a customer name or an alphanumeric character string. In some instances, the identifier of the corresponding customer (e.g., the customer name, etc.) specified within one or more of source data tables 138 may differ from a customer identifier assigned to the corresponding customer by computing system 130 (and the organization). In view of these potential discrepancies, executed preprocessing engine 148 may access each of source data tables 138, and may perform operations that, for each of source data tables 138, determine whether the specified identifier of the corresponding customer is consistent with, and corresponds to, the customer identifier assigned to the corresponding customer by computing system 130, e.g., as specified within the elements of configuration data 149. If, for example, executed preprocessing engine 148 were to establish a discrepancy between the specified and assigned customer identifiers within a corresponding one of source data tables 138, executed preprocessing engine 148 may perform operations that replace the specified identifier (e.g., the customer name) within the corresponding one of source data tables 138 within the assigned identifier of the corresponding customer, e.g., as specified within the elements of configuration data 149.

Executed preprocessing engine 148 may also perform operations that assign, to each of source data tables 138, a temporal identifier to each of the accessed data records, and that augment each of the source data tables 138 to include the newly assigned temporal identifier. In some instances, the temporal identifier may associate each of source data tables 138 with a corresponding temporal interval, which may be indicative of reflect a regularity or a frequency at which computing system 130 ingests data from corresponding ones of source systems 110. For example, executed data ingestion engine 132 may receive elements of data from corresponding ones of source systems 110 on a monthly basis (e.g., on the final day of the month), and in particular, may receive and store the elements of interaction data 112, 114, and 116 from corresponding ones of source systems 110 on Jun. 30, 2024. In some instances, executed preprocessing engine 148 may generate a temporal identifier associated with the regular, monthly ingestion of interaction data 112, 114, and 116 on Jun. 30, 2024 (e.g., “2024 Jun. 30”), and may augment source data tables 138 to include the generated temporal identifier.

In some instances, executed preprocessing engine 148 may perform further operations that, for a particular customer of the organization during the temporal interval (e.g., represented by a pair of the customer and temporal identifiers described herein), obtain one or more data tables of profile data 112A, account data 112B, transaction data 112C, engagement data 114A, attrition data 114B, and reporting data 116A that include the pair of customer and temporal identifiers. Executed preprocessing engine 148 may perform operations that consolidate the one or more obtained data tables and generate a corresponding one of processed data tables 176 that includes the customer identifier and temporal identifier, and that is associated with, and characterizes, the particular customer of the financial institution across the temporal interval. By way of example, executed preprocessing engine 148 may consolidate the obtained data records, which include the pair of customer and temporal identifiers, through an invocation of an appropriate Java-based SQL “join” command (e.g., an appropriate “inner” or “outer” join command, etc.).

Further, executed preprocessing engine 148 may perform any of the exemplary processes described herein to generate another one of processed data tables 176 for each additional, or alternate, customer of the organization during the temporal interval (e.g., as represented by a corresponding customer identifier and the temporal interval). Executed preprocessing engine 148 may perform operations that store each of processed data tables 176 within the one or more tangible, non-transitory memories of computing system 130, e.g., within a portion of source data store 134.

In some instances, and as described herein, processed data tables 176 may include a plurality of discrete data tables, and each of these discrete data tables may be associated with, and may maintain data characterizing, a corresponding one of the customers of the financial institution during the corresponding temporal interval (e.g., a month-long interval extending from Jun. 1, 2024, to Jun. 30, 2024). For example, and for a particular customer, discrete data table 176A of processed data tables 176 may include a customer identifier 178 of the particular customer (e.g., an alphanumeric character string “CUSTID”), a temporal identifier 180 of the corresponding temporal interval (e.g., a numerical string “2024 Jun. 30”), and consolidated data elements 182 of profile, account, transaction, engagement, attrition, and/or reporting data associated with the particular customer during the corresponding temporal interval (e.g., as consolidated from the data records of profile data 112A, account data 112B, transaction data 112C, engagement data 114A, attrition data 114B, and/or reporting data 116A ingested by computing system 130 on Jun. 30, 2024).

Further, in some instances, source data store 134 may maintain each of processed data tables 176, which characterize corresponding ones of the customers, their interactions with the organization and with other related or unrelated organizations, and any associated attrition events involving the corresponding customers and provisioned services during the temporal interval, in conjunction with additional consolidated data records 152. Further, in some examples, processed data tables 176 may include the additional processed data tables associated with customer-specific elements of profile, account, transaction, engagement, attrition, and reporting data ingested from source systems 110 during the corresponding prior temporal intervals (not illustrated in FIG. 1B).

In some instances, executed preprocessing engine 148 may perform operations that provision processed data tables 176, or the identifiers of processed data tables 176 (e.g., an alphanumeric file name or a file path within source data store 134, etc.) to executed artifact management engine 183, e.g., as output artifacts 190 of executed preprocessing engine 148. Executed artifact management engine 183 may receive of output artifacts 190 via the artifact API, and may package each of output artifacts 190 into a corresponding portion of preprocessing artifact data 192, along with a unique, alphanumeric component identifier 148A of executed preprocessing engine 148, and executed artifact management engine 183 may store preprocessing artifact data 192 within a corresponding portion of artifact data store 151, e.g., within data record 153 associated with training pipeline 145 and run identifier 155A. Further, although not illustrated in FIG. 1B, executed artifact management engine 183 may also package, into a corresponding portion of preprocessing artifact data 192, additional data identifying and characterizing one or more of the input artifacts ingested by executed preprocessing engine 148, such as, but not limited to, the elements of configuration data 149.

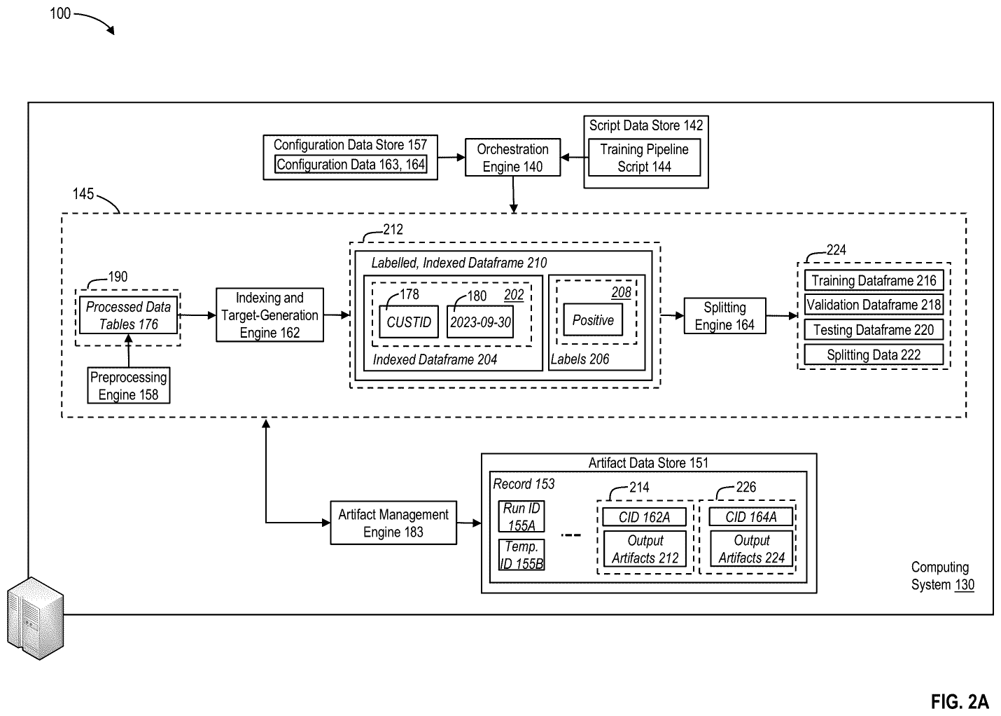

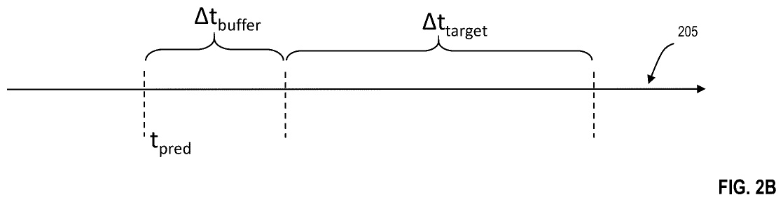

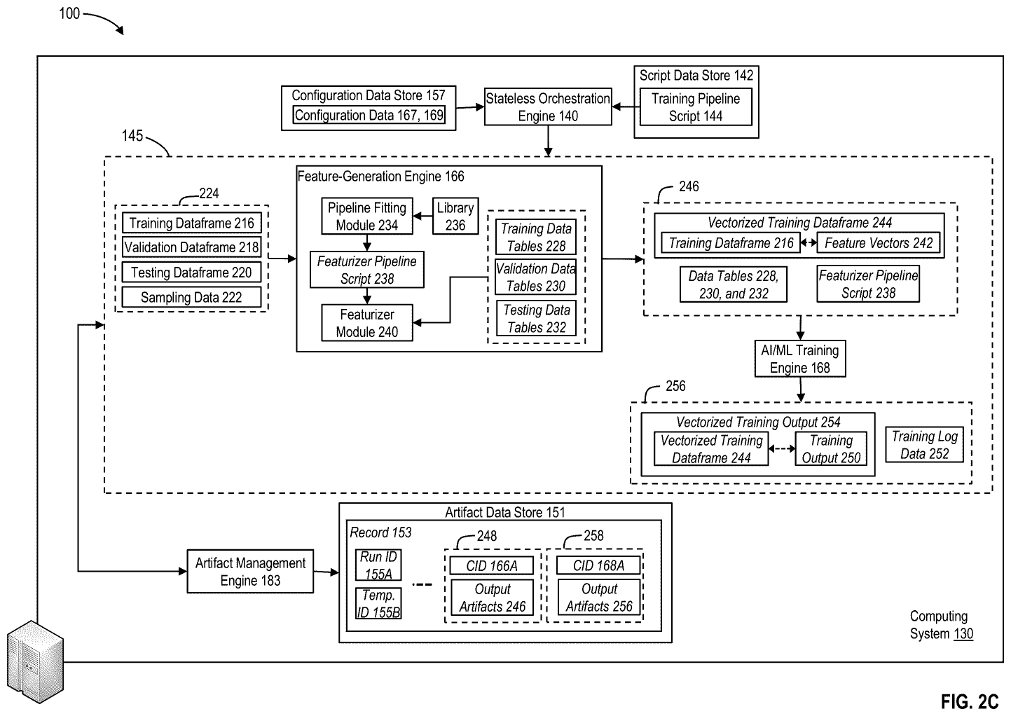

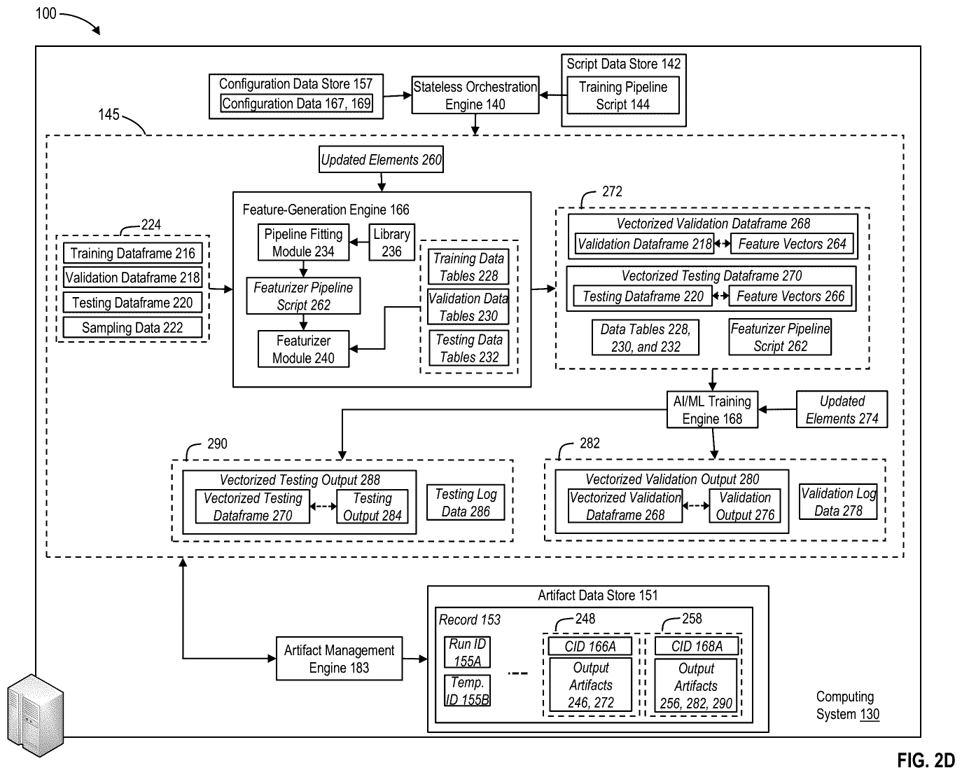

Referring to FIG. 2A, executed preprocessing engine 148 may provide output artifacts 190, including processed data tables 176 and/or or the identifiers of processed data tables 176 (e.g., an alphanumeric file name or a file path within source data store 134, etc.), as inputs to indexing and target-generation engine 162 executed by the one or more processors of computing system 130. In some instances, a programmatic interface associated with executed indexing and target-generation engine 162 may receive processed data tables 176 and/or and the elements of configuration data 163 (e.g., as corresponding input artifacts), and may perform any of the exemplary processes described herein to establish a consistency of the corresponding input artifacts with the engine- and pipeline specific operational constraints imposed on executed indexing and target-generation engine 162.

Based on an established consistency of the input artifacts with the imposed engine- and pipeline-specific operational constraints, executed indexing and target-generation engine 162 may perform operations, consistent with the elements of configuration data 163, that access each of processed data tables 176, select one or more columns from each of the each of processed data tables 176 that are consistent with the corresponding primary key (or composite primary key), and generate an indexed dataframe that includes the entries of each of the selected columns. Further, and based on the established consistency of the input artifacts with the imposed engine- and pipeline-specific operational constraints, executed indexing and target-generation engine 162 may perform additional operations, consistent with the elements of configuration data 163, that generate ground-truth labels associated with corresponding rows of the indexed dataframe and with corresponding ones of processed data tables 176, and that append each of the ground-truth labels to a corresponding row of the indexed data, e.g., to generate a labeled indexed dataframe.

In some instances, elements of configuration data 163 may include, among other things, an identifier of each of the processed data tables 176, one or more primary or composite primary keys of each of processed data tables 176, data specifying a format or structure of the indexed dataframe generated by executed indexing and target-generation engine 162, and data specifying one or more one or more constraints imposed on the indexed dataframe, such as a column-specific uniqueness constraint (e.g., a SQL UNIQUE constraint). Further, and as described herein, the indexed dataframe may include a plurality of discrete rows populated with corresponding ones of the entries of each of the selected columns, e.g., the values of corresponding ones of the primary keys (or composite primary keys) obtained from each of processed data tables 176.

For example, the primary keys (or composite primary keys) specified within the elements of configuration data 163 may include, but are not limited to, a unique, alphanumeric identifier assigned to the corresponding customers by the organization or enterprise, and temporal data, such as a timestamp, associated with a corresponding one of processed data tables 176. In some instances, executed indexing and target-generation engine 162 may perform operations that access a corresponding one of processed data tables 176, such as processed data table 176A, and that obtain, from corresponding columns of processed data table 176A, customer identifier 178 (e.g., “CUSTID”) and temporal identifier 180 (e.g., “2024 Jun. 30”). As illustrated in FIG. 2B, executed indexing and target-generation engine 162 may package customer identifier 178 and temporal identifier 180 (e.g., the primary keys specified within the elements of configuration data 163) into corresponding columns of a row 202 of the indexed dataframe, e.g., indexed dataframe 204. Further, although not illustrated in FIG. 2B, executed indexing and target-generation engine 162 may also perform any of these exemplary processes, consistent with the elements of configuration data 163, that populate each additional or alternate row of indexed dataframe 204 with values of the customer identifier and timestamp maintained within columns of corresponding ones of processed data tables 176.

Further, the elements of configuration data 163 may include, among other things, data specifying a logic and a value of one or more corresponding parameters for constructing a ground-truth label for each row of indexed dataframe 204. In some instances, the ground-truth labels may support an adaptive training of a machine-learning or artificial-intelligence process (such as, but not limited to, a gradient-boosted, decision-tree process, e.g., an XGBoost process), which may facilitate a prediction, at a temporal prediction point, of a likelihood of an occurrence, or a non-occurrence, of a target event involving a customer of the organization during a future, target temporal interval, which may be separated from the temporal prediction point by a corresponding buffer interval. By way of example, the target event may correspond to an attrition event involving a small-business customer of the financial institution, and the ground-truth labels may support the adaptive training of a machine-learning or artificial-intelligence process to predict, at the prediction date, a likelihood of an occurrence, or a non-occurrence, of the attrition event involving the small-business customer during a two-month temporal interval disposed between two and four months subsequent to the prediction date.

For instance, as illustrated in FIG. 2B, the temporal prediction point, e.g., temporal prediction point t_{pred}, may be disposed along a timeline 205, and the executed indexing and target-generation engine 162 may perform any of the exemplary processes described herein to train adaptively machine-learning or artificial-intelligence process (e.g., the gradient-boosted, decision-tree process described herein) to predict the likelihood of the occurrence, or non-occurrence, of the attrition event involving the small-business customer of the financial institution during the future, target temporal interval Δt_{target}, which may be separated temporally from the temporal prediction point t_{pred} by a corresponding buffer interval Δt_{buffer}. By way of example, the target temporal interval Δt_{target} may be characterized by a predetermined duration, such as, but not limited to, two months, and buffer interval Δt_{buffer} may also be associated with a predetermined duration, such as, but not limited to, two months. In some instances, the predetermined duration of buffer interval Δt_{buffer} may be established by computing system 130 to separate temporally the customers' prior interactions with the financial institution (and with other financial institutions) and attrition events from the future target temporal interval Δt_{target}.

The elements of configuration data 163 may, for example, specify the predetermined duration of the future, target temporal interval Δt_{target} (e.g., the two-month duration, etc.) and the predetermined duration of the buffer interval Δt_{buffer} (e.g. the two-month interval, etc.). Further, the elements of configuration data 163 may also specify logic that define the occurrence of the organization- or customer-specific attrition event and that, when processed by executed indexing and target-generation engine 162, enable executed indexing and target-generation engine 162 to detect the occurrence of the organization- or customer-specific attrition event based on the elements of attrition data maintained within corresponding ones of processed data tables 176.

In some instances, executed indexing and target-generation engine 162 may perform operations that, for each row of indexed dataframe 204, obtain the customer identifier associated with the corresponding customer (e.g., an alphanumeric customer identifier, as described herein) from each row of indexed dataframe 204, access portions of processed data tables maintained within source data store 134 associated with the corresponding customer based on the customer identifier (e.g., portions of processed data tables 176 and 184, etc.), and apply the logic maintained within the elements of configuration data 163 to the accessed portions of processed data tables in accordance with the specified parameter values. Based on the application of the logic to the accessed portions of processed data tables 176 (e.g., the element of attrition data 114B, as described herein), executed indexing and target-generation engine 162 may determine the occurrence, or non-occurrence, of the corresponding attrition event involving each of the corresponding customers during the future, target temporal interval, which may be disposed subsequent to the temporal prediction point and separated from that temporal prediction point by the corresponding buffer interval. Further, executed indexing and target-generation engine 162 may also generate, for each row of indexed dataframe 204, the corresponding one of ground-truth labels 206 indicative of a determined occurrence of the attrition event involving the corresponding customer during the future, target temporal interval (e.g., a “positive” target associated with a ground-truth label of unity) or alternatively, a determined non-occurrence of the corresponding attrition event involving the corresponding customer during the future, target temporal interval (e.g., a “negative” target associated with a ground-truth label of zero).

For example, executed indexing and target-generation engine 162 may access row 202 of indexed dataframe 204, and may obtain customer identifier 178 (e.g., “CUSTID”) associated with a corresponding one of the customers and temporal identifier 180 (e.g., “2024 Jun. 30”), which indicates an ingestion of elements of interaction data 112, 114, and 116 associated with the corresponding customer on Jun. 30, 2024. As described herein, the elements of interaction data 112, 114, and 116 ingested on Jun. 30, 2024, may characterize the corresponding customer during a temporal interval between Jun. 1, 2024, to Jun. 30, 2024. Further, and based on the parameter values and the logic maintained within the elements of configuration data 163, executed indexing and target-generation engine 162 may establish Jun. 30, 2024, as the temporal prediction point t_{pred} associated with row 202, and may determine the future, target temporal interval Δt_{target} associated with row 202, and the determination of the corresponding one of ground-truth labels 206, extends from Sep. 1, 2024, through Oct. 31, 2024 (e.g., a two-month interval separated from the Jun. 30, 2024, temporal prediction point by the two-month buffer interval Δt_{buffer}). In some instances, executed indexing and target-generation engine 162 may access a subset of the processed data tables maintained within source data store 134 that include or reference customer identifier 178 and that include temporal identifiers associated with ingestion dates between Sep. 1, 2024, through Oct. 31, 2024, and executed indexing and target-generation engine 162 may apply the logic maintained within the elements of configuration data 163 to the accessed portions of processed data tables in accordance with the specified parameter values and determine whether an attrition event involving the corresponding customer associated with customer identifier 178 occurred during the future, target temporal interval Δt_{target}.

By way of example, and based on elements of attrition data maintained within the accessed subset of the processed data tables, executed indexing and target-generation engine 162 may establish that the corresponding customer, e.g., the small-business banking customer described herein, ceased participating in one or more of the small-business banking services provisioned by the financial instruction on Oct. 3, 2024, and executed indexing and target-generation engine 162 may determine that an attrition event involving that small-business banking customer and the one or more of the small-business banking services occurred on Oct. 3, 2024. Based on the determination, executed indexing and target-generation engine 162 may generate, for row 202 of indexed dataframe 204, a corresponding one of ground-truth labels 206, e.g., ground-truth label 208, indicative of a determined occurrence of the attrition event on Oct. 3, 2024. (e.g., a “positive” target associated with a ground-truth label of unity). Executed indexing and target-generation engine 162 may also perform any of the exemplary processes described, in accordance with the elements of configuration data 163, to generate a corresponding one of ground-truth labels 206 for each additional or alternate row of indexed dataframe 204.

Executed indexing and target-generation engine 162 may also append each of generated ground-truth labels 206 (including ground-truth label 208) to the corresponding row of Indexed dataframe 204, and generate elements of a labelled indexed dataframe 210 that include each row of Indexed dataframe 204 and the appended one of ground-truth labels 206. In some instances, executed indexing and target-generation engine 162 may provision labelled indexed dataframe 210 to executed artifact management engine 183, e.g., as output artifacts 212, and executed artifact management engine 183 may receive each of output artifacts 212 via the artifact API. Executed artifact management engine 183 may package each of output artifacts 212 into a corresponding portion of indexing and target-generation artifact data 214, along with a unique component identifier 162A of executed indexing and target-generation engine 162, and may store indexing and target-generation artifact data 214 within a corresponding portion of artifact data store 151, e.g., within data record 153 associated with training pipeline 145 and run identifier 155A.

Further, as illustrated in FIG. 2A, executed indexing and target-generation engine 162 may provide output artifacts 212, including labelled indexed dataframe 210 (e.g., maintaining each the rows of Indexed dataframe 204 and the appended ones of ground-truth labels 206) as inputs to splitting engine 164 executed by the one or more processors of computing system 130. Additionally, in some instances, executed orchestration engine 140 may provision one or more elements of configuration data 165 maintained within configuration data store 157 to executed splitting engine 164 in accordance with training pipeline 145.

As described herein, the elements of configuration data 165 may include, among other things, an identifier of labelled indexed dataframe 210 (e.g., which may be ingested by executed splitting engine 164 as an input artifact) and an identifier of one or more primary keys of labelled Indexed dataframe 204, such as, but not limited to, an identifier of a column of labelled indexed dataframe 210 that maintains unique, alphanumeric customer identifiers or temporal data, e.g., timestamps. In some instances, the identifier of labelled indexed dataframe 210 may include, but is not limited to, an alphanumeric file name or a file path of labelled indexed dataframe 210 within artifact data store 151. Further, and as described herein, the elements of configuration data 165 may include a value of one or more parameters of a corresponding splitting process that include, but are not limited to, a temporal splitting point (e.g., Feb. 1, 2021, etc.) and data specifying populations of in sample and out partitions of labelled, indexed dataframe 210 ingested by executed splitting engine 164. In some instances, the data specifying the populations of in sample and out partitions of labelled, indexed dataframe 210 may include, but is not limited to, a first percentage of the rows of a labelled, indexed dataframe that represent “in sample” rows and as such, an “in-sample” partition of the labelled, indexed dataframe, and a second percentage of the rows of the labelled, indexed dataframe that represent “out-of-sample” rows and as such, an “out-of-sample” partition of the labelled, indexed dataframe. Examples of the first predetermined percentage include, include, but are not limited to, 50%, 75%, or 80%, and corresponding examples of the second predetermined percentage include, but are not limited to, 50%, 25%, or 20% (e.g., a difference between 100% and the corresponding first predetermined percentage).

A programmatic interface associated with executed splitting engine 164 may receive labelled indexed dataframe 210 and the elements of configuration data 165 (e.g., as corresponding input artifacts), and may perform any of the exemplary processes described herein to establish a consistency of the corresponding input artifacts with the engine- and pipeline specific operational constraints imposed on executed splitting engine 164. Based on an established consistency of the input artifacts with the imposed engine- and pipeline-specific operational constraints, executed splitting engine 164 may perform operations that, consistent with the elements of configuration data 165, partition labelled indexed dataframe 210 into a plurality of partitioned dataframes suitable for training, validating, and testing the machine-learning or artificial-intelligence process within training pipeline 145. As described herein, each of the partitioned dataframes may include a partition-specific subset of the rows of labelled Indexed dataframe 210, each of which include a corresponding row of Indexed dataframe 204 and the appended one of ground-truth labels 206.

By way of example, and based the elements of configuration data 165, executed splitting engine 164 may apply the splitting process to labelled Indexed dataframe 204, and based on the application of the default splitting process to the rows of labelled indexed dataframe 204, executed splitting engine 164 may partition the rows of labelled indexed dataframe 210 into a distinct training dataframe 216, a distinct validation dataframe 218, and a distinct testing dataframe 220 appropriate to train, validate, and subsequently test the first machine-learning or artificial-intelligence process (e.g., the gradient boosted, decision-tree process, such as the XGBoost process) using any of the exemplary processes described herein. Each of the rows of labelled indexed dataframe 210 may include, among other things, a unique, alphanumeric customer identifier and an element of temporal data, such as a corresponding timestamp. In some instances, and based on a comparison between the corresponding timestamp and the temporal splitting point (e.g., Feb. 1, 2021) maintained within the elements of configuration data 165, executed splitting engine 164 may assign each of the rows of labelled indexed dataframe 210 to an intermediate, in-time partitioned dataframe (e.g., based on a determination that the corresponding timestamp is disposed prior to, or concurrent with, the temporal splitting point of Feb. 1, 2021) or to an intermediate, out-of-time partitioned dataframe (e.g., based on a determination that the corresponding timestamp is disposed subsequent to the temporal splitting point of Feb. 1, 2021).

Executed splitting engine 164 may also perform operations, consistent with the elements of configuration data 165, that further partition the intermediate, in-time partitioned dataframe into corresponding ones of an in-time, and in sample, partitioned dataframe and an in-time, and out-of-sample, partitioned dataframe. For instance, and as described herein, the elements of configuration data 165 may include sampling data characterizing populations of the in sample and out partitions for the default splitting process (e.g., the first percentage of the rows of a temporally partitioned dataframe represent “in-sample” rows, and the second percentage of the rows of the temporally partitioned dataframe represent “out-of-sample” rows, etc.). Examples of the first and second percentages may include, but are not limited to, eighty and twenty percent, respectively, or seventy-five and twenty-five percent, respectively.

Based on the elements of sampling data, executed splitting engine 164 may allocate, to the in-time and in-sample partitioned dataframe, the first predetermined percentage of the rows of labelled indexed dataframe 210 assigned to the intermediate, in-time partitioned dataframe, and may allocate to the in-time and out-of-sample partitioned dataframe, the second predetermined percentage of the rows of labelled indexed dataframe 210 assigned to the intermediate, in-time partitioned dataframe. In some instances, the rows of labelled indexed dataframe 210 allocated to the in-time and in-sample partitioned dataframe may establish training dataframe 216, the rows of labelled indexed dataframe 210 allocated to the in-time and out-of-sample partitioned dataframe may establish validation dataframe 218, and the rows of labelled indexed dataframe 210 assigned to the intermediate, out-of-time partitioned dataframe (e.g., including both in sample and out-of-sample rows) may establish testing dataframe 220.

In some instances, executed splitting engine 164 may perform operations that provision training dataframe 216, validation dataframe 218, and testing dataframe 220, and elements of splitting data 222 that characterize the temporal splitting point and the in-sample and out-of-sample populations, and the first and second percentages, of the splitting process, to executed artifact management engine 183, e.g., as output artifacts 224. In some instances, executed artifact management engine 183 may receive each of output artifacts 224 via the artifact API, and may perform operations that package each of output artifacts 224 into a corresponding portion of splitting artifact data 226, along with a unique component identifier 155A of executed splitting engine 164, and that store splitting artifact data 226 within a corresponding portion of artifact data store 151, e.g., within data record 153 associated with training pipeline 145 and run identifier 155A.

In accordance with training pipeline 145, executed splitting engine 164 may provide output artifacts 224, including training dataframe 216, validation dataframe 218, and testing dataframe 220, and the elements of splitting data 222, as inputs to a feature-generation engine 166 executed by the one or more processors of computing system 130. Further, within training pipeline 145, executed orchestration engine 140 may provision the elements of configuration data 167 maintained within configuration data store 157 to executed feature-generation engine 166, and based on programmatic communications with executed artifact management engine 183, may provision processed data tables 176 maintained within data record 153 of artifact data store 151 to executed feature-generation engine 166.

By way of example, the elements of configuration data 167 may include data identifying and characterizing operations that partition processed data tables 176 into corresponding training, validation, and testing partitions (e.g., in scripts callable in a namespace of executed feature-generation engine 166). The elements of configuration data 167 may also include feature data identifying and characterizing a plurality of features selected for inclusion within a feature vector of corresponding feature values for each row within training dataframe 216. The feature data may, in some instances, establish an initial, candidate composition of the feature vectors associated with training dataframe 216, and the feature data may include, for each of the selected features, a unique feature identifier, aggregation data specifying one or more aggregation operations associated with the feature value and one or more prior temporal intervals associated with the aggregation operations, post-processing data specifying one or more post-processing operations associated with the aggregation operations, and identifiers of one or more columns of training data tables 228, (and of validation data tables 230 and testing data tables 232) subject to the one or more aggregation or post-processing operations. As described herein, for each of the selected features, corresponding ones of the aggregation and/or post-processing operations may be specified within the elements of modified feature-generation data as helper scripts capable of invocation within the namespace of executed feature-generation engine 166 and arguments or configuration parameters that facilitate the invocation of corresponding ones of the helper scripts.

In some instances, the selected features may include elements of the customer profile, account, transaction, engagement, attrition, or reporting data ingested by computing system 130 and characterizing corresponding customers of the organization (e.g., the small-business banking customers of the financial institution, as described herein, etc.). Examples of these selected features may include, but are not limited to, current balance of a business checking or savings account, an opening balance of a business checking or savings account, a number of days since a last deposit to or withdrawal from a business checking or savings account, or a number of days since a corresponding customer opened a business checking or savings account. Further, in some instances, the selected features may be determined or derives from the ingested elements of the customer profile, account, transaction, engagement, attrition, or reporting data, e.g., using one of more of the exemplary aggregation operations over the one or more prior temporal intervals. Examples of these determined or derived features may include, but are not limited to, an average balance of a business checking or savings account over the one or more prior temporal intervals, a total amount of funds in all accounts held by the corresponding customer at a completion of the one or more prior temporal intervals, a sum of debit transactions involving a business checking or savings account on during the one or more prior temporal intervals, or a number of instances of, or a duration of, digital engagement (e.g., web-based interfaces or mobile applications, etc.) involving the corresponding customer and the organization during the one or more prior temporal intervals.

In some instances, a programmatic interface of executed feature-generation engine 166 may receive training dataframe 216, validation dataframe 218, testing dataframe 220, and the elements of splitting data 222, each of processed data tables 176, and the elements of configuration data 167 (e.g., as corresponding input artifacts), and may perform any of the exemplary processes described herein to establish a consistency of the corresponding input artifacts with the engine- and pipeline-specific operational constraints imposed on executed feature-generation engine 166. Based on an established consistency of the input artifacts with the imposed engine- and pipeline-specific operational constraints, executed feature-generation engine 166 may perform one or more of the exemplary processes described herein that, consistent with the elements of configuration data 167, generate an initial feature vector of corresponding feature values for each row of training dataframe 216 based on, among other things, a sequential application of pipelined, and customized, estimation and transformation operations to a corresponding, partitions of the processed data tables 176 associated with corresponding ones of training dataframe 216. The feature vectors associated with the rows of training dataframe 216 may, in some instances, be ingested by one or more additional executable application engines within training pipeline 145 (e.g., AI/ML training engine 168), and may facilitate an adaptive training of the first machine-learning or artificial-intelligence process using any of the exemplary processes described herein (e.g., the gradient-boosted, decision-tree process described herein, such as the XGBoost process).

For example, as illustrated in FIG. 2C, executed feature-generation engine 166 may access one or more of processed data tables 176 maintained within source data store 134, and may perform operations, consistent with the splitting data 222 and with the elements of configuration data 167, that partition processed data tables 176 into a corresponding partition associated with training dataframe 216 (e.g., training data tables 228), a corresponding partition associated with validation dataframe 218 (e.g., validation data tables 230), and a corresponding partition associated with testing dataframe 220 (e.g., testing data tables 232). As described herein, each row of training dataframe 216, validation dataframe 218, and testing dataframe 220 may include values of one or more primary keys of Indexed dataframe 204 (e.g., customer identifier, timestamp, etc.) and a corresponding one of ground-truth labels 206, and in some instances, each row of training dataframe 216, validation dataframe 218, and testing dataframe 220 may be associated with a corresponding customer and a corresponding temporal interval.

Based on the values of the one or more primary keys, executed feature-generation engine 166 may perform operations, consistent with the elements of configuration data 167, that map subsets of the rows of each of preprocessed data tables to corresponding ones of the training, validation, and testing partitions, and assign the mapped subsets of the rows to corresponding ones of training data tables 228, validation data tables 230, and testing data tables 232. In some examples, the rows of processed data tables 176 assigned to training data tables 228, validation data tables 230, and testing data tables 232 may facilitate a generation, using any of the exemplary processes described herein, of a feature vector of specified, or adaptively determined, feature values for each row of a corresponding one of training dataframe 216, validation dataframe 218, and testing dataframe 220. Further, in some instances, each, or a subset of the operations that facilitate mapping of the subsets of the rows of processed data tables 176 to corresponding ones of the training partition, the validation partition, and the testing partition, and the assignment of the mapped subsets of the rows to corresponding ones of training data tables 228, validation data tables 230, and testing data tables 232, may also be specified within the elements of configuration data 167 (e.g., in scripts callable in a namespace of executed feature-generation engine 166).

As illustrated in FIG. 2C, a pipeline fitting module 234 of executed feature-generation engine 166 may process the elements of configuration data 167, and obtain, for each of the features specified with the elements of configuration data 167, the corresponding feature identifier, the aggregation data specifying the one or more aggregation operations associated with the feature value and one or more prior temporal intervals associated with the aggregation operations, the post-processing data specifying one or more post-processing operations associated with the aggregation operations, and identifiers of one or more columns of training data tables 228 subject to the one or more aggregation or post-processing operations. In some instances, executed pipeline fitting module 234 may process the feature identifiers, the aggregation data (e.g., the helper classes or scripts identifying the aggregation operations, identifiers of the temporal intervals associated with the aggregation operations, etc.), the post-processing data (e.g., the helper scripts identifying the post-processing operations associated with corresponding ones of aggregation operations, etc.), and the associated table and/or column identifiers, and may perform operations establish a “featurizer pipeline” of stateless transformation operations and stateless estimation operations that, when applied sequentially to one or more of the rows of training data tables 228 generate an initial feature vector of the selected feature values for each row within of training dataframe 216.

By way of example, executed pipeline fitting module 234 may access a transformation and estimation library 236, which may maintain and characterize one or more default (or previously customized) stateless transformation or estimation operations, and which may associate each of the default (or previously customized) stateless transformation or estimation operations with corresponding input arguments and output data, and in some instances, with a value of one or more configuration parameters. Examples of the stateless transformation operations includes one or more historical (e.g., backward) aggregation operations or one or more vector transformation operations applicable to training data tables 228 (and additionally, or alternatively, to validation data tables 230 and testing data tables 232) and/or with columns within training data tables 228 (and additionally, or alternatively, to validation data tables 230 and testing data tables 232), and examples of the stateless estimation operations may include one or more one-hot-encoding operations, label-encoding operations, scaling operations (e.g., based on minimum, maximum, or mean values, etc.), or other statistical processes application to training data tables 228 (and additionally, or alternatively, to validation data tables 230, and testing data tables 232).

Based on the aggregation data, the post-processing data, and the corresponding table and/or column identifiers associated with the selected features (e.g., within the elements of configuration data 167), executed pipeline fitting module 234 may perform operations that map the aggregation and post-processing operations associated with each of the specified features to a corresponding one (or corresponding ones) of the default stateless transformation and the default estimation operations maintained within transformation and estimation library 236. Executed pipeline fitting module 340 may also generate elements of feature-specific executable code that, upon execution by the one or more processors of computing system 130, apply the mapped default stateless transformations and the default estimation operations to corresponding ones of training data tables 228, validation data tables 230, and testing data tables 232, and generate, for each of the selected features, a feature value associated with a row of training dataframe 216 (and additionally, or alternatively, rows of validation data tables 230 and testing data tables 232).

Executed pipeline fitting module 234 may also perform operations that combine, or concentrate, programmatically each of the elements of feature-specific executable code associated with corresponding ones of the selected features, and generate a corresponding script, e.g., featurizer pipeline script 238 executable by the one or more processors of computing system 130. By way of example, when executed by the one or more processors of computing system 130, executed featurizer pipeline script 238 may establish a “featurizer pipeline” of sequentially executed ones of the mapped, default stateless transformation and the mapped, default estimation operations, which, upon application to the rows of training data tables 228, and additionally or alternatively, to rows of validation data tables 230, and testing data tables 232 (e.g., upon “ingestion” of these tables by the established featurizer pipelined), generate a feature vector of sequentially order feature values for corresponding ones of the rows of training dataframe 216 (and additionally, or alternatively, for rows of validation data tables 230 and testing data tables 232). In some instances, computing system 130 may maintain featurizer pipeline script 238 in Python™ format, and in some instances, executed pipeline fitting module 234 may apply one or more Python™-compatible optimization or profiling processes to the elements of executable code maintained within featurizer pipeline script 238, which may reduce inefficiencies within the executed elements of code, and improve or optimize a speed at which the one or more processors of computing system 130 executed featurizer pipeline script 238 and/or a use of available memory by featurizer pipeline script 238.

In some instances, a featurizer module 240 of executed feature-generation engine 166 may obtain featurizer pipeline script 238 and training data tables 228 (and additionally, or alternatively, validation data tables 230 and testing data tables 232), and executed featurizer module 240 may trigger an execution of featurizer pipeline script 238 by the one or more processors of computing system 130. Within the established featurizer pipeline, executed featurizer module 240 may apply sequentially each of the mapped, default stateless transformation and the mapped, default estimation operations to each row of training data tables 228 (and additionally, or alternatively, to rows of validation data tables 230 and testing data tables 232), and generate a corresponding feature vector of sequentially ordered feature values for each of the rows of training dataframe 216, e.g., corresponding ones of feature vectors 242. As described herein, each of feature vectors 242 may include feature values associated with a corresponding set of features, and a composition and a sequential order of the corresponding feature values may be consistent with the composition and sequential ordering specified within the elements of configuration data 167.

In some instances, executed featurizer module 240 may perform operations that append each of feature vectors 242 to a corresponding row of training dataframe 216, which includes a row of labelled, indexed dataframe 210 (e.g., a corresponding row of Indexed dataframe 204 and the appended one of ground-truth labels 206). As illustrated in FIG. 2C, executed featurizer module 240 may generate elements of a vectorized training dataframe 244 that include the rows of training dataframe 216 and the appended ones of feature vectors 242, and executed featurizer module 240 may perform operations that provision training data tables 228, validation data tables 230, and testing data tables 232, featurizer pipeline script 238, and vectorized training dataframe 244 to executed artifact management engine 183, e.g., as initial output artifacts 246 of executed feature-generation engine 166 within training pipeline 145. In some instances, executed artifact management engine 183 may receive each of initial output artifacts 246, and may perform operations that package each of initial output artifacts 246 into a corresponding portion of feature-generation artifact data 248, along with a unique component identifier 166A of executed feature-generation engine 166, and that store feature-generation artifact data 248 within a portion of artifact data store 151, e.g., within data record 153 associated with training pipeline 145 and run identifier 155A.

Further, and in accordance with training pipeline 145, executed feature-generation engine 166 may provide vectorized training dataframe 244 as an input to AI/ML training engine 168 executed by the one or more processors of computing system 130, e.g., in accordance with executed training pipeline script 150. Further, executed orchestration engine 140 may also provision, to executed AI/ML training engine 168, elements of configuration data 169 that, among other things, identifies the gradient-boosted, decision-tree process (e.g., via a corresponding default script callable within the namespace of AI/ML training engine 168, via a corresponding file system path, etc.), and an initial value of one or more parameters of the gradient-boosted, decision-tree process, which may facilitate an instantiation of the gradient-boosted, decision-tree process during an initial phase within the training pipeline (e.g., by executed AI/ML training engine 168). Examples of these initial parameter values for the specified gradient-boosted, decision-tree process may include, but are not limited to, a learning rate, a number of discrete decision trees (e.g., the “n_estimator” for the trained, gradient-boosted, decision-tree process), a tree depth characterizing a depth of each of the discrete decision trees, a minimum number of observations in terminal nodes of the decision trees, and/or values of one or more hyperparameters that reduce potential model overfitting.

In some instances, a programmatic interface associated with executed AI/ML training engine 168 may receive, as corresponding input artifacts, the elements of configuration data 169, and vectorized training dataframe 244, and the programmatic interface of executed AI/ML training engine 168 may perform operations any of the exemplary processes described herein that establish a consistency of these input artifacts with the imposed engine- and pipeline-specific operational constraints imposed on executed AI/ML training engine 168. Based on an established consistency of the input artifacts with the imposed engine- and pipeline-specific operational constraints, executed AI/ML training engine 168 may cause the one or more processors of computing system 130 to perform, through an implementation of one or more parallelized, fault-tolerant distributed computing and analytical processes described herein, operations that instantiate the machine-learning or artificial-intelligence process in accordance with the one or more initial parameter values, e.g., as specified within the elements of configuration data 169. Further, and through the implementation of one or more parallelized, fault-tolerant distributed computing and analytical processes described herein, the one or more processors of computing system 130 may perform further operations that apply the instantiated machine-learning or artificial-intelligence process to each row of vectorized training dataframe 244, which includes the corresponding row of indexed dataframe 204, the appended one of ground-truth labels 206, and the appended one of feature vectors 242.

By way of example, and in accordance with the elements of configuration data 169, executed AI/ML training engine 168 may perform operations, described herein, that train adaptively a gradient-boosted, decision-tree process (e.g., an XGBoost process), to predict a likelihood of an occurrence, or a non-occurrence, of an attrition event during a future, target temporal interval separated from a temporal prediction point by a corresponding buffer interval. In some instances, the future, target temporal interval may correspond to a two-month interval disposed between two and four months subsequent to the temporal prediction point, e.g., separated from the temporal prediction point by a buffer interval of two months. Further, and as described herein, the attrition event may be associated with, and involve, a corresponding customer of the organization (e.g., a small-business banking customer of the financial institution) and with one more provisioned products and services, and a targeted attrition event may occur during the future, target temporal interval when a corresponding customer ceases participation in, or “attrites” from, the one more provisioned products and services. For instance, an attrition event involving a small-business customer of the financial institution may occur when that small-business customer ceases participation in one or more of the small-business banking services provisioned to that small-business customer by the financial institution, e.g., on a corresponding attrition date within the target, future temporal interval.

In some instances, the elements of configuration data 169 may include data that identifies the gradient-boosted, decision-tree process (e.g., a helper class or script associated with the XGBoost process and capable of invocation within the namespace of executed AI/ML training engine 168) and an initial value of one or more parameters of the gradient-boosted, decision-tree process, such as, but not limited to, those parameters described herein. In some instances, executed AI/ML training engine 168 may cause the one or more processors of computing system 130 to instantiate the gradient-boosted, decision-tree process (e.g., the XGBoost process) in accordance with the initial parameter values maintained the elements of configuration data 169, and to apply the instantiated, gradient-boosted, decision-tree process to each row of vectorized training dataframe 244. By way of example, executed AI/ML training engine 168 may cause the one or more processors of computing system 130 to perform operations that establish a plurality of nodes and a plurality of decision trees for the gradient-boosted, decision-tree process, each of which receive, as inputs, corresponding rows of vectorized training dataframe 244, which include the corresponding row of indexed dataframe 204, and the appended ones of ground-truth labels 206 and feature vectors 242.

Based on the application of the instantiated machine-learning or artificial-intelligence process (e.g., the gradient-boosted, decision-tree process described herein, etc.) to each row of vectorized training dataframe 244, executed AI/ML training engine 168 may generate a corresponding elements of training output data 250 and one or more elements of training log data 252 that characterize the application of the instantiated machine-learning or artificial-intelligence process to the each row of vectorized training dataframe 244. Executed AI/ML training engine 168 may append each of the generated elements of training output data 250 to the corresponding row of vectorized training dataframe 244, and generate elements of vectorized training output 254 that include each row of vectorized training dataframe 244 and the appended element of training output data 364.

In some instances, the elements of training output 250 may each indicate, for the values of the primary keys within vectorized training dataframe 244 (e.g., the alphanumeric, customer identifier and the timestamp, as described herein), the predicted likelihood of the occurrence, or non-occurrence, of an attrition event involving a corresponding customer of the organization and one or more provisioned services during a two-month, future temporal interval separated from a temporal prediction point (e.g., the corresponding timestamp) by a two-month buffer interval. As described herein, each of the elements of training output 250 may include a value ranging from zero to unity, with a value of zero being indicative of a minimal likelihood of the occurrence of the attrition event during the two-month, future temporal interval, and with a value of unity being indicative of a maximum likelihood of the occurrence of the attrition event during the two-month, future temporal interval.

By way of example, the elements of training log data 252 may characterize the application of the instantiated machine-learning or artificial-intelligence process to the rows of vectorized training dataframe 244, and may include, but are not limited to, performance data (e.g., execution times, memory or processor usage, etc.) and the initial values of the processes parameters associated with the instantiated machine-learning or artificial-intelligence process, as described herein. Further, the elements of training log data 252 may also include elements of explainability data characterizing the predictive performance and accuracy of the machine-learning or artificial-intelligence process during application to vectorized training dataframe 244.

The elements of explainability data may include, but are not limited to, Shapley feature values that characterize a relative importance of each of the discrete features within vectorized training dataframe 244 (e.g., within feature vectors 242) and/or values of one or more deterministic or probabilistic metrics that characterize the relative importance of discrete ones of the features. In some instances, executed AI/ML training engine 168 may generate the Shapley values in accordance with one or more Shapley Additive explanations (SHAP) processes, such as, but not limited to, a KernelSHAP process or a TreeShap process. Further, examples of these deterministic or probabilistic metrics may include, but are not limited to, data establishing individual conditional expectation (ICE) curves or partial dependency plots, computed precision values, computed recall values, computed areas under curve (AUCs) for receiver operating characteristic (ROC) curves or precision-recall (PR) curves, and/or computed multiclass, one-versus-all areas under curve (MAUCs) for ROC curves. The disclosed embodiments are, however, not limited to, these exemplary elements of training log data 252, and in other examples, training log data 252 may include any additional, or alternate, elements of data characterizing the application of the instantiated machine-learning or artificial-intelligence process to the rows of vectorized training dataframe 244 within training pipeline 145.

Executed AI/ML training engine 168 may perform operations that provision vectorized training output 254 (e.g., including the rows of vectorized training dataframe 244 and the appended elements of training output 250) and the elements of training log data 252 to executed artifact management engine 183, e.g., as initial output artifacts 256 of executed AI/ML training engine 168 within training pipeline 145. In some instances, executed artifact management engine 183 may receive each of initial output artifacts 256, and may perform operations that package each of initial output artifacts 256 into a corresponding portion of AI/ML training artifact data 258, along with a unique, component identifier 168A of executed AI/ML training engine 168, and that store AI/ML training artifact data 258 within a corresponding portion of artifact data store 151, e.g., within data record 153 associated with training pipeline 145 and run identifier 155A.

In some instances, not illustrated in FIG. 2C, executed AI/ML training engine 168 may obtain, from the explainability data maintained within training log data 252, one or more of the Shapley values that characterize the relative importance of corresponding ones of the feature values within feature vectors 242, and one or more of the computed metric values that characterize the predictive capability and accuracy of the machine-learning or artificial-intelligence process during current run of training pipeline 145. Based on the Shapley values and/or the computed metric values, executed AI/ML training engine 168 (or additional elements of code, application modules, or application engines executed by the one or more processors of computing system 130) may perform operations that modify a composition of feature vectors 242 by adding one or more new features to the feature vectors 242, by deleting one or more previously specified features from feature vectors 242 (e.g., non-contributing features associated with Shapley values that fail to exceed a threshold Shapley value, which may be specified within the elements of configuration data 169) and additionally, or alternatively, combine together previously specified features within feature vectors 242 (e.g., to derive a composite feature, etc.). Executed AI/ML training engine 168 may, for example, perform operations that modify programmatically one or more of the elements of configuration data 167 to reflect the modified composition of feature vectors 242, e.g., to add elements to configuration data 167 that characterize the newly added or combined features, such as the corresponding feature identifiers, aggregation data, post-processing data, and column identifiers described herein, or to delete elements from configuration data associated with the newly deleted features.

Further, in some instances, executed AI/ML training engine 168 may obtain, from the explainability data maintained within training log data 252, the performance data characterizing the execution of the gradient-boosted decision tree process within the current run of training pipeline 145 and the values of the one or more deterministic or probabilistic metrics that characterize the relative importance of discrete ones of the features. Based on the performance data and the deterministic or probabilistic metric values, executed AI/ML training engine 168 may determine an intermediate value of one or more of the parameters of the gradient-boosted, decision-tree process (such as those described herein), and may perform operations that modify programmatically the elements of configuration data 169 to reflect the determined, intermediate parameters values. The programmatic modifications to the elements of configuration data 167 and 169 may maintain a compliance of the elements of configuration data 167 with the imposed engine- and pipeline-specific operational constraints and in some instances, executed AI/ML training engine 168 may execute one or more generative artificial-intelligence to modify the elements of configuration data 167 and/or configuration data 169 in their native formats (e.g., human-readable data-serialization language, such as, but not limited to, a YAML™ data-serialization language or an extensible markup language (XML)).

Although not illustrated in FIG. 2C, executed AI/ML training engine 168 may provision the modified elements of configuration data 167 as inputs to executed feature-generation engine 166, and the programmatic interface of executed feature-generation engine 166 may the modified elements of configuration data 167, which reflect the modifications to the composition of feature vectors 242. Based on an established consistency of these input additional artifacts with the imposed engine- and pipeline-specific operational constraints, executed feature-generation engine 166 may perform one or more of the exemplary processes described herein that, consistent with the modified elements of configuration data 167, generate an intermediate feature vector of corresponding feature values for each row of training dataframe 216, and generate an intermediate vectorized training dataframe that associates each row of training dataframe 216 within a corresponding one of the intermediate feature vectors. Further, in some instances, executed AI/ML training engine 168 may perform operations, described herein, those store additional output artifacts characterizing the generation of the intermediate feature vectors within record 153 of artifact data store 151 (e.g., as an intermediate portion of feature-generation artifact data 248), and may provision the intermediate vectorized training dataframe, which associates each row of training dataframe 216 within the corresponding one of the intermediate feature vectors, as an input to executed AI/ML training engine 168.

Based on an established consistency of these additional input artifacts (e.g., the intermediate vectorized training dataframe and in some instances, the modified elements of configuration data 169, which reflect the modified parameter values) with the imposed engine- and pipeline-specific operational constraints, executed AI/ML training engine 168 may cause the one or more processors of computing system 130 to perform, through an implementation of one or more parallelized, fault-tolerant distributed computing and analytical processes described herein, operations that instantiate the machine-learning or artificial-intelligence process in accordance with the one or more initial and/or modified parameter values. Further, executed AI/ML training engine 168 may perform any of the exemplary processes described herein to apply the instantiated machine-learning or artificial-intelligence process to each row of the intermediate vectorized training dataframe, and to generate additional elements of training output data and training log data that characterize the application of the instantiated machine-learning or artificial-intelligence process to the each row of the additional vectorized training dataframe.

For example, executed AI/ML training engine 168 (or additional elements of code, application modules, or application engines executed by the one or more processors of computing system 130) may perform any of the exemplary processes described herein to determine, based on the explainability data maintained within the additional training log data, whether to further modify the composition of the intermediate feature vectors (e.g., by adding one or more new features, by deleting one or more previously specified features, or by combining together previously specified features) and additionally, or alternatively, to modify further the intermediate values of the parameters of the gradient-boosted, decision-tree process (not illustrated in FIG. 2C). In some instances, executed AI/ML training engine 168 may iteratively, and adaptively, modify the composition of the intermediate feature vectors and/or modify the intermediate parameter values until a marginal impact resulting from a further addition, subtraction, or combination of discrete features values, or a further modification of the parameter values, on a predictive output of the gradient-boosted, decision-tree process falls below a predetermined threshold, which may be specified within the elements of configuration data 169 (e.g., the addition, subtraction, or combination of the discrete features values within an intermediate feature dataset and/or the modification of the intermediate parameter values results in a change in a value of one or more of the probabilistic metrics that falls below a predetermined threshold change, etc.).

Based on the determination that the marginal impact on the predictive output falls below the predetermined threshold, executed AI/ML training engine 168 may deem complete the initial training of the gradient-boosted, decision-tree process, and may perform any of the exemplary processes described herein to generate updated elements of configuration data 167 and configuration data 169, which reflect, respectively, a composition of the feature vectors for the initially trained gradient-boosted, decision-tree process and a value of one or more parameters of the initially trained gradient-boosted, decision-tree process. As described herein, the updated elements of configuration data 167 and/or configuration data 169 may comply with the engine- and pipeline-specific operational constraints imposed by respective ones of executed feature-generation engine 166 and executed AI/ML training engine 168 and may be structure din their native formats native formats (e.g., human-readable data-serialization language, such as, but not limited to, a YAML™ data-serialization language or an extensible markup language (XML)), and executed AI/ML training engine 168 may generate the updated elements of configuration data 167 and configuration data 169 based on an execution of one or more generative artificial-intelligence processes. Further, in some instances, executed AI/ML training engine 168 may perform operations, described herein, those store additional output artifacts characterizing the updated elements of configuration data 167 and/or configuration data 169 within record 153 of artifact data store 151 (e.g., as a further portion of training artifact data 258).

Based on the completion of the initial training of the gradient-boosted, decision-tree process, executed feature-generation engine 166 and executed AI/ML training engine 168 may perform one or more of the exemplary processes described to validate a predictive output of the initially trained the gradient-boosted, decision-tree process based on an application of the initially trained gradient-boosted, decision-tree process to additional feature vectors associated with, and generated or derived from, data maintained within validation data tables 230 and within testing data tables 232. By way of example, as illustrated in FIG. 2D, executed orchestration engine 140 may perform operations that provision the updated elements of configuration data 167, e.g., updated elements 260, as an input to the programmatic interface of executed feature-generation engine 166. As described herein, updated elements 260 may specify a composition of the feature vectors for the initially trained gradient-boosted, decision-tree process, e.g., as generated programmatically by executed AI/ML training engine 168 during the initial training of the gradient-boosted decision-tree process.

Based on an established consistency of these additional input artifacts with the imposed engine- and pipeline-specific operational constraints, executed feature-generation engine 166 may perform one or more of the exemplary processes described herein that, consistent with updated elements 260, generate additional elements of feature-specific executable code associated with corresponding ones of the features specified within updated elements 260, and generate an additional, corresponding script, e.g., featurizer pipeline script 262, executable by the one or more processors of computing system 130. By way of example, when executed by the one or more processors of computing system 130, executed featurizer pipeline script 262 may establish an additional featurizer pipeline of sequentially executed ones of the mapped, default stateless transformation and the mapped, default estimation operations, which, upon application to the rows of validation data tables 230 and testing data tables 232, generate a feature vector of sequentially order feature values for corresponding ones of the rows of validation data tables 230 and testing data tables 232.

Further, executed feature-generation engine 166 may perform any of the exemplary processes described herein to trigger an execution of featurizer pipeline script 262 by the one or more processors of computing system 130, and executed feature-generation engine 166 may perform any of the exemplary processes described herein to apply sequentially each of the mapped, default stateless transformation and the mapped, default estimation operations to each row of validation data tables 230 and testing data tables 232, and generate a corresponding feature vector of sequentially ordered feature values for each of the rows of validation dataframe 218, e.g., corresponding ones of feature vectors 264, and each of the rows of testing dataframe 220, e.g., corresponding ones of feature vectors 266. As described herein, each of feature vectors 264 and 266 may include feature values associated with a corresponding set of features, and a composition and a sequential order of the corresponding feature values may be consistent with the composition and ordering specified within the updated elements 260, e.g., as generated programmatically by executed AI/ML training engine 168 during the initial training of the gradient-boosted decision-tree process.

In some instances, executed feature-generation engine 166 may perform operations, described herein, that append each of feature vectors 264 to a corresponding row of validation dataframe 218, which includes a row of labelled, indexed dataframe 210 (e.g., a corresponding row of Indexed dataframe 204 and the appended one of ground-truth labels 206), and that append each of feature vectors 266 to a corresponding row of testing dataframe 220, which includes an additional row of labelled, indexed dataframe 210 (e.g., a corresponding row of Indexed dataframe 204 and the appended one of ground-truth labels 206). As illustrated in FIG. 2D, executed feature-generation engine 166 may generate elements of a vectorized validation dataframe 268 that include the rows of validation dataframe 218 and the appended ones of feature vectors 264, and may generate elements of a vectorized testing dataframe 270 that include the rows of testing dataframe 220 and the appended ones of feature vectors 266.

Executed feature-generation engine 166 may also perform operations, described herein, that provision training data tables 228, validation data tables 230, and testing data tables 232, additional featurizer pipeline script 262, and vectorized validation and testing dataframes 268 and 270 to executed artifact management engine 183, e.g., as further output artifacts 272 of executed feature-generation engine 166 within training pipeline 145. In some instances, executed artifact management engine 183 may receive each of further output artifacts 272, and may perform operations that package each of further output artifacts 272 into an additional portion of feature-generation artifact data 248, e.g., within data record 153 associated with training pipeline 145 and run identifier 155A.

Further, and in accordance with training pipeline 145, executed feature-generation engine 166 may provide vectorized validation dataframe 268 as an input to executed AI/ML training engine 168, e.g., in accordance with executed training pipeline script 150. Further, executed orchestration engine 140 may also provision, to executed AI/ML training engine 168, updated elements of configuration data 169, such as updated elements 274, that identify the gradient-boosted, decision-tree process (e.g., via a corresponding default script callable within the namespace of AI/ML training engine 168, via a corresponding file system path, etc.), and an updated value of one or more parameters of the gradient-boosted, decision-tree process, e.g., as generated by executed AI/ML training engine 168 during the initial training of the gradient-boosted, decision-tree process.

In some instances, a programmatic interface associated with executed AI/ML training engine 168 may receive, as corresponding input artifacts, updated elements 274 and vectorized validation dataframe 268, and the programmatic interface may perform operations any of the exemplary processes described herein that establish a consistency of these input artifacts with the engine- and pipeline-specific operational constraints imposed on executed AI/ML training engine 168. Based on an established consistency of the input artifacts with the imposed engine- and pipeline-specific operational constraints, executed AI/ML training engine 168 may cause the one or more processors of computing system 130 to perform any of the exemplary processes described herein to instantiate the gradient-boosted, decision-tree process in accordance with the one or more updated parameter values specified within the updated elements 274, and to apply the instantiated machine-learning or artificial-intelligence process to each row of vectorized validation dataframe 268, which includes the corresponding row of indexed dataframe 204, the appended one of ground-truth labels 206, and the appended one of feature vectors 264.

Based on the application of the instantiated machine-learning or artificial-intelligence process (e.g., the gradient-boosted, decision-tree process described herein, etc.) to each row of vectorized validation dataframe 269, executed AI/ML training engine 168 may generate corresponding elements of validation output data 276 and one or more elements of validation log data 278 that characterize the application of the instantiated machine-learning or artificial-intelligence process to the each row of vectorized validation dataframe 268. Executed AI/ML training engine 168 may append each of the generated elements of validation output data 276 to the corresponding row of vectorized validation dataframe 268, and generate elements of vectorized validation output 280 that include each row of vectorized training dataframe 244 and the appended element of validation output 276.

By way of example, the elements of validation log data 278 may characterize the application of the instantiated machine-learning or artificial-intelligence process to the rows of vectorized training dataframe 244, and may include, but are not limited to, performance data (e.g., execution times, memory or processor usage, etc.) and the initial values of the processes parameters associated with the instantiated machine-learning or artificial-intelligence process, as described herein. Further, the elements of training log data 252 may also include elements of explainability data characterizing the predictive performance and accuracy of the machine-learning or artificial-intelligence process during application to vectorized validation dataframe 268, such as, but not limited to, the Shapley feature values that characterize a relative importance of each of the discrete features vectorized validation dataframe 268 and the values of one or more deterministic or probabilistic metrics that characterize the relative importance of discrete ones of the features.

Executed AI/ML training engine 168 may perform operations that provision vectorized validation output 280 (e.g., including the rows of vectorized validation dataframe 268 and the appended elements of validation output 276) and the elements of validation log data 278 to executed artifact management engine 183, e.g., as further output artifacts 282 of executed AI/ML training engine 168 within training pipeline 145. In some instances, executed artifact management engine 183 may receive each of further output artifacts 282, and may perform operations that store further output artifacts 282 within a portion of AI/ML training artifact data 258, e.g., within data record 153 associated with training pipeline 145 and run identifier 155A.

In some examples, not illustrated in FIG. 2D, executed AI/ML training engine 168 may perform operations that, based on the Shapley values and/or the values of the one or more deterministic or probabilistic metrics maintained within the explainability data of validation log data 278, determine whether the gradient-boosted, decision-tree process satisfies one or more threshold conditions for deployment and real-time application to elements of confidential data within a production environment. For example, the one or more threshold conditions may specify that one, or more, of the computed recall-based values, the computed precision-based values, or the computed AUC or MAUC values (e.g., as maintained within validation log data 278) exceed, or alternatively, fall below a corresponding, metric-specific threshold value, which may be specified within updated elements 274 of configuration data.

If, for example, executed AI/ML training engine 168 were to establish that the gradient-boosted, decision-tree process fails to satisfy at least one of the threshold conditions for deployment, computing system 130 may establish that the gradient-boosted, decision-tree process is insufficiently accurate for deployment and a real-time application to the confidential data within the production environment. Based on the determination that the gradient-boosted, decision-tree process fails to satisfy at least one of the threshold conditions for deployment, executed AI/ML training engine 168 may perform any of the exemplary processes described herein to modify a composition of feature vectors 264 and 266 (e.g., associated with vectorized validation dataframe 268 and vectorized testing dataframe 270, respectively) and additionally, or alternatively, a value of one or more of the parameters of the gradient-boosted, decision-tree process. In some instances, executed orchestration engine 140 may perform operations that trigger a performance of one or more of the adaptive training and validation processes described herein by executed feature-generation engine 166 and executed AI/ML training engine 168, e.g., in accordance with the modified composition of the feature vectors or the modified parameter values of the gradient-boosted, decision-tree process.

Alternatively, if executed AI/ML training engine 168 were to establish that the gradient-boosted, decision-tree process satisfies each of the threshold conditions for deployment, executed orchestration engine 140 may perform additional operations that provision (or that cause executed feature-generation engine 166 to provision) vectorized testing dataframe 270 as an input to executed AI/ML training engine 168, e.g., in accordance with executed training pipeline script 150. Further, executed orchestration engine 140 may also provision, to executed AI/ML training engine 168, updated elements 274, which identifies the gradient-boosted, decision-tree process (e.g., via a corresponding default script callable within the namespace of AI/ML training engine 168, via a corresponding file system path, etc.), and the updated value of the one or more parameters of the gradient-boosted, decision-tree process, e.g., as generated by executed AI/ML training engine 168 during the initial training of the gradient-boosted, decision-tree process.

In some instances, the programmatic interface associated with executed AI/ML training engine 168 may receive, as corresponding input artifacts, updated elements 272 and vectorized testing dataframe 270, and the programmatic interface may perform operations any of the exemplary processes described herein that establish a consistency of these input artifacts with the engine- and pipeline-specific operational constraints imposed on executed AI/ML training engine 168. Based on an established consistency of the input artifacts with the imposed engine- and pipeline-specific operational constraints, executed AI/ML training engine 168 may cause the one or more processors of computing system 130 to perform any of the exemplary processes described herein to instantiate the gradient-boosted, decision-tree process in accordance with the one or more updated parameter values specified within the updated elements 274, and to apply the instantiated machine-learning or artificial-intelligence process to each row of vectorized testing dataframe 270.

Based on the application of the instantiated machine-learning or artificial-intelligence process (e.g., the gradient-boosted, decision-tree process described herein, etc.) to each row of vectorized testing dataframe 270, executed AI/ML training engine 168 may generate a corresponding elements of testing output 284 and one or more elements of testing log data 286 that characterize the application of the instantiated machine-learning or artificial-intelligence process to the each row of vectorized testing dataframe 270. Executed AI/ML training engine 168 may append each of the generated elements of testing output 284 to the corresponding row of vectorized testing dataframe 270, and generate elements of vectorized testing output 288 that include each row of vectorized testing dataframe 270 and the appended element of testing output 284.

By way of example, the elements of testing log data 286 may characterize the application of the instantiated machine-learning or artificial-intelligence process to the rows of vectorized testing dataframe 270, and may include, but are not limited to, performance data (e.g., execution times, memory or processor usage, etc.) and the initial values of the processes parameters associated with the instantiated machine-learning or artificial-intelligence process, as described herein. Further, the elements of training log data 252 may also include elements of explainability data characterizing the predictive performance and accuracy of the machine-learning or artificial-intelligence process during application to vectorized testing dataframe 270, such as, but not limited to, the Shapley feature values that characterize a relative importance of each of the discrete features within vectorized testing dataframe 270 and the values of one or more deterministic or probabilistic metrics that characterize the relative importance of discrete ones of the features.

Executed AI/ML training engine 168 may perform operations that provision vectorized testing output 288 (e.g., including the rows of vectorized testing dataframe 270 and the appended elements of testing output 284) and the elements of testing log data 286 to executed artifact management engine 183, e.g., as further output artifacts 290 of executed AI/ML training engine 168 within training pipeline 145. In some instances, executed artifact management engine 183 may receive each of further output artifacts 290, and may perform operations that store further output artifacts 290 within a portion of AI/ML training artifact data 258, e.g., within data record 153 associated with training pipeline 145 and run identifier 155A.

Although not illustrated in FIG. 2D, executed AI/ML training engine 168 may perform operations that, based on the Shapley values and/or the values of the one or more deterministic or probabilistic metrics maintained within the explainability data of testing log data 286, determine whether the trained and validated gradient-boosted, decision-tree process satisfies one or more threshold conditions for deployment and real-time application to elements of confidential data within a production environment. As described herein, the one or more threshold conditions may specify that one, or more, of the computed recall-based values, the computed precision-based values, or the computed AUC or MAUC values (e.g., as maintained within validation log data 278) exceed, or alternatively, fall below a corresponding, metric-specific threshold value, which may be specified within updated elements 274 of configuration data.

If, for example, executed AI/ML training engine 168 were to establish that the trained and validated gradient-boosted, decision-tree process fails to satisfy at least one of the threshold conditions for deployment, computing system 130 may establish that the gradient-boosted, decision-tree process is insufficiently accurate for deployment and a real-time application to the confidential data within the production environment. Based on the determination that the gradient-boosted, decision-tree process fails to satisfy at least one of the threshold conditions for deployment, executed AI/ML training engine 168 may perform any of the exemplary processes described herein to modify a composition of feature vectors 264 and 266 (e.g., associated with vectorized validation dataframe 268 and vectorized testing dataframe 270, respectively) and additionally, or alternatively, a value of one or more of the parameters of the gradient-boosted, decision-tree process. In some instances, executed orchestration engine 140 may perform operations that trigger a performance of one or more of the adaptive training and validation processes described herein by executed feature-generation engine 166 and executed AI/ML training engine 168, e.g., in accordance with the modified composition of the feature vectors or the modified parameter values of the gradient-boosted, decision-tree process.

Alternatively, if executed AI/ML training engine 168 were to establish that the gradient-boosted, decision-tree process satisfies each of the threshold conditions for deployment (e.g., based on the explainability data within testing log data 286), computing system 130 may establish that the gradient-boosted, decision-tree process is sufficiently accurate for deployment and a real-time application to the confidential data within the production environment, and that exemplary processes for training adaptively, and subsequently validate and test, the gradient-boosted, decision-tree process are complete within training pipeline 145.

Through an implementation of one or more of the exemplary processes described herein, the distributed or cloud-based computing components of computing system 130 may implement a generalized and modular computational framework that facilitates an adaptive training of a first machine-learning or artificial-intelligence process (e.g., the gradient-boosted, decision-tree processes described herein, such as an XGBoost process) to predict, at a temporal prediction point, a likelihood of an occurrence of a attrition event involving a customer of the organization and one or more provisioned services during a target, future temporal interval subsequent to the temporal prediction point and separated from the temporal prediction point by a corresponding buffer interval. Further, the generalized and modular computational framework implemented by the distributed or cloud-based computing components of computing system 130 may also facilitate an adaptive training of a second machine-learning or artificial-intelligence process (e.g., an unsupervised machine-learning process, such as a clustering process) to assign at least a subset of the customers associated with likely occurrences of the attrition events during the target, future temporal intervals to clustered groups associated with descriptive, and interpretable, contribution values or ranges of contribution values, e.g., based on explainability data characterizing the trained machine-learning or artificial-intelligence process. In some instances, described herein, data characterizing the assigned, clustered groups and characterizing the descriptive, and interpretable, contribution values or ranges of contribution values may, when provisioned to a computing system of an organization, facilitate a programmatic modification of an operation of one or more applications programs executed at the computing system, and an enhanced programmatic communication between the executed application program and devices operable by corresponding ones of the customers, which may reduce the likelihood of the occurrence of attrition events involving these customers.

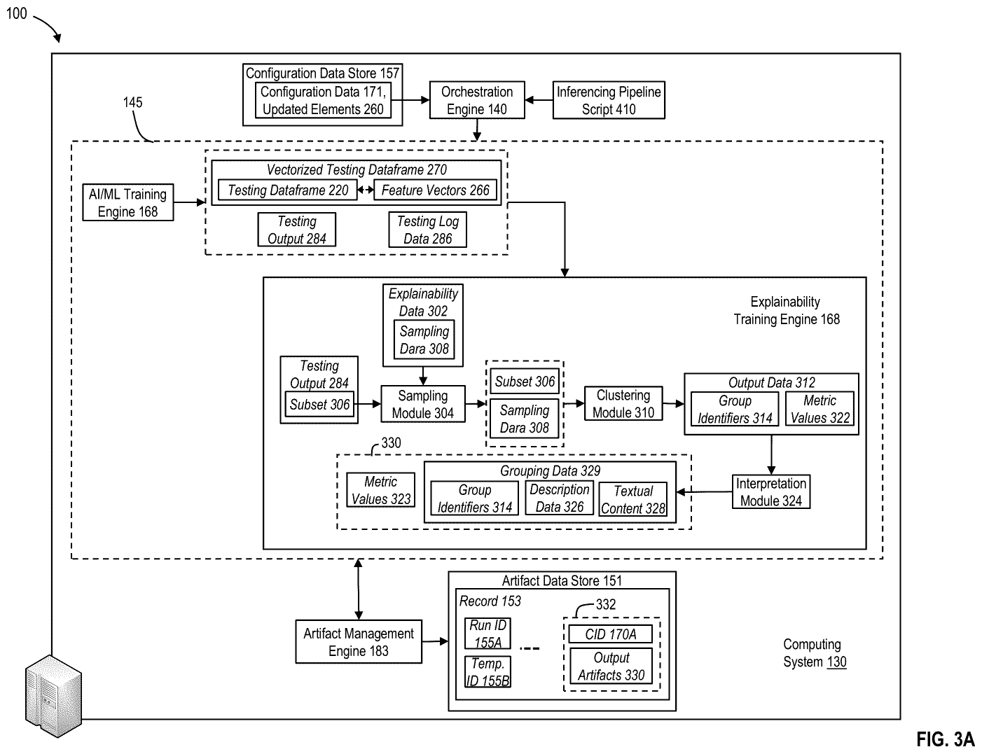

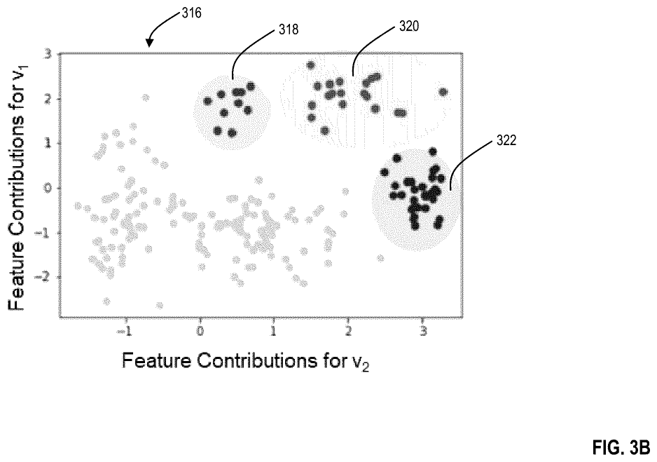

Referring to FIG. 3A, and in accordance with training pipeline 145, executed orchestration engine 140 may cause executed AI/ML training engine 168 to provision each of vectorized testing dataframe 370 (including testing dataframe 220 and feature vectors 266), testing output 284 and testing log data 286 as inputs to an explainability training engine 170 executed by the one or more processors of computing system 130. As described herein, each of the elements of testing output 284 may each indicate, for the values of the primary keys within vectorized testing dataframe 270 (e.g., the alphanumeric, customer identifier and the timestamp, as described herein), the predicted likelihood of the occurrence, or non-occurrence, of an attrition event involving a corresponding customer of the organization and one or more provisioned products or services during a two-month, future temporal interval separated from a temporal prediction point (e.g., the corresponding timestamp) by a two-month buffer interval. As described herein, each of the elements of testing output 284 may include a predicted value ranging from zero to unity, with a value of zero being indicative of a minimal likelihood of the occurrence of the attrition event during the two-month, future temporal interval, and with a value of unity being indicative of a maximum likelihood of the occurrence of the attrition event during the two-month, future temporal interval.

Testing log data 286 may also include row-specific elements of explainability data 302, and the row-specific elements of explainability data 302 may characterize the application of the machine-learning or artificial-intelligence process (e.g., the gradient-boosted, decision-tree process, such as the XGBoost process described herein) to the rows vectorized testing dataframe 270, which are associated with corresponding customers of the organization (e.g., the small-business banking customers of the financial institution, as described herein). By way of example, each of the row-specific elements of explainability data 302 may include, but are not limited to, Shapley feature values that characterize a relative importance of each of the discrete features within vectorized testing dataframe 270 (e.g., within feature vectors 266) on the element of testing output 284 indicating the likelihood of the occurrence, or non-occurrence, of an attrition event involving the corresponding customer of the organization and the one or more provisioned products or services during the two-month, future temporal interval.

The disclosed embodiments are, however, not limited to the row-specific elements of explainability data 302 that include Shapley values, and in other examples, the row-specific elements of explainability data 302 may also include values of one or more deterministic or probabilistic metrics that characterize the relative importance of discrete ones of the features within vectorized testing dataframe 270 and additionally, or alternatively, performance data (e.g., execution times, memory or processor usage, etc.). Further, although not illustrated in FIG. 3, executed orchestration engine 140 may cause executed AI/ML training engine 168 to provision, as additional inputs to executed explainability training engine 170, each of training output 250 and validation output 276, and each of training log data 252 and validation log data 278, which include additional elements of explainability data, such as those exemplary elements described herein.

Further, within training pipeline 145, executed orchestration engine 140 may also provision elements of configuration data 171 maintained within configuration data store 157 and additionally, or alternatively, updated elements 260 of configuration data, to executed explainability training engine 170. In some instances, the elements of configuration data 171 may identify the second machine-learning or artificial-intelligence process (e.g., in scripts callable in a namespace of executed explainability training engine 170) and an initial value of one or more parameters that facilitate the adaptive training of the second machine-learning or artificial-intelligence process. Further, updated elements 260 of configuration data may, for example, include a unique feature identifier (e.g., a feature name, etc.) of each of the sequentially ordered features, and corresponding feature values, maintained within feature vectors 266 of vectorized testing dataframe 270.

In some instances, the second machine-learning or artificial-intelligence process may include an unsupervised machine-learning process, such as a clustering process, and examples of the clustering process may include, but are not limited to, a centroid-based clustering process, such as a k-means clustering process or processes hat maximum corresponding Silhouette values, a model-based clustering process (e.g., that rely on specified distribution models, such as Gaussian distributions), density-based clustering processes (e.g., a DBSCAN™ process), a grid-based clustering process, or a grid-based clustering process. Further, and in addition to including one or more initial parameter values of the clustering process, the elements of configuration data 171 may also include a value of a threshold population metric that enables executed explainability training engine 170 to select a subset of the customers of the organization, and a corresponding subset of the elements of explainability data 300, for training the second machine-learning or artificial-intelligence process. Examples of the value of the threshold population metric include, but are not limited to, a threshold number of customers associated with the predicted values of largest magnitude, or a threshold percentage of the customers associated with the predicted values of largest magnitude (e.g., five percent, ten percent, etc.).

Referring back to FIG. 3A, an sampling module 304 of executed explainability training engine 170 may access the elements of configuration data 171 and testing output 284, which includes, for each of the corresponding customers, a unique customer identifier (e.g., an alphanumeric login credential, etc.) and the corresponding predicted value. In some instances, executed sampling module 304 may perform operations that rank the pairs of customer identifiers and predicted values within testing output 284 in accordance with the magnitude of the predicted values, e.g., from highest predicted likelihood of the occurrence of the attrition event due to the target, future temporal interval, and select a subset 306 of the ranked pairs of customer identifiers and predicted values in accordance with the threshold population metric value maintained within the elements of configuration data 171. For example, and based on the threshold population metric value, sampling module 304 may select the threshold number of the ranked pairs of customer identifiers and predicted values associated with predicted values of largest magnitude (e.g., 500 pairs, 1,000 pairs, 10,000 pairs, etc.) or the threshold percentage of the ranked pairs of customer identifiers and predicted values associated with predicted values of largest magnitude (e.g., five percent, etc.), and may perform operations that package the threshold number or the threshold percentage of the ranked pairs into corresponding portions of subset 306.

Further, executed sampling module 304 may also perform operations that access the elements of explainability data 302 maintained within testing log data 286, and obtain sets of Shapley values that characterize the application of the trained, gradient-boosted, decision tree process to the features vectors associated with the customer identifiers maintained within subset 306 (e.g., feature vectors 266 associated corresponding, customer-specific rows of testing dataframe 220). In some instances, executed sampling module 304 may package the obtained sets of Shapley values into corresponding portions of sampling data 308, along with corresponding ones of the customer identifiers, and provide subset 306 and sampling data 308 as inputs to a clustering module 310 of executed explainability training engine 170, which may perform any of the exemplary processes described herein to apply the second machine-learning or artificial-intelligence process to all, or a selected subset, of the feature-specific Shapley values, e.g., which characterize a relative contribution and a relative importance of corresponding ones of the feature values to the predicted values, and which are generated through the application of the first machine-learning or artificial-intelligence process (e.g., the trained, gradient-boosted, decision-tree processes) to feature vectors 266 of vectorized testing dataframe.

In some instances, the customer-specific sets of Shapley values within sampling data 308 may establish, for corresponding one of the customers, a multi-dimensional space of Shapley values characterized by a dimension equivalent to the number of discrete features within feature vectors 266, e.g., as specified within updated elements 260 of configuration data. Executed clustering module 310 may access the elements of configuration data 171, and may perform operations that obtain the information identifying the second machine-learning or artificial-intelligence process (e.g., the executable scripts associated with the clustering process described herein), and that cause the one or more processors of computing system 130 to execute the scripts and apply the clustering process to the customer-specific sets of Shapley values within sampling data 308, e.g., across all or a subset of the Shapley-value dimensions. Based on the application of the clustering process to the customer-specific sets of Shapley values, executed clustering module 310 may generate elements of output data 312 that associate discrete, clustered groups of the customers with a common Shapley values for one or more corresponding features, a common range of Shapley values for one or more corresponding features, or combinations of common Shapley values and/or common ranges of Shapley values for one or more corresponding features within the multi-dimensional Shapley-value space. By way of example, output data 312 may include group identifiers 314 of the discrete, clustered groups of the customers, and for each of discrete groups, output data 312 may associate a corresponding one of group identifiers 314 with the customer identifiers of the customers within the clustered group.

FIG. 3B provides a graphical representation 316 of an output of the application of the clustering process the customer-specific sets of Shapley values of sampling data 308 within a two-dimensional, Shapley-value space, e.g., based on features v₁ and v₂. Features v₁ and v₂ may, in some instances, represent those features that provide a maximum contribution to the predicted output of the trained, gradient-boosted, decision-tree processes, and as illustrated in FIG. 3B, the application of the clustering process may identify clustered groups 318, 320, and 322 of customers associated with common Shapley values for features v₁ and/or v₂, a common range of Shapley values for features v₁ and/or v₂, or combinations of common Shapley values and/or common ranges of Shapley values for features v₁ and/or v₂. Further, the elements of output data 312 may include unique, alphanumeric group identifiers for each of clustered groups 318, 320, and 322, and may associated the group identifiers for each of clustered groups 318, 320, and 322 with corresponding ones of the customer identifiers of the customers associated with clustered groups 318, 320, and 322.

Referring back to FIG. 3A, executed clustering module 310 may also perform operations that compute one or more metric values 323 that facilitate an interpretation, and a validation of a consistency, of the clustered groups of customers established through the application of the clustering process to sampling data 308, such as, but not limited to, clustered groups 318, 320, and 322. For example, the one or more metric values 323 may include, but are not limited to, customer-specific silhouette values characterize a similarity of a corresponding customer to its assigned, clustered group (e.g., a measure of cohesion) when compared to other clustered groups (e.g., a measure of separation). The disclosed embodiments are, however, not limited to these exemplary metric values, and in other instances, executed clustering module 310 may compute a value of any additional or alternate metric that facilitates and interpretation of a validation of the clustering process.

In some instances, executed clustering module 310 may provide the elements of output data 312, which identifies each of the clustered groups and the customers clustered into each of the clustered groups, as an input to an interpretation module 324 of executed explainability training engine 170. As described herein, the elements of output data 312 associate each of group identifiers 314 with a corresponding plurality of customer identifiers, and for each of group identifiers 314, executed interpretation module 324 may perform operations that obtain a group-specific subset of feature vectors 266 (e.g., as maintained within vectorized testing dataframe 270) associated with each of the group-specific pluralities of customer identifiers. Further, and for each of group identifiers 314, executed interpretation module 324 may perform operations that determine a value of one or more feature values, or a range of one or more feature values, that characterize the customers clustered into the clustered group associated with the corresponding group identifier.

For example, the elements of description data 326 may specify that the clustered customers of clustered group 318 are characterized by values of feature v₁ that are less than-0.4, and values of feature v₂ that exceed zero, the elements of description data 326 may specify that the clustered customers of clustered group 320 are characterized by values of feature v₁ that range between zero and −0.4, and that the elements of description data 326 may specify that the clustered customers of clustered group 322 are characterized by values of feature v₁ that exceed zero, and values of feature v₂ that range between −2 and zero. In some instances, executed interpretation module 324 may package corresponding one of group identifiers 314 and elements of description data 326 into corresponding portions of grouping data 329.

Further, in some instances, executed interpretation module 324 may also perform operations that generate elements of human-interpretable, textual content 328 characterizing corresponding ones of the elements of description data 326 and associated with corresponding ones of the group identifiers 314. By way of example, executed interpretation module 324 may generate corresponding ones of the elements of textual content 328 based on an application of a trained natural language process, or of a large language model, such as a generating pre-trained transformer, to respective ones of the elements of description data 326 and additionally, or alternatively, to corresponding ones of the feature identifiers maintained within updated elements 260 of configuration data. Further, as illustrated in FIG. 3A, executed interpretation module 324 may package each of the elements of textual content 328 into a corresponding portion of grouping data 329, e.g., in conjunction with corresponding ones of group identifiers 314 and the elements of description data 326.

Executed explainability training engine 170 may also perform operations, described herein, that provision grouping data 329 (including group identifiers 314 and corresponding ones of the elements of description data 326 and textual content 328) and metric values 323 to executed artifact management engine 183, e.g., as output artifacts 330 of executed explainability training engine 170 within training pipeline 145. In some instances, executed artifact management engine 183 may receive each of output artifacts 330, and may perform operations that package component identifier 170A of executed explainability training engine 170 and each of output artifacts 330 into a portion of explainability training artifact data 332, e.g., within data record 153 associated with training pipeline 145 and run identifier 155A.

Further, although not illustrated in FIG. 3A, and upon completion of the current run of training pipeline 145, one or more additional application engines executed by the one or more processors of computing system 130 within the training pipeline 145, such as a reporting engine, may perform operations, consistent with corresponding elements of configuration data, that generate elements of pipeline reporting data that characterize an operation and a performance of the discrete, modular components executed by the one or more processors of computing system 130 within training pipeline 145, e.g., based on corresponding elements of artifact data 174, 192, 214, 226, 248, 258, and 332. By way of example, the generated elements of pipeline reporting data may establish a success, or failure, in an execution of corresponding ones of the application engines executed sequentially within training pipeline 145, e.g., by confirming that each of the generated elements of artifact data are consistent, or inconsistent, with corresponding ones of the operational constraints imposed on corresponding ones of executed application engines.

In some instances, the elements of pipeline reporting data may also characterize a predictive performance and accuracy of the first machine-learning or artificial-intelligence process (e.g., the gradient-boosted, decision tree process) during application to corresponding ones of vectorized training dataframe 244, vectorized validation dataframe 268, and vectorized testing dataframe 270, and a performance of the second machine-learning or artificial-intelligence process (e.g., the clustering process) during application to sampling data 308. By way of example, the elements of pipeline reporting data may process data that specifies the values of one or more process parameters of the trained, gradient-boosted, decision tree process, composition data that specifies a composition of, and sequential ordering of the feature values within, feature vectors associated with the trained, gradient-boosted, decision tree process, elements of the explainability data described herein (e.g., the Shapley values and/or the values of the probabilistic or deterministic metrics, etc.), and values of metrics characterizing a bias or a fairness of the trained, gradient-boosted, decision tree process and additionally, or alternatively, at a bias or a fairness associated with the calculations performed at all, or a selected subset, of the discrete steps of the execution flow established by training pipeline 145 (e.g., a value of an area under a ROC curve across one or more stratified segments of the ingested data samples characterized by a common value of one, or more demographic parameters, etc.). Further, the elements of pipeline reporting data may also include a value of one or more metrics that facilitate an interpretation, and a validation of a consistency, of the clustered groups of customers established through the application of the clustering process to sampling data 308, e.g., metric values 323 described herein.

The executed reporting engine may also perform operations that structure the generated elements of pipeline reporting data in accordance with the corresponding elements of configuration data (e.g., in DOCX format, in PDF format, etc.) and that output the elements of pipeline reporting data as corresponding output artifacts, which may be provisioned to executed artifact management engine 183, e.g., for maintenance within record 153 of artifact data store 151 associated with run identifier 155A. Further, in some instances, computing system 130 may provision all, or a selected portion, of the elements of pipeline reporting data across network 120 to developer system 102, e.g., via a web-based interactive computational environment, such as a Juypter™ notebook or a Databricks™ notebook, implemented by a web browser executed by the one or more processors of developer system 102. Further, in some instances, the executed web browser may cause developer system 102 to present all, or a selected portion, of the elements of pipeline reporting data within display screens of a corresponding digital interface of the web-based interactive computational environment.

B. Exemplary Processes for Predicting Future Occurrences of Events using Coupled Machine-Learning and Explainability Processes

As described herein, one or more computing systems associated with or operated by a financial institution, such as one or more of the distributed components of computing system 130, may perform operations that implement a generalized and modular computational framework facilitating an adaptive training of a first machine-learning or artificial-intelligence process (e.g., the gradient-boosted, decision-tree processes described herein, such as an XGBoost process) to predict, at a temporal prediction point, a likelihood of an occurrence of a attrition event involving a customer of the organization and one or more provisioned services during a target, future temporal interval subsequent to the temporal prediction point and separated from the temporal prediction point by a corresponding buffer interval. Further, the generalized and modular computational framework implemented by the distributed computing components of computing system 130 may also facilitate an adaptive training of a second machine-learning or artificial-intelligence process (e.g., an unsupervised machine-learning process, such as a clustering process) to assign at least a subset of the customers associated with likely occurrences of the attrition events during the target, future temporal intervals to clustered groups associated with descriptive, and interpretable, contribution values or ranges of contribution values, e.g., based on explainability data characterizing the trained machine-learning or artificial-intelligence process (e.g., interpretable, and descriptive, explainability data).

Additionally, the generalized and modular computational framework implemented by the distributed components of computing system 130 may also facilitate, in real-time or in accordance with a predetermined schedule, an application of the trained first machine-learning or artificial-intelligence process (e.g., the trained, gradient-boosted, decision-tree process described herein, such the an XGBoost process) to feature vectors associated with corresponding customers of the organization and further, an application of the trained second machine-learning or artificial-intelligence process (e.g., the unsupervised machine-learning process, such as a clustering process described herein) to the feature vectors associated with at least a subset of the customers of the organization. In some instances, based on the application of the trained, gradient-boosted, decision-tree process to the customer-specific feature vectors, the distributed components of computing system 130 may predict, and a corresponding temporal prediction point, a likelihood of an occurrence of a attrition event involving corresponding customers of the organization and one or more provisioned services during a target, future temporal interval subsequent to the temporal prediction point and separated from the temporal prediction point by a corresponding buffer interval, and based on an application of the trained clustering process to the feature vectors associated with at least the subset of the customers, the distributed components of computing system 130 may assign each of the subset of the customers to corresponding clustered groups associated with descriptive, and interpretable, feature values or ranges of feature values.

The assignment of each of the subset of the customers to corresponding clustered groups, and the association of these clustered groups with the descriptive, and interpretable, feature values or ranges of feature values may provide and facilitate an explanation for the likely attrition of the subset of the customers. Further, when provisioned to a computing system of the organization, data characterizing the assigned, clustered groups and the descriptive, and interpretable, feature values or ranges of features values may, facilitate a programmatic modification of an operation of one or more applications programs executed at the computing system, and an enhanced programmatic communication between the executed application program and devices operable by corresponding ones of the customers, which may reduce the likelihood of the occurrence of attrition events involving these customers.

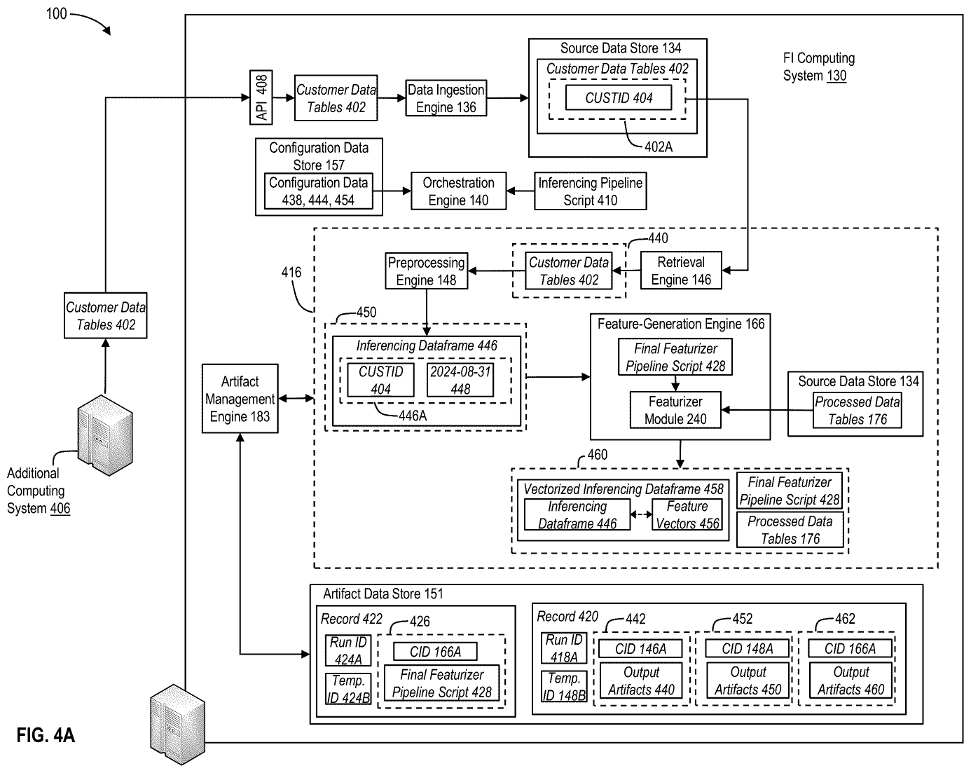

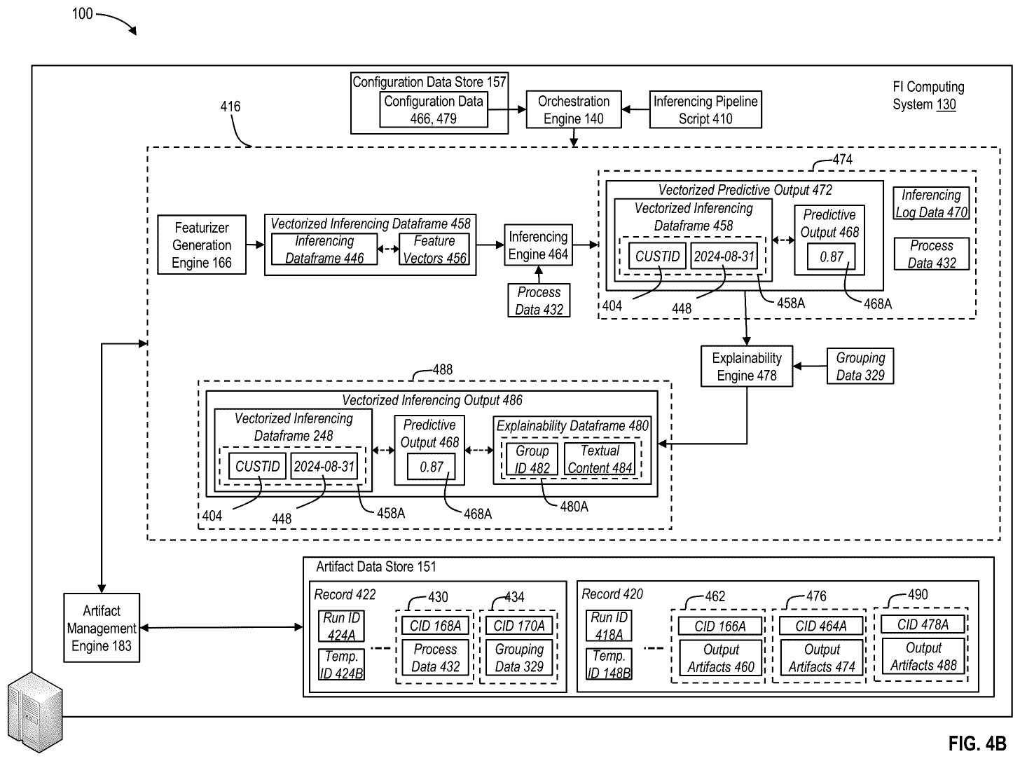

Referring to FIG. 4A, source data store 134 of computing system 130 may maintain one or more customer data tables 402, and each of the customer data tables may be associated with a corresponding customer of the organization, such as, but not limited to, a small-business banking customer that participates on one or more small-business banking services provisioned by the financial institution. As illustrated in FIG. 4A, each of customer data tables 402 may include a unique identifier of the corresponding customer, such as, but not limited to, customer identifier 404 maintained within customer data table 402A. Further, in some instances, computing system 130 may, for example, receive all, or a selected portion, of customer data tables 402 from an additional computing system 406 associated with the organization and the one of more provisioned services, e.g., in accordance with a predetermined temporal schedule (e.g., at a predetermined time on a monthly or daily basis, etc.), on a continuous, streaming basis, or in response to a request generated by computing system 130. By way of example, additional computing system 406 may be associated with the financial institution, and may execute one or more application programs that provision the small-business banking services to the small-business banking customers.

In some examples, additional computing system 406 may represent a computing system that includes one or more servers and tangible, non-transitory memories storing executable code and application modules, engines, and programs. Further, the one or more servers may each include one or more processors (such as a central processing unit (CPU)), which may be configured to execute portions of the stored code or application modules, engines, and programs to perform operations consistent with the disclosed embodiments. Additional computing system 406 may also include a communications interface, such as one or more wireless transceivers, coupled to the one or more processors for accommodating wired or wireless internet communication with other computing systems and devices operating within environment 100. In some instances, additional computing system 406 may be incorporated into a discrete computing system, although in other instances, additional computing system 406 may correspond to a distributed computing system having a plurality of interconnected, computing components distributed across an appropriate computing network, such as communications network 120 of FIG. 1, or to a publicly accessible, distributed or cloud-based computing cluster, such as a computing cluster maintained by Microsoft Azure™ Amazon Web Services™, Google Cloud™, or another third-party provider.

Referring back to FIG. 4A, the one or more application programs executed by the one or more processors of additional computing system 406 may transmit subsets of customer data tables 402 (including customer data table 402A) across communications network 120 to computing system 130 in accordance with the predetermined temporal schedule (e.g., at the predetermined time on a monthly or daily basis, etc.), and a programmatic interface established and maintained by computing system 130, such as application programming interface (API) 406, may receive the subsets of customer data tables 402 from computing system 403.

API 408 may, for example, route each of the subsets of customer data tables 402 to executed data ingestion engine 132, which may perform operations that store the subsets of customer data tables 402 within one or more tangible, non-transitory memories of computing system 130, such as within source data store 134. Further, and as described herein, source data store 134 may also store processed data tables 176, which identify and characterize corresponding customers of the organization during corresponding temporal intervals. For example, each of processed data tables 176 may maintain a unique customer identifier of the corresponding customer (e.g., the alphanumeric login credential described herein), a temporal identifier of the corresponding temporal interval, and consolidated data elements that identify and characterize the corresponding customer during the corresponding temporal interval.

As described herein, the distributed components of computing system 130 may perform operations, described herein, that apply the trained first machine-learning or artificial-intelligence process (e.g., the trained, gradient-boosted, decision-tree process described herein, such the an XGBoost process) to feature vectors associated with corresponding customers of the organization, and that apply the trained second machine-learning or artificial-intelligence process (e.g., the unsupervised machine-learning process, such as a clustering process described herein) to the feature vectors associated with at least a subset of the customers of the organization, in accordance with a predetermined schedule, such as, but not limited to, the final business day of each month. For example, on Aug. 31, 2024, the one or more processors of computing system 130 may execute orchestration engine 140, and obtain inferencing pipeline script 410 from a portion of script data store 142.

Inferencing pipeline script 410 may, for example, be maintained in Python™ format within script data store 142, and inferencing pipeline script 410 may specify an execution flow of discrete application engines within a corresponding inferencing pipeline (e.g., an order of sequential execution of each of the application engines within the inferencing pipeline). In some instances, inferencing pipeline script 410 may specify, for each of the sequentially executed application engines within in the inferencing pipeline, corresponding elements of engine-specific configuration data (e.g., maintained within configuration data store 157 in a human-readable data-serialization language, such as, but not limited to, a YAML™ data-serialization language or an extensible markup language (XML)), one or more input artifacts ingested by the sequentially executed application engine, and additionally, or alternatively, one or more output artifacts generated by the sequentially executed application engine. By way of example, and as described herein, the default training pipeline may include retrieval engine 146, preprocessing engine 148, feature-generation engine 166, inferencing engine 412 and explainability engine 414, which may be executed sequentially by the one or more processors in accordance with the execution flow.

Executed orchestration engine 140 may trigger an execution of inferencing pipeline script 410 by the one or more processors of computing system 130, which may establish the inferencing pipeline, e.g., inferencing pipeline 416. In some instances, upon execution of inferencing pipeline script 410, executed orchestration engine 140 may generate a unique, alphanumeric identifier, e.g., run identifier 418A, for a current run of inferencing pipeline 416 in accordance with the corresponding elements of engine-specific configuration data, and executed orchestration engine 140 may provision run identifier 418A to artifact management engine 183 via artifact API. Executed artifact management engine 183 may perform operations that, based on run identifier 418A, associate one or more data record 420 of artifact data store 151 with the current run of inferencing pipeline 416, and that store run identifier 418A within data record 420 along with a corresponding temporal identifier 418B indicative of date at which executed orchestration engine 140 executed inferencing pipeline script 410 and established inferencing pipeline 416 (e.g., on Aug. 31, 2024).

Upon execution by the one or more processors of computing system 130, each of the application engines executed sequentially within inferencing pipeline 416 may ingest one or more input artifacts and corresponding elements of configuration data specified within executed inferencing pipeline script 410, and may generate one or more output artifacts. In some instances, executed artifact management engine 183 may obtain the output artifacts generated by corresponding ones of these application engines, and store the obtained output artifacts within a corresponding portion of data record 420, e.g., in conjunction within a unique, alphanumeric component identifier of the corresponding one of the executed application engines and run identifier 418A.

Further, and in addition to data record 420 characterizing the current run of inferencing pipeline 416, executed artifact management engine 183 may also maintain, within artifact data store 151, data records characterizing prior runs of inferencing pipeline 416 and one or more prior runs of training pipeline 145. For example, as illustrated in FIG. 4B, artifact data store 151 may also include additional data record 422, which characterizes the output artifacts generated by (and in some instances, the input artifacts ingested by), each of the application engines executed sequentially by the one or more processors of computing system 130 during the final training run of training pipeline 145. Additional data record 422 may include a unique, alphanumeric identifier 424A of the final training run of training pipeline 145, a temporal identifier 424B that identifies an initiation time or date of final training run of training pipeline 145, and elements of engine-specific artifact data that include the output artifacts generated by corresponding ones of the sequentially application engines and that associate each of the engine-specific output artifacts with a corresponding component identifier.

By way of example, the elements of engine-specific artifact data may include, among other things, elements of feature-generation artifact data 426, which include component identifier 166A of feature-generation engine 166 and a final featurizer pipeline script 428 generated by executed feature-generation engine 166 during the final training run of training pipeline 145, elements of training artifact data 430, which include component identifier 168A of AI/ML training engine 168 and elements of process data 432 characterizing the trained first machine-learning or artificial-intelligence process (e.g., the trained, gradient-boosted, decision-tree process described herein), and elements of explainability training artifact data 434, which include component identifier 170A of explainability training engine 170 and elements of grouping data 329 associated with the trained, clustering process. As described herein, final featurizer pipeline script 428 may establish a final featurizer pipeline of sequentially executed ones of the mapped, default stateless transformation and the mapped, default estimation operations that, upon application to the rows of corresponding ones processed data tables 176, generate a feature vector appropriate for ingestion by the first trained machine-learning or artificial-intelligence process. Further, the elements of process data 432 include the values of one or more process parameters associated with the trained machine-learning or artificial-intelligence process. Additionally, as described herein, the elements of grouping data 329 may include group identifiers 314 of corresponding plurality of clustered groups, elements of description data 326 specifying the value of one or more feature values, and/or the range of one or more feature values, that characterize the customers clustered into the clustered groups, and elements of human-interpretable, textual content 328 characterizing corresponding ones of the elements of description data 326.

Referring back to FIG. 4A, executed inferencing pipeline script 410 may trigger an execution of retrieval engine 146 by the one or more one or more processors of computing system 130, and orchestration engine 140 may provision elements of configuration data 438 to the programmatic interface associated with executed retrieval engine 146 (e.g., as corresponding input artifacts), and may perform any of the exemplary processes described herein to establish a consistency of the corresponding input artifacts with the engine- and pipeline-specific operational constraints imposed on executed retrieval engine 146. Based on an established consistency of the input artifacts with the imposed engine- and pipeline-specific operational constraints, executed retrieval engine 146 may perform operations, described herein, to access source data store 134, and obtain customer data tables 402 (including customer data table 402A) in accordance with the elements of configuration data 438. As described herein, each of customer data tables 402 may maintain the unique, customer identifier associated with the corresponding customer of the organization (e.g., the small-business banking customer of the financial institution, as described herein, etc.), and executed retrieval engine 146 may also perform provision customer data tables 402 to executed artifact management engine 183, e.g., as output artifacts 440 of executed retrieval engine 146.

In some instances, executed artifact management engine 183 may receive each of output artifacts 440 via the artifact API, and may perform operations that package each of output artifacts 440 into a corresponding portion of retrieval artifact data 442, along with identifier 146A of executed retrieval engine 146, and that store retrieval artifact data 442 within a corresponding portion of artifact data store 151, e.g., within data record 420 associated with inferencing pipeline 416 and run identifier 418A. Further, and in accordance with inferencing pipeline 416, executed retrieval engine 146 may provide output artifacts 440, including customer data tables 402, as inputs to preprocessing engine 148 executed by the one or more processors of computing system 130, and executed orchestration engine 140 may provision one or more elements of configuration data 444 maintained within configuration data store 157 to executed preprocessing engine 148, e.g., in accordance with executed inferencing pipeline script 410. In some instances, the programmatic interface associated with executed preprocessing engine 148 may ingest each of customer data tables 402 and one or more elements of configuration data 444 (e.g., as corresponding input artifacts), and may perform any of the exemplary processes described herein to establish a consistency of the corresponding input artifacts with the engine- and pipeline-specific operational constraints imposed on executed preprocessing engine 148.

Based on an established consistency of the input artifacts with the imposed engine- and pipeline-specific operational constraints, executed preprocessing engine 148 may perform operations that apply one or more preprocessing operations to corresponding ones of customer data tables 402 in accordance with the elements of configuration data 444 (e.g., through an execution or invocation of each of the specified default scripts or classes within the namespace of executed preprocessing engine 148, etc.). As described herein, each of customer data tables 402 may include a unique identifier of a corresponding customer, such as, but not limited to, customer identifier 404 maintained within customer data table 402A. For example, and based on the application of the preprocessing operations to corresponding ones of customer data tables 402, executed preprocessing engine 148 may parse each of customer data tables 402 and obtain the corresponding customer identifier, which executed preprocessing engine 148 may package into a corresponding, customer-specific row of inferencing dataframe 446.

Further, executed preprocessing engine 148 may also perform operations that generate a temporal identifier 448 associated with the Aug. 31, 3034, initiation of inferencing pipeline 416 (e.g., the temporal prediction point for the exemplary inferencing processes described herein), and package temporal identifier 448 into a corresponding portion of each row of inferencing dataframe 446. For example, as illustrated in FIG. 4A, row 446A of inferencing dataframe 446 may include customer identifier 404 of the corresponding customer (e.g., “CUSTID”) and temporal identifier 448 (e.g., “2024 Aug. 31”). In some instances, executed preprocessing engine 148 may perform operations that provision inferencing dataframe 446 to executed artifact management engine 183, e.g., as output artifacts 450 of executed preprocessing engine 148. Executed artifact management engine 183 may receive each of output artifacts 450 via the artifact API, and may perform operations that package each of output artifacts 450 into a corresponding portion of preprocessing artifact data 452, along with identifier 148A of executed preprocessing engine 148, and that store preprocessing artifact data 452 within a corresponding portion of artifact data store 151, e.g., within data record 420 associated with inferencing pipeline 416 and run identifier 418A.

In accordance with inferencing pipeline 416, executed preprocessing engine 148 may provide output artifacts 450, including inferencing dataframe 446, as input to feature-generation engine 166 executed by the one or more processors of computing system 130. In some instances, within inferencing pipeline 416, executed orchestration engine 140 may provision, to executed feature-generation engine 166, one or more elements of configuration data 454 maintained within configuration data store 157. Further, and based on programmatic communications with executed artifact management engine 183, executed orchestration engine 140 may perform operations that obtain processed data tables 176, and that obtain a featurizer pipeline script associated with a final training run of training pipeline 145 and with the first, trained machine-learning or artificial-intelligence process, such as, but not limited to, a final featurizer pipeline script 428 maintained as a portion of feature-generation artifact data 426 within data record 422 of artifact data store 151. Executed orchestration engine 140 may provision final featurizer pipeline script 428 and each of processed data tables 176 as additional input to executed feature-generation engine 166.

In some instances, the programmatic interface of executed feature-generation engine 166 may receive the elements of configuration data 454, final featurizer pipeline script 428, processed data tables 176, and inferencing dataframe 446 (e.g., as corresponding input artifacts), and may perform operations that establish a consistency of these input artifacts with the engine- and pipeline-specific operational constraints imposed on executed feature-generation engine 166. Based on an established consistency of the input artifacts with the imposed engine- and pipeline-specific operational constraints, executed feature-generation engine 166 may perform one or more of the exemplary processes described herein that, consistent with the elements of configuration data 454, generate a customer-specific feature vector of corresponding feature values for each row of inferencing dataframe 446.

For example, featurizer module 240 of executed feature-generation engine 166 may obtain final featurizer pipeline script 428, inferencing dataframe 446, and processed data tables 176, and executed featurizer module 240 may trigger an execution of final featurizer pipeline script 428 by the one or more processors of computing system 130. As described herein, the execution of final featurizer pipeline script 428 may establish the final featurizer pipeline of the sequentially executed ones of the mapped, default stateless transformation operations and the mapped, default estimation operations associated with the trained machine-learning or artificial-intelligence process, and the established, final featurizer pipeline may ingest processed data tables 176.

Within the established, final featurizer pipeline, executed featurizer module 346 may apply sequentially each of the mapped, default stateless transformation operations and the mapped, default estimation operations to the rows of processed data tables 176, and generate a corresponding feature vector of sequentially ordered feature values for each of the rows of inferencing dataframe 446, e.g., a corresponding one of feature vectors 456. As described herein, each of feature vectors 456 may include feature values associated with a corresponding set of features, and executed featurizer module 240 may perform operations that append each of feature vectors 456 to a corresponding row of inferencing dataframe 446, and that generate elements of a vectorized inferencing dataframe 458 that include each row of inferencing dataframe 446 and the appended one of feature vectors 456.

Further, executed featurizer module 346 may also perform operations that provision vectorized inferencing dataframe 458 and in some instances, final featurizer pipeline script 428 and processed data tables 176 to executed artifact management engine 183, e.g., as output artifacts 460 of executed feature-generation engine 166 within inferencing pipeline 416. In some instances, executed artifact management engine 183 may receive each of output artifacts 460, and may perform operations that package each of output artifacts 460 into a corresponding portion of feature-generation artifact data 462, along with identifier 166A of executed feature-generation engine 166, and that store feature-generation artifact data 460 within a portion of artifact data store 151, e.g., within data record 420 associated with inferencing pipeline 416 and run identifier 418A.

Referring to FIG. 4B, and in accordance with inferencing pipeline 416, executed feature-generation engine 166 may provide vectorized inferencing dataframe 458 as an input to inferencing engine 464 executed by the one or more processors of I computing system 130 within inferencing pipeline 416, e.g., in accordance with executed inferencing pipeline script 410. Further, and based on programmatic communications with executed artifact management engine 183, executed orchestration engine 140 may perform operations that obtain a value of one or more process parameters that characterize the trained machine-learning or artificial-intelligence process, such as, but not limited to, the elements of process data 432 maintained as a portion of AI/ML training artifact data 430 within data record 422 of artifact data store 151 (e.g., generated during the final training run of default training pipeline 145). Executed orchestration engine 140 may also provision the elements of process data 432, and the one or more elements of configuration data 466 maintained within configuration data store 157, as additional inputs to executed inferencing engine 464 within inferencing pipeline 416.

A programmatic interface associated with executed inferencing engine 464 may receive the elements of configuration data 466, the elements of process data 432, vectorized inferencing dataframe 458, e.g., as input artifacts, and the programmatic interface may perform operations that establish a consistency of these input artifacts with the engine- and pipeline-specific operational constraints imposed on executed inferencing engine 464. Based on an established consistency of the input artifacts with the imposed engine- and pipeline-specific operational constraints, executed inferencing engine 464 may cause the one or more processors of computing system 130 to perform operations that instantiate the trained first machine-learning or artificial-intelligence process specified within the elements of configuration data 466 (e.g., the trained, gradient-boosted, decision-tree process, such as the XGBoost process) in accordance with the values of the corresponding process parameters.

In some instances, as described herein, the elements of process data 432 may specify all, or a selected subset, of the process parameter values associated with the trained, gradient-boosted, decision-tree process, such as, but not limited to, those described herein (although in other instances, one or more of the process parameter values may be specified within the elements of configuration data 466). Further, the elements of configuration data 466 may include data that identifies the trained gradient-boosted, decision-tree process (e.g., a helper class or script associated with the XGBoost process and capable of invocation within the namespace of executed inferencing engine 464). In some instances, and based on the elements of configuration data 466, executed inferencing engine 464 may cause the one or more processors of computing system 130 to instantiate the gradient-boosted, decision-tree process (e.g., the XGBoost process) in accordance with the values of the corresponding process parameters.

Executed inferencing engine 464 may cause the one or more processors of computing system 130 may perform operations that establish a plurality of nodes and a plurality of decision trees for the trained gradient-boosted, decision-tree process, each of which receive, as inputs, each of the rows of vectorized inferencing dataframe 458, which include the corresponding row of inferencing dataframe 446 and the appended one of feature vectors 456. Based on the ingestion of the rows of vectorized inferencing dataframe 458 by the plurality of nodes and decision trees of the trained gradient-boosted, decision-tree process (e.g., which apply the trained, gradient-boosted, decision-tree process to each of the rows of vectorized inferencing dataframe 458), the one or more processors of computing system 130 may generate corresponding elements of predictive output 468 associated with the corresponding customer and temporal prediction point (e.g., Aug. 31, 2024), and elements of inferencing log data 470 that characterize the application of the trained machine-learning or artificial-intelligence process to the each row of vectorized inferencing dataframe 458.

As described herein, each element of predictive output 468 may indicate a likelihood of an occurrence of a attrition event involving a corresponding customer of the organization (e.g., associated with a corresponding row of vectorized inferencing dataframe 458) and one or more provisioned services during a target, future temporal interval subsequent to the temporal prediction point of Aug. 31, 2024, and separated from the temporal prediction point by a corresponding buffer interval. By way of the example, the target, future temporal interval and the buffer interval may each correspond to two-month intervals, and for the temporal prediction point of Aug. 31, 2024, each element of predictive output 468 may indicate a likelihood of an occurrence of a attrition event involving the corresponding customer and the one or more provisioned services during a target, future temporal disposed between Nov. 1, 2024, and Dec. 31, 2024, e.g., between two and four months subsequent to the temporal prediction point of Aug. 31, 2024. Further, and as described herein, each element of predictive output 468 may include a value ranging from zero to unity, with a value of zero being indicative of a minimal likelihood of the occurrence of the attrition event during the two-month, future temporal interval, and with a value of unity being indicative of a maximum likelihood of the occurrence of the attrition event during the two-month, future temporal interval, the customers of the organization may correspond to small-business banking customer of the financial institution that participate in small-business banking services provisioned by the financial institution.

By way of example, row 458A of vectorized inferencing dataframe 458 may include row 446A of inferencing dataframe 446 and a corresponding one of feature vectors 456 (not illustrated in FIG. 4B). As described herein, row 446A of inferencing dataframe 446 may include customer identifier 404 of a corresponding customer (e.g., “CUSTID”) and temporal identifier 448 of the temporal prediction point (e.g., “2024 Aug. 31”). Further, predictive output 468 may include an element 468A associated with row 446A and indicating that the corresponding customer (e.g., the small-business banking customer) is associated with an 87% change of ceasing participating in, and attriting from, the small-business banking services during the target, future temporal disposed between Nov. 1, 2024, and Dec. 31, 2024.

In some instances, the elements of inferencing log data 470 may include performance data characterizing the application of the trained machine-learning or artificial-intelligence process to the rows of vectorized inferencing dataframe 458 (e.g., execution times, memory or processor usage, etc.) and the values of the process parameters associated with the trained machine-learning or artificial-intelligence process, as described herein. Further, the elements of inferencing log data 470 may also include elements of explainability data characterizing the predictive performance and accuracy of the trained machine-learning or artificial-intelligence process during application to the rows of vectorized inferencing dataframe 458, such as, but not limited to, one or more of the Shapley values and the probabilistic or deterministic metric values described herein.

As illustrated in FIG. 4B, executed inferencing engine 464 may append each of the elements of predictive output 468 to the corresponding row of vectorized inferencing dataframe 458, and generate elements of vectorized predictive output 472 that include each row of vectorized inferencing dataframe 458 and the appended element of predictive output 468. Further, executed inferencing engine 464 may perform operations that provision vectorized predictive output 472, the elements of inferencing log data 468, and in some instances, the elements of process data 432, to executed artifact management engine 183, e.g., as output artifacts 474 of executed inferencing engine 464 within inferencing pipeline 416.

Executed artifact management engine 183 may receive each of output artifacts 474, and may perform operations that package each of output artifacts 474 into a corresponding portion of inferencing artifact data 476, along with a unique, component identifier 464A of executed inferencing engine 464, and that store inferencing artifact data 476 within a corresponding portion of artifact data store 151, e.g., within data record 420 associated with inferencing pipeline 416 and run identifier 418A. Further, and in accordance with inferencing pipeline 416, executed inferencing engine 464 may provide output artifacts 474, including vectorized predictive output 472 (e.g., the rows vectorized inferencing dataframe 458 and the appended elements of predictive output 468), as inputs to an explainability engine 478 executed by the one or more processors of computing system 130 within inferencing pipeline 416, e.g., in accordance with executed inferencing pipeline script 410.

Based on programmatic communications with executed artifact management engine 183, executed orchestration engine 140 may perform operations that obtain elements of grouping data 329 associated with the second trained machine-learning or artificial-intelligence process (e.g., the trained clustering process described herein), which may be maintained as a portion of explainability training artifact data 434 within data record 422 of artifact data store 151 (e.g., generated during the final training run of default training pipeline 145). As described herein, the elements of grouping data 329 may include group identifiers 314 of corresponding plurality of clustered groups, elements of description data 326 specifying the value of one or more feature values, and/or the range of one or more feature values, that characterize the customers clustered into the clustered groups, and elements of human-interpretable, textual content 328 characterizing corresponding ones of the elements of description data 326. Executed orchestration engine 140 may provision the elements of grouping data 329, and the one or more elements of configuration data 479 maintained within configuration data store 157, as additional inputs to executed explainability engine 478.

In some instances, and in accordance with the elements of configuration data 479, executed explainability engine 478 may obtain, from the vectorized inferencing dataframe 458, each of feature vectors 456 associated with, and characterizing, corresponding ones of the customers of the organization. As described herein, each of each of feature vectors 456 may include a plurality of sequentially ordered feature values, and based on the sequentially ordered feature values and on the elements of description data 326, which specify the value of one or more feature values and/or the range of one or more feature values that characterize the customers clustered into each of the clustered groups, executed explainability engine 478 may assign each of the customers to a corresponding one of the clustered groups, and obtain one or more elements of textual content 328 that interpret or “explain” the predicted likelihood of an occurrence of an attrition event involving the corresponding customer during the target, future temporal interval.

Executed explainability engine 478 may also perform operations, for corresponding ones of the customers, that package data characterizing the assigned, clustered group and the obtained elements of textual content 328 into a corresponding, customer-specific row of explainability dataframe 480. For example, as illustrated in FIG. 4B, row 480A of explainability dataframe 480 may maintain a group identifier 482 (e.g., “Group 2”) and elements 484 of textual content 328 explaining the group assignment (e.g., “low digital engagement”) for the customer associated with customer identifier 404 (e.g., within row 458A) of vectorized inferencing dataframe 458. In some instances, executed explainability engine 478 may also generate elements of vectorized inferencing output 486, which include and associate together the rows of vectorized inferencing dataframe 458, corresponding elements of predictive output 468, and corresponding rows of explainability dataframe 480). Further, executed explainability engine 478 may perform operations that provision vectorized inferencing output 486, and in some instances, the elements of grouping data 329, to executed artifact management engine 183, e.g., as output artifacts 488 of executed explainability engine 478 within inferencing pipeline 416.

Executed artifact management engine 183 may receive each of output artifacts 474, and may perform operations that package each of output artifacts 474 into a corresponding portion of inferencing artifact data 476, along with a unique, component identifier 464A of executed inferencing engine 464, and that store inferencing artifact data 476 within a corresponding portion of artifact data store 151, e.g., within data record 420 associated with inferencing pipeline 416 and run identifier 418A. Further, although not illustrated in FIG. 4B, executed artifact management engine 183 may also package, into a corresponding portion of explainability artifact data 490, additional data identifying and characterizing one or more of the input artifacts ingested by executed inferencing engine 464, and as described herein. Executed artifact management engine 183 may receive each of output artifacts 488, and may perform operations that package each of output artifacts 488 into a corresponding portion of explainability artifact data 490, along with a unique, component identifier 478A of executed explainability engine 478, and that store explainability artifact data 490 within a portion of artifact data store 151, e.g., within data record 420 associated with inferencing pipeline 416 and run identifier 418A.

Further, although not illustrated in FIG. 4B, and upon completion of the current run of inferencing pipeline 416, one or more additional application engines executed by the one or more processors of computing system 130 within the inferencing pipeline 416, such as a reporting engine, may perform operations, consistent with corresponding elements of configuration data, that generate elements of pipeline reporting data that characterize an operation and a performance of the discrete, modular components executed by the one or more processors of computing system 130 within training pipeline 145, e.g., based on corresponding elements of artifact data 442, 452, 462,. By way of example, the generated elements of pipeline reporting data may establish a success, or failure, in an execution of corresponding ones of the application engines executed sequentially within inferencing pipeline 416, e.g., by confirming that each of the generated elements of artifact data are consistent, or inconsistent, with corresponding ones of the operational constraints imposed on corresponding ones of executed application engines.

The executed reporting engine may also perform operations that structure the generated elements of pipeline reporting data in accordance with the corresponding elements of configuration data (e.g., in DOCX format, in PDF format, etc.) and that output the elements of pipeline reporting data as corresponding output artifacts, which may be provisioned to executed artifact management engine 183, e.g., for maintenance within record 153 of artifact data store 151 associated with run identifier 155A. Further, in some instances, computing system 130 may provision all, or a selected portion, of the elements of pipeline reporting data across network 120 to developer system 102, e.g., via a web-based interactive computational environment, such as a Juypter™ notebook or a Databricks™ notebook, implemented by a web browser executed by the one or more processors of developer system 102. Further, in some instances, the executed web browser may cause developer system 102 to present all, or a selected portion, of the elements of pipeline reporting data within display screens of a corresponding digital interface of the web-based interactive computational environment.

Additionally, and upon completion of the current run of inferencing pipeline 416, one or more additional application engines executed by the one or more processors of computing system 130 within the inferencing pipeline 416, such as a monitoring engine, may obtain elements of monitoring data characterizing a performance of at least one of the first trained artificial-intelligence process (e.g., the trained gradient-boosted, decision-tree process described herein or the trained second artificial-intelligence process (e.g., the trained, clustering process described herein) at predetermined temporal intervals (e.g., on a monthly basis) or in response to a request by developer system 102 or another computing system associated with the organization. The elements of monitoring data may include a value of one or more performance metrics, such as, but not limited to, a value of a feature population stability index (PSI) characterizing an input drift of the trained gradient-boosted, decision-tree process, and value of a score or cluster PRI characterizing an output drift in the trained gradient-boosted, decision-tree process and the trained clustering process, respectively, a value of a ROC-AUC, a PR-AUC, or a precision/recall at 5% of the trained gradient-boosted, decision-tree process, a silhouette value of the trained clustering process, and/or a value characterizing a stability of feature usage of the trained gradient-boosted, decision-tree process.

In some instances, the executed monitoring engine may perform operations that establish whether all, or a selected portion, of these elements of monitoring data satisfy a threshold condition at each of the predetermined temporal intervals (e.g., that corresponding values exceed, or fail to exceed, a threshold value, etc.). Based on the determination that each, or a selected portion, of the elements of monitoring data fail to satisfy the threshold condition at a corresponding one of the predetermined temporal intervals, the executed monitoring engine may perform operations that modify programmatically at least one of the composition of the input dataset for the trained gradient-boosted, decision-tree process, one or more first process parameters values for the trained gradient-boosted, decision-tree process, or one or more second process parameter values for the trained clustering process. In other instances, based on the determination that each, or a selected portion, of the elements of monitoring data fail to satisfy the threshold condition at a corresponding one of the predetermined temporal intervals, the executed monitoring engine may perform operations that cause executed orchestration engine 140 to trigger a re-initiation of training pipeline 145 and a retraining of the trained gradient-boosted, decision-tree process and/or the trained clustering process.

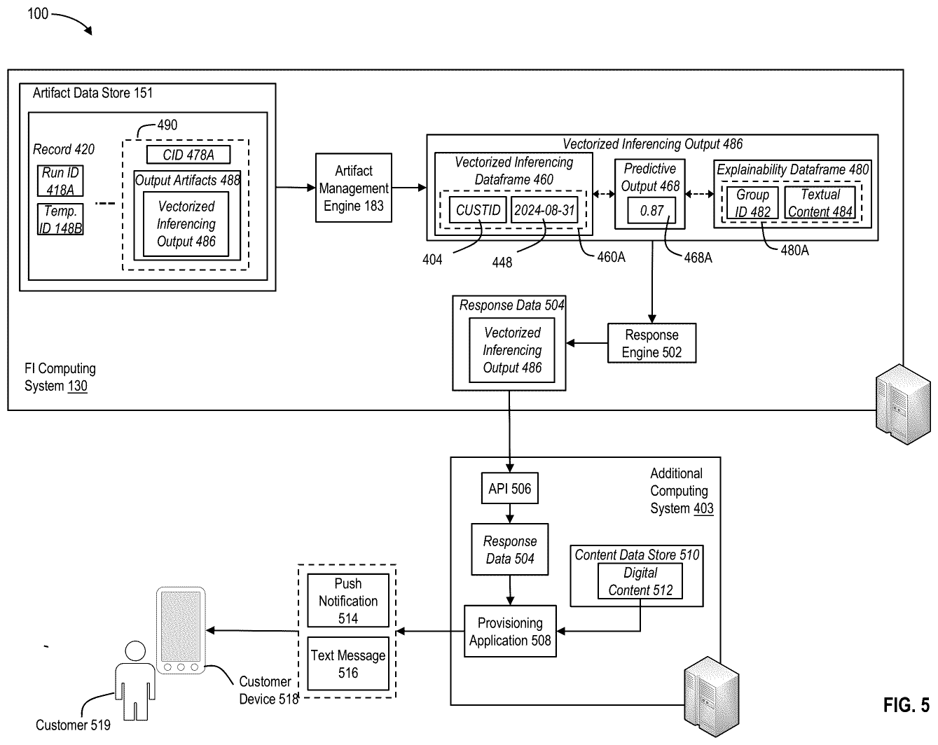

Referring to FIG. 5, executed artifact management engine 183 may perform operations that access explainability artifact data 490 within record 420 of artifact data store 151 (e.g., associated with the current run of inferencing pipeline 416), and may obtain the elements of vectorized inferencing output 486, which include vectorized inferencing dataframe 458, the elements of predictive output 468, and explainability dataframe 480. Executed artifact management engine 183 may provision the elements of vectorized inferencing output 486 as an input to a response engine 502 executed by the one or more processors of computing system 130, and executed response engine 502 may perform operations that package the elements of vectorized inferencing output 486 into corresponding portions of a response message 504, and that cause computing system 130 to transmit response message 504 across network 120 to additional computing system 406, e.g., as a response to customer data tables 402.

In some instances, a programmatic interface associated with one or more application programs executed at additional computing system 406, such as application programming interface (API) 506 of executed provisioning application 508, may receive response message 504, which includes the elements of vectorized inferencing output 486, and may route response message 504 to executed provisioning application 508. As described herein, additional computing system 406, and executed provisioning application 508, may each be associated with the organization and the one of more provisioned services. By way of example, additional computing system 406 may be associated with the financial institution, and executed provisioning application 508 may perform operations that provision the small-business banking services to corresponding ones of the small-business banking customers, and that manage programmatically communications that support the provisioning of the small-business banking services to the small-business banking customers.

Executed provisioning application 508 may receive response message 504, and may store response message 504 within the one or more tangible, non-transitory memories of additional computing system 406. Further, in some instances, executed provisioning application 508 may perform operations that parse the elements of vectorized inferencing output 486 and obtain the customer identifier associated with corresponding ones of the customers (e.g., as maintained within the rows of vectorized inferencing dataframe 458). Further, and based on the elements of predictive output 468 associated with the corresponding ones of the customers, and on the group assignments and human-interpretable elements of textual content that explain the likelihood of attrition characterized by the elements of predictive output 468, executed provisioning application 508 may perform operations that engage, proactively and programmatically, with a computing device or system of each of the customers identified within vectorized inferencing output 486, or of a subset of the identified customers (e.g., those customers associated with elements of predictive output 468 that include values exceeding a threshold value, etc.), in an attempt to maintain the participation of the customers in the provisioned services (e.g., the small-business banking services described herein) and the reduce the likelihood of occurrences of future attrition events involving these customers.

The programmatic engagement between executed provisioning application 508 and the computing systems or devices operable by the identified customers (or the subset of the identified customers) may be consistent with the group assignment (and the likelihood of the occurrence of the attrition event, as specified by the corresponding element of predictive output 468), and examples of the programmatic engagement may include, but are not limited to, a provisioning digital content consistent with the human-interpretable elements of textual content to one or more application programs executed by the computing systems or devices of the identified (e.g., via a push notification to a mobile application, such as a mobile banking application), generating and transmitting electronic messages (e.g., email messages, text messages, etc.) to a corresponding messaging application executed at the computing systems or devices of the identified customers.

By way of example, element 468A of predictive output 468 indicates an 87% likelihood that the customer associated with customer identifier 404 within vectorized inferencing dataframe 458 (e.g., “CUSTID”) will be involved in an attrition event during the target, future temporal disposed between Nov. 1, 2024, and Dec. 31, 2024. Further, and based on row 480A of explainability dataframe 480, the likelihood of the customer's involvement in the future attrition event may be associated with a low level of engagement of the customer with one or more digital channels provided by the financial institution, and results in the customer's assignment to the clustered group associated with group identifier 482 (e.g., clustered group “2”). In some instances, and based on the likelihood of the customer's involvement in the future attrition event and on the low level of engagement of the customer with one or more digital channels provided by the financial institution, executed provisioning application 508 may access content data store 510 (e.g., as maintained within the one or more tangible, non-transitory memories of additional computing system 406), and obtain elements of digital content 512 that are consistent with the predicted association between the likelihood of the customer's involvement in the future attrition event and the low level of engagement of the customer with one or more digital channels provided by the financial institution.

As illustrated in FIG. 5, executed provisioning application 508 may perform operations that generate one or more notifications or messages, such as push notification 514 and text message 516, that include at least a subset of the elements of digital content 512. In some instances, executed provisioning application 508 may perform operations that cause additional computing system 406 to transmit the one or more notifications or messages, such as push notification 514 and text message 516, across network 120 to a device 518 associated with the customer, e.g., customer 519, and further, to a device or computing system operable by one or more additional customers assigned to the clustered subgroup associated with group identifier 482 and textual content 484.

Although not illustrated in FIG. 5, a mobile application, such as a mobile banking application, executed by customer device 518 may receive push notification 514, process the elements of digital content 512 included within push notification 514, and present at least a subset of the elements of digital content 512 within one or more display screens of a corresponding digital interface, e.g., as a banner notification or within the executed mobile application. Additionally, or alternatively, a messaging application executed by customer device 518 may receive text message 516, process the elements of digital content 512 included within text message 516, and present at least a subset of the elements of digital content 512 within one or more display screens of a corresponding, additional digital interface. In some examples, the presented elements of digital content 512, when viewed by customer 519, may prompt customer 519 to increase a level of engagement within one or more digital channels of the financial institution, such as web-based interfaces or mobile application, and may reduce the predicted likelihood of occurrences of future attrition events involving customer 519 during the target, future temporal interval.

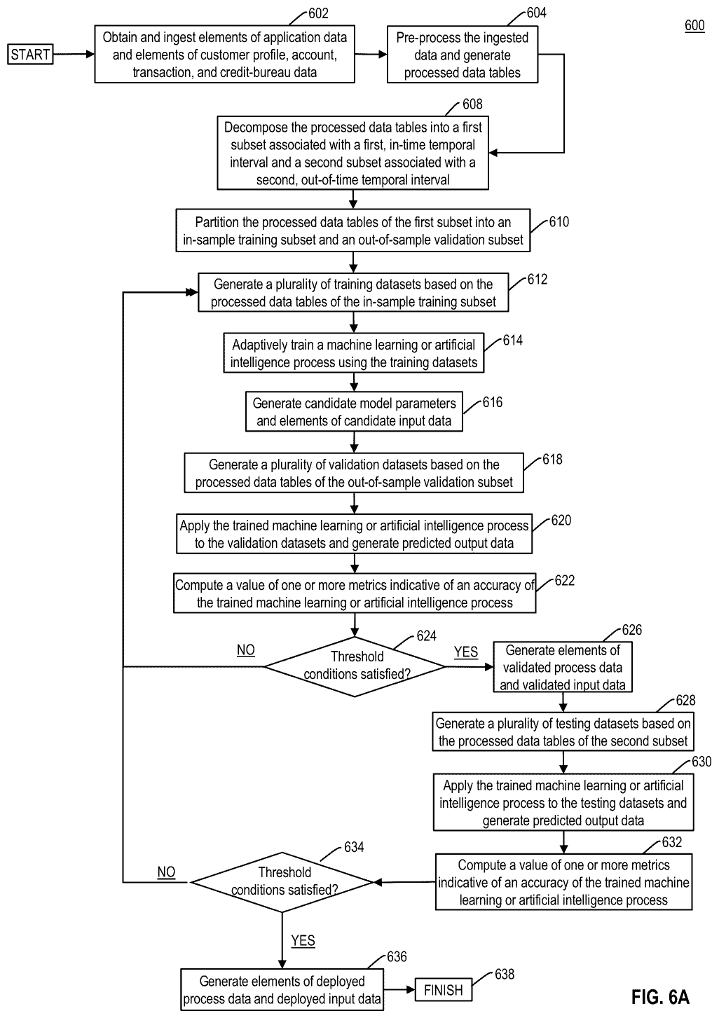

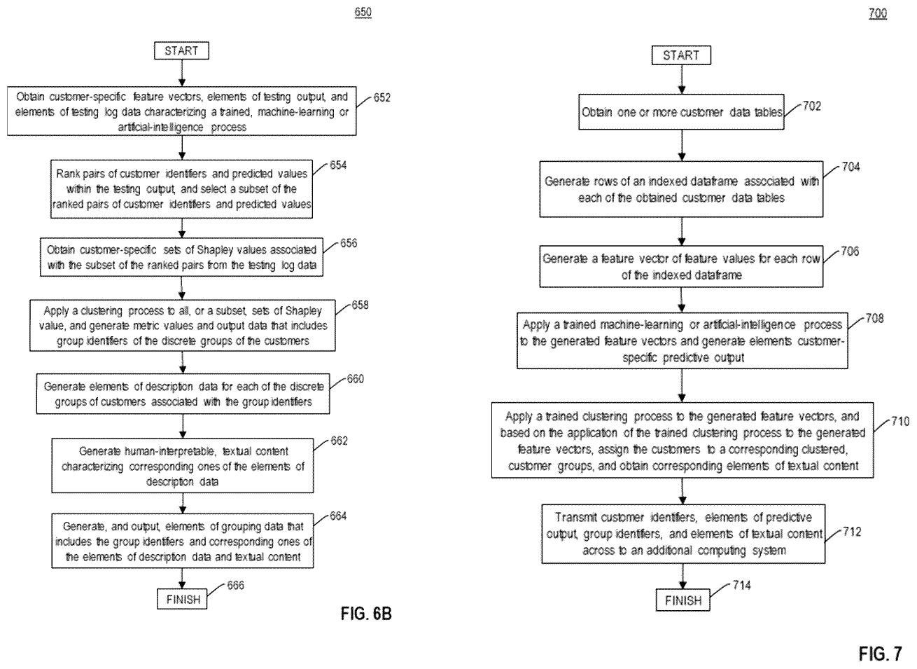

FIG. 6A is a flowchart of an exemplary process 600 for training adaptively a machine-learning or artificial-intelligence process to predict a likelihood of an occurrence, or a non-occurrence, of a target event involving a customer of the organization during a future, target temporal interval. The target event may correspond to an attrition event involving the customer of the organization and with one more provisioned services, and each attrition event may be associated with a corresponding attrition date (e.g., a date on which the corresponding customer ceases participating in, or “attrites” from, the one more provisioned services). By way of example, an attrition event involving a small-business customer of a financial institution may occur when that small-business customer ceases participation in one or more of the small-business banking services provisioned to that small-business banking customer by the financial institution, e.g., on a corresponding attrition date.

Further, in some instances, the machine-learning or artificial-intelligence process may include an ensemble or decision-tree process, such as a gradient-boosted decision-tree process (e.g., the XGBoost process), and one or more of the exemplary, adaptive training processes described herein may utilize partitioned training and validations datasets associated with a first prior temporal interval (e.g., an in-time training and validation interval), and testing datasets associated with a second, and distinct, prior temporal interval (e.g., an out-of-time testing interval). As described herein, one or more computing systems, such as, but not limited to, one or more of the distributed components of computing system 130, may perform one or of the steps of exemplary process 600.

Referring to FIG. 6A, computing system 130 may establish a secure, programmatic channel of communication with one or more source computing systems, such as source systems 110 of FIG. 1A, and may perform operations that obtain, from the source computing systems, one or more source data tables identifying and characterizing corresponding customers, and attrition events involving these customers, during one or more prior temporal intervals (e.g., in step 602 of FIG. 6A). As described herein, the source data tables may include, but are not limited to, elements of profile, account, transaction engagement, attrition, and reporting data associated with corresponding ones of the customers during the one or more prior temporal intervals, and in some instances, computing system 130 may perform the exemplary processes described herein to obtain and ingest the elements of profile, account, transaction engagement, attrition, and reporting data in accordance with a predetermined temporal schedule (e.g., on a monthly basis at a predetermined date or time, etc.), or a continuous streaming basis, across the secure, programmatic channel of communication.

In some instances, computing system 130 may access the source data tables (e.g., the profile, account, transaction engagement, attrition, and reporting data described herein), and generate one or more processed source data tables based on an application of one or more preprocessing operations to corresponding ones of the source data tables (e.g., in step 604 in FIG. 6A). As described herein, computing system 130 may store each of the processed data tables within one or more accessible data repositories, such as source data store 134 (e.g., also in step 604 of FIG. 6A).

Computing system 130 may also perform any of the exemplary processes described herein to generate an indexed dataframe associated each of the processed data tables, and to generate a ground-truth label associated with each row of the generated indexed dataframe (e.g., in step 604 of FIG. 6A). In some instances, described herein, computing system 130 may perform operations that append each of the generated ground-truth label to a corresponding row of the indexed dataframe, and package the rows of the indexed dataframe and the appended ground-truth labels into an indexed, labelled dataframe (e.g., also in step 604 of FIG. 6A).

In some instances, computing system 130 may perform any of the exemplary processes described herein to decompose the rows of the labelled, indexed dataframe (e.g., the rows of the indexed dataframe and the appended ground-truth labels) into (i) a first subset having temporal identifiers associated with a first prior temporal interval and (ii) a second subset having temporal identifiers associated with a second prior temporal interval, which may be separate, distinct, and disjoint from the first prior temporal interval (e.g., in step 606 of FIG. 6A). Computing system 130 may also perform any of the exemplary processes described herein to partition the rows of within the first subset into (i) an in-sample training subset of rows appropriate to train adaptively the machine-learning or artificial process (e.g., the gradient-boosted decision process described herein) during the first prior temporal interval and (ii) an out-of-sample validation subset of the rows appropriate to validate the adaptively trained gradient-boosted decision process during the first prior temporal interval (e.g., in step 608 of FIG. 6A). Additionally, and as described herein, the second subset of the rows may be appropriate to test an accuracy or a performance of the adaptively trained gradient-boosted decision process using elements of testing data associated with the second temporal interval.

In some instances, computing system 130 may perform any of the exemplary processes described herein to generate one or more initial training datasets (e.g., the vectorized training dataframes described herein) based on data maintained within the in-sample training subset of rows, and additionally, or alternatively, based on the processed data tables that maintain elements of ingested customer profile, account, transaction, or reporting data (e.g., in step 610 of FIG. 6A). As described herein, each of the plurality of initial training datasets may include a corresponding row of the in-sample training subset (which includes a corresponding ground-truth label) and a corresponding feature vector, and based on the plurality of training datasets, computing system 130 may also perform any of the exemplary processes described herein to train adaptively the machine-learning or artificial-intelligence process (e.g., the gradient-boosted decision-tree process described herein) to predict a likelihood of an occurrence, or a non-occurrence, of a target event involving a customer of an organization during a future, target temporal interval (e.g., in step 612 of FIG. 6A). For example, and as described herein, computing system 130 may perform operations that establish a plurality of nodes and a plurality of decision trees for the gradient-boosted, decision-tree process, which may ingest and process the elements of training data maintained within each of the initial training datasets, and that train adaptively the gradient-boosted, decision-tree process against the elements of training data included within each of the initial training datasets.

Through the performance of these adaptive training processes, computing system 130 and may perform operations, described herein, that compute one or more candidate process parameters that characterize the adaptively trained, gradient-boosted, decision-tree process, and to generate elements of process data that include the candidate process parameters, such as, but not limited to, those described herein (e.g., in step 614 of FIG. 6A). Further, and based on the performance of these adaptive training processes, computing system 130 may perform any of the exemplary processes described herein to generate composition data, which specifies a candidate composition and sequence of feature values of an input dataset for the adaptively trained machine-learning or artificial intelligence process, such as the adaptively trained, gradient-boosted, decision-tree process (e.g., also in step 614 of FIG. 6A).

In some instances, computing system 130 may also perform any of the exemplary processes described herein to, based on the elements of trained input data and trained process data, validate the trained gradient-boosted, decision-tree process against elements of in-time, but out-of-sample, data records of the out-of-time validation subset. For example, computing system 130 may perform any of the exemplary processes described herein generate a plurality of validation datasets (e.g., the vectorized validation dataframes described herein) based on the validation subset of rows, and in some instances, based on temporally relevant portions of the processed data tables (e.g., in step 616 of FIG. 6A). As described herein, a composition, and a sequential ordering, of features values within each of validation datasets may be consistent with the composition and corresponding sequential ordering set forth in the composition data, and each of validation datasets may be associated with a corresponding ground-truth label.

Computing system 130 may perform any of the exemplary processes described herein to apply the adaptively trained machine-learning or artificial intelligence process (e.g., the adaptively trained, gradient-boosted, decision-tree process described herein) to respective ones of the validation datasets in accordance with the process parameters, and to generate corresponding elements of output data based on the application of the adaptively trained machine-learning or artificial intelligence process to the respective ones of the validation datasets (e.g., in step 618 of FIG. 6A). In some instances, computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data, corresponding ones of the validation datasets, and the respective ground-truth labels (e.g., in step 620 of FIG. 6A), and to determine whether all, or a selected portion of, the computed metric values satisfy one or more threshold requirements for a validation of the adaptively trained machine-learning or artificial intelligence process, such as those described herein (e.g., in step 622 of FIG. 6A).

If, for example, computing system 130 were to establish that one, or more, of the computed metric values fail to satisfy at least one of the threshold requirements (e.g., step 622; NO), computing system 130 may establish that the adaptively trained, gradient-boosted, decision-tree process is insufficiently accurate for deployment and a real-time application to the elements of profile, account, transaction, engagement, attrition, and reporting data described herein. Exemplary process 400 may, for example, pass back to step 610, and computing system 130 may perform any of the exemplary processes described herein to generate additional training datasets based on the rows of the labelled, indexed dataframe maintained within the in-time raining subset.

Alternatively, if computing system 130 were to establish that each computed metric value satisfies threshold requirements (e.g., step 622; YES), computing system 130 may validate the adaptive training of the gradient-boosted, decision-tree process, and may generate validated process data that includes the one or more validated process parameters of the adaptively trained, gradient-boosted, decision-tree process (e.g., in step 624 of FIG. 6A) Further, computing system 130 may also generate validated input data, which characterizes a composition of an input dataset for the adaptively trained, and now validated, gradient-boosted, decision-tree process and identifies each of the discrete feature values within the feature vectors, along with a sequence or position of these feature values within the feature vector (e.g., also in step 624 of FIG. 6). Computing system 130 may also perform operations that store the validated process data and the validated input data within the one or more tangible, non-transitory memories of computing system 130 (e.g., also in step 624 of FIG. 6A).

Further, in some examples, computing system 130 may perform operations that further characterize an accuracy, and a performance, of the adaptively trained, and now-validated, gradient-boosted, decision-tree process against elements of testing data associated with the during the second temporal interval and maintained within the second subset of the rows of the labelled, indexed dataframe. As described herein, the further testing of the adaptively trained, and now-validated, gradient-boosted, decision-tree process against the elements of temporally distinct testing data may confirm a capability of the adaptively trained and validated, gradient-boosted, decision-tree process to predict the likelihood of the occurrence, or the non-occurrence, of the target event involving the customer during a future, target temporal interval, and may further establish the readiness of the adaptively trained and validated, gradient-boosted, decision-tree process for deployment and real-time application to the elements of elements of profile, account, transaction, engagement, attrition, and reporting data.

Referring back to FIG. 6A, computing system 130 may perform any of the exemplary processes described herein generate a plurality of testing datasets (e.g., the vectorized testing dataframes described herein) based on the second subset of the rows of the labelled, indexed dataframe, and in some instances, based on temporally relevant elements of previously ingested profile, account, transaction, engagement, attrition, and reporting data (e.g., in step 626 of FIG. 6A). As described herein, a composition, and a sequential ordering, of features values within each of testing datasets may be consistent with the composition and corresponding sequential ordering set forth in the validated input data, and each of the testing datasets may be associated with a corresponding ground-truth label.

Computing system 130 may perform any of the exemplary processes described herein to apply the adaptively trained machine-learning or artificial intelligence process (e.g., the adaptively trained, gradient-boosted, decision-tree process described herein) to respective ones of the testing datasets in accordance with the validated process parameters, and to generate corresponding elements of output data based on the application of the adaptively trained machine-learning or artificial intelligence process to the respective ones of the testing datasets (e.g., in step 628 of FIG. 6A). For example, computing system 130 may perform operations, described herein, to establish the plurality of nodes and the plurality of decision trees for the gradient-boosted, decision-tree process in accordance with each, or a subset, of the validated process parameters, as described herein.

In some instances, in step 630 of FIG. 6A, computing system 130 may perform any of the exemplary processes described herein to apply the adaptively trained, and validated, gradient-boosted, decision-tree process to the elements of the out-of-time data maintained within respective ones of the testing datasets, e.g., based on an ingestion and processing of the data maintained within respective ones of the testing datasets by the established nodes and decision trees of the adaptively trained, gradient-boosted, decision-tree process. Further, computing system 130 may also perform operations, described herein, that generate elements of output data through the application of the adaptively trained, gradient-boosted, decision-tree process to corresponding ones of the testing datasets (e.g., also in 630 of FIG. 6A).

Computing system 130 may also perform any of the exemplary processes described herein to compute a value of one or more additional metrics that characterize a predictive capability, and an accuracy, of the adaptively trained, and validated, gradient-boosted, decision-tree process based on the generated elements of output data, corresponding ones of the testing datasets, and corresponding ones of the ground-truth labels (e.g., in step 632 of FIG. 6A), and to determine whether all, or a selected portion of, the computed additional metric values satisfy one or more additional threshold requirements for a deployment of the adaptively trained machine-learning or artificial intelligence process, such as those described herein (e.g., in step 634 of FIG. 6A).

In some examples, the threshold condition applied by computing system 130 to establish the readiness of the adaptively trained machine-learning or artificial intelligence process for deployment (e.g., in step 632) may be equivalent to those threshold conditions applied by computing system 130 to validate the adaptively trained machine-learning or artificial intelligence process. In other instances, the threshold conditions, or a magnitude of one or more of the threshold conditions, applied by computing system 130 may differ between the establishment of the readiness of the adaptively trained machine-learning or artificial intelligence process for deployment in step 632 and the validation of the adaptively trained machine-learning or artificial intelligence process in step 622.

If, for example, computing system 130 were to establish that one, or more, of the computed additional metric values fail to satisfy at least one of the threshold requirements (e.g., step 632; NO), computing system 130 may establish that the adaptively trained machine-learning or artificial-intelligence process (e.g., the adaptively trained, gradient-boosted, decision-tree process) is insufficiently accurate for deployment and real-time application to the elements of profile, account, transaction, engagement, attrition, and reporting data described herein. Exemplary process 600 may, for example, pass back to step 612, and computing system 130 may perform any of the exemplary processes described herein to generate additional training datasets based on the rows of the labelled, indexed dataframe maintained within the in-time training subset.

Alternatively, if computing system 130 were to establish that each computed additional metric value satisfies threshold requirements (e.g., step 632; YES), computing system 130 may deem the machine-learning or artificial intelligence process (e.g., the gradient-boosted, decision-tree process described herein) adaptively trained and ready for deployment and real-time application to the elements of customer profile, account, transaction, credit performance, or credit-bureau data, and may perform any of the exemplary processes described herein to generate deployed process data that includes the validated process parameters and deployed input data associated with the of the adaptively trained machine-learning or artificial intelligence process (e.g., in step 634 of FIG. 6A). Exemplary process 600 is then complete in step 636.

FIG. 6B is a flowchart of an exemplary process 650 for training adaptively a machine-learning or artificial-intelligence process to assign at least a subset of customers associated with likely occurrences of attrition events during a target, future temporal intervals to clustered groups associated with descriptive, and interpretable, feature values or ranges of feature values, e.g., based on explainability data characterizing the trained machine-learning or artificial-intelligence process. In some instances, the machine-learning or artificial-intelligence process may correspond to an unsupervised machine-learning process, such as a clustering process, and one or more computing systems, such as, but not limited to, one or more of the distributed components of computing system 130, may perform one or of the steps of exemplary process 600.

Referring to FIG. 6B, computing system 130 may perform any of the exemplary processes described herein to obtain customer-specific feature vectors, elements of testing output, and elements of testing log data characterizing a trained, machine-learning or artificial-intelligence process such as the trained, gradient-boosted decision-tree process described hereon (e.g., in step 652 of FIG. 6B). Computing system 130 may also perform operations that rank pairs of customer identifiers and predicted values within the testing output in accordance with the magnitude of the predicted values, e.g., from highest predicted likelihood of the occurrence of the attrition event due to the target, future temporal interval, and select a subset of the ranked pairs of customer identifiers and predicted values in accordance with a threshold population metric value (e.g., in step 654 of FIG. 6B).

Computing system 130 may also perform operations, in step 656 of FIG. 6B, that access elements of explainability data maintained within the testing log data and obtain sets of Shapley values that characterize the application of the trained, gradient-boosted, decision tree process to the features vectors associated with the customer identifiers maintained within the obtained subset. In some instances, computing system 130 may package the obtained sets of Shapley values into corresponding portions of sampling data, along with corresponding ones of the customer identifiers, and provide subset 306 and sampling data 308 as inputs to a clustering module 310.

Further, in step 658 of FIG. 6B, computing system 130 the exemplary processes described herein to apply the clustering process to all, or a selected subset, of the feature-specific Shapley values, e.g., which characterize a relative contribution and a relative importance of corresponding ones of the feature values to the predicted values, and which are generated through the application of the trained, gradient-boosted, decision-tree process to corresponding feature vectors. Based on the application of the clustering process to all, or the selected subset, of the feature-specific Shapley values, computing system 130 may generate output data that includes group identifiers of the discrete, clustered groups of the customers (e.g., also in step 658 of FIG. 6B), and for each of discrete, clustered groups, the output data may associate a corresponding one of the group identifiers with the customer identifiers of the customers within the corresponding clustered group. Further, computing system 130 may also perform operations that compute one or more metric values 323 that facilitate an interpretation, and a validation of a consistency, of the clustered groups of customers established through the application of the clustering process to the sampling data 308, such as, but not limited to, a customer-specific silhouette values characterize a similarity of a corresponding customer to its assigned, clustered group when compared to other clustered groups (e.g., also in step 658 of FIG. 6B).

In some instances, computing system 130 may perform any of the exemplary processes described herein to generate, for each of the discrete, clustered groups, elements of description data that include a value of one or more feature values, or a range of one or more feature values, that characterize the customers clustered into the clustered group associated with the corresponding group identifier (e.g., in step 660 of FIG. 6B), and to generate elements of human-interpretable, textual content characterizing corresponding ones of the elements of description data and associated with corresponding ones of the group identifiers (e.g., in step 662 of FIG. 6B). Further, computing system 130 may perform any of the exemplary processes described herein to generate, and output, elements of grouping data that includes the group identifiers and corresponding ones of the elements of description data and textual content (e.g., in step 664 of FIG. 6B). Exemplary process 640 is complete in step 666.

FIG. 7 is a flowchart of an exemplary process 700 for predicting a likelihood of an occurrence, or a non-occurrence, of a target event involving a customer of the organization during a future, target temporal interval, and for generating elements of explainability data that characterizes the predicted likelihood of the occurrence of the target event involving the customers, using multiple, trained machine-learning or artificial intelligence processes. The target event may correspond to an attrition event involving the customer of the organization and with one more provisioned services, and each attrition event may be associated with a corresponding attrition date (e.g., a date on which the corresponding customer ceases participating in, or “attrites” from, the one more provisioned services). By way of example, an attrition event involving a small-business customer of a financial institution may occur when that small-business customer ceases participation in one or more of the small-business banking services provisioned to that small-business banking customer by the financial institution, e.g., on a corresponding attrition date. Further, and as described herein, one or more computing systems, such as, but not limited to, one or more of the distributed components of computing system 130, may perform one or of the steps of exemplary process 700.

Referring to FIG. 7, computing system 130 may obtain one or more customer data tables associated with corresponding customers of the organization, such as, but not limited to, a small-business banking customer that participates on one or more small-business banking services provisioned by the financial institution (e.g., in step 702 of FIG. 7). In some instances, computing system 130 may perform any of the exemplary processes to generate rows of an indexed dataframe associated with each of the obtained customer data tables (e.g., in step 704 of FIG. 7). As described herein, each row of the indexed dataframe may include a unique customer identifier associated with the corresponding one of the customer data tables and a temporal identifier that identifies, and specifies, a temporal prediction point.

Computing system 130 may also perform any of the exemplary processes described herein to generate a feature vector of feature values for each row of the indexed dataframe (e.g., in step 706 of FIG. 7), and to apply a first, trained machine-learning or artificial-intelligence process to the generated feature vectors (e.g., in step 708 of FIG. 7). As described herein, the first, trained machine-learning or artificial-intelligence process may include an ensemble or decision-tree process, such as a gradient-boosted decision-tree process (e.g., the XGBoost process). Further, and based on the application of the first, trained machine-learning or artificial-intelligence process to the generated feature vectors, computing system 130 may perform any of the exemplary processes described herein to generate, for each row of the indexed dataframe, and for corresponding ones of the customers, an element of predictive output indicating a likelihood of an occurrence, or a non-occurrence, of a target event involving the corresponding customer during a future, target temporal interval (e.g., also in step 708 of FIG. 7).

Further, in some instances, computing system 130 may also perform operations that apply a second, trained machine-learning or artificial-intelligence process to corresponding ones of the customer-specific feature vectors (e.g., in step 710 of FIG. 7). As described herein, the second, trained machine-learning or artificial-intelligence process may correspond to an unsupervised machine-learning process, such as clustering process, and based on the application of the clustering process to the customer-specific feature vectors, computing system 130 may perform any of the exemplary processes described herein to assign each of the customers to a corresponding one of the clustered groups, and obtain one or more elements of textual content that interpret or “explain” the predicted likelihood of an occurrence of an attrition event involving the corresponding customer during the target, future temporal interval (e.g., also in step 710 of FIG. 7).

Computing system 130 may also perform any of the exemplary processes described herein to associate each of the customer identifiers with a corresponding element of predictive output, and with a corresponding group identified of the assigned, clustered group and the elements of textual content, and transmit the associate customer identifiers, elements of predictive output, group identifiers, and elements of textual content across network 120 to an additional computing system associated with the organization (e.g., in step 712 of FIG. 7). Exemplary process 700 is complete in step 714.

### C. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to application programming interfaces (APIs) 136, 408, and 506, ingestion engine 138, stateless orchestration engine 140, training pipeline script 144, retrieval engine 146, preprocessing engine 148, indexing and target-generation engine 162, splitting engine 164, feature-generation engine 166, AI/ML training engine 168, explainability engine 170, artifact management engine 183, pipeline fitting module 234, featurizer pipeline scripts 238, 262, and 428, featurizer module 240, sampling module 304, clustering module 310, interpretation module 324, inferencing engine 464, explainability engine 478, responding engine 502, and provisioning application 508, can be implemented as one or more computer programs, i.e., one or more modules of computer program instructions encoded on a tangible non-transitory program carrier for execution by, or to control the operation of, a data processing apparatus (or a computer system or a computing device).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” (e.g., the computing system and the device described herein) refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto optical disks; and CD ROM and DVD-ROM disks. The processor and the memory can be supplemented by, or incorporated in, special purpose logic circuitry.

To provide for interaction with a user (e.g., the customer or employee described herein), embodiments of the subject matter described in this specification can be implemented on a computer having a display unit, such as a CRT (cathode ray tube) or LCD (liquid crystal display) monitor, a TFT display, or an OLED display, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back end component, such as a data server, or that includes a middleware component, such as an application server, or that includes a front end component, such as a computer having a graphical user interface or a Web browser through which a user can interact with an implementation of the subject matter described in this specification, or any combination of one or more such back end, middleware, or front end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. The section headings used herein are for organizational purposes only, and are not to be construed as limiting the described subject matter.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

What is claimed is:

1. An apparatus, comprising:
a memory storing instructions;
a communications interface; and
at least one processor coupled to the memory and to the communications interface, the at least one processor being configured to execute the instructions to:
receive first interaction data from a computing system via the communications interface, the first interaction data being associated with a first temporal interval;
based on an application of a first trained artificial-intelligence process to an input dataset that includes at least a subset of the first interaction data, generate output data indicative of a predicted likelihood of an occurrence of a target event during a second temporal interval;
based on an application of a second trained artificial-intelligence process to the input dataset, generate explainability data that characterizes the predicted likelihood of the occurrence of the targeted event; and
transmit, via the communications interface, notification data that includes the output data and the explainability data to the computing system, the notification data causing the computing system to modify an operation of an executed application program in accordance with at least one of a portion of the output data or a portion of the explainability data.

2. The apparatus of claim 1, wherein:
The first interaction data characterizes a participant in a service during the first temporal interval, the service being provisioned by the computing system;
the target event comprises an attrition event involving the participant and the provisioned service; and
the output data indicates of the predicted likelihood of the occurrence of the attrition event during the second temporal interval.

3. The apparatus of claim 2, wherein the notification data further causes the executed application program to:
generate or modify second interaction data in accordance with the explainability data; and
transmit at least a portion of the second interaction data to a device operable by the participant.

4. The apparatus of claim 1, wherein the at least one processor is further configured to execute the instructions to:
obtain (i) data that characterizes a composition of the input dataset and (ii) a value of one or more process parameters that characterize the first trained artificial-intelligence process;
generate the input dataset in accordance with the data that characterizes the composition; and
apply the first trained artificial-intelligence process to the input dataset in accordance with the one or more process parameters values.

5. The apparatus of claim 4, wherein:
the data that characterizes the composition of the input dataset comprises at least one script; and
the at least one processor is further configured to execute the instructions to execute the at least one script, the at least one executed script causing the at least one processor to:
perform operations that (i) extract a first feature value from at least a portion of the first interaction data and that (ii) compute a second feature value based on at least the portion of the first interaction data; and
generate the input dataset based on at least one of the extracted first feature value or the computed second feature value.

6. The apparatus of claim 1, wherein:
The first trained artificial-intelligence process comprises a trained, gradient-boosted, decision-tree process; and
the second temporal interval is subsequent to the first temporal interval and separated from the first temporal interval by a buffer interval.

7. The apparatus of claim 1, wherein:
the second trained artificial-intelligence process comprises a trained clustering process; and
the at least one processor is further configured to execute the instructions to:
obtain one or more parameter values that characterize the second trained artificial-intelligence process, the one or more parameter values comprising at least one of a (i) feature value or a (ii) range of feature values that characterize each of a plurality of clustered groups;
apply the trained second trained artificial-intelligence process to the input dataset in accordance with the one or more parameter values; and
based on the application of the second trained artificial-intelligence process to the input dataset, perform operations that assign the participant to a corresponding one of the clustered groups in accordance with the one or more parameter values.

8. The apparatus of claim 7, wherein:
the first interaction data characterizes a participant in a service during the first temporal interval;
the input dataset is associated with the participant and is consistent with the at least one of the feature value or the range of feature values associated with the corresponding one of the clustered groups; and
the explainability data comprises an identifier of the corresponding one of the clustered groups and elements of textual content that characterize the feature value or the range of feature values.

9. The apparatus of claim 7, wherein the notification data further causes the executed application program to:
generate or modify second interaction data in accordance with at least a portion of the explainability data; and
transmit at least a portion of the second interaction data to a device operable by the participant and to an additional device operable by an additional participant assigned to the corresponding one of the clustered groups.

10. The apparatus of claim 1, wherein the at least one processor is further configured to execute the instructions to:
obtain elements of third interaction data, each of the elements of third interaction data comprising a temporal identifier associated with a temporal interval;
based on the temporal identifier, determine that a first subset of the elements of third interaction data is associated with a first prior interval, and that a second subset of the elements of the third interaction data is associated with a second prior interval;
perform operations that decompose the first subset into a training partition and a validation partition; and
generate a plurality of training datasets based on corresponding ones of the elements of third interaction data associated with the training partition, and perform operations that train a third artificial intelligence process based on the training datasets.

11. The apparatus of claim 10, wherein the at least one processor is further configured to execute the instructions to:
generate a plurality of validation datasets based on corresponding ones of the elements of the third interaction data associated with the validation partition;
apply the third additional artificial intelligence process to the plurality of validation datasets in accordance with a value of one or more process parameters, and generate additional elements of output data based on the application of the trained first artificial intelligence process to the plurality of validation datasets;
compute one or more validation metrics based on the additional elements of output data; and
determine whether the one or more validation metrics are consistent with a threshold condition; and
based on a determination that the one or more validation metrics are inconsistent with the threshold condition, perform operations that modify the value of at least one of the process parameters, and that apply the third artificial intelligence process to the plurality of validation datasets in accordance with the at least one modified value of the process parameters.

12. The apparatus of claim 11, wherein the at least one process is further configured to execute the instructions to:
based on a determined consistency between the one or more validation metrics and the threshold condition, validate the third intelligence process and generate a plurality of testing datasets based on corresponding ones of the elements of third interaction data associated with the second subset;
apply the third artificial intelligence process to the plurality of testing datasets, and generate further elements of output data based on the application of the third artificial intelligence process to the plurality of testing datasets;
compute one or more testing metrics based on the further elements of output data; and
based on a determined consistency between the one or more testing metrics and the threshold condition, generate (i) values of process parameters that characterize the third artificial intelligence process and (ii) data that characterizes a composition of a corresponding input dataset for the third artificial intelligence process.

13. The apparatus claim 1, wherein the at least one processor is further configured to execute the instructions to
obtain (i) data that characterizes a composition of the input dataset and (ii) a value of one or more process parameters that characterize the first trained artificial-intelligence process;
generate the input dataset in accordance with data that characterizes a composition of the input dataset;
apply the first trained artificial-intelligence process to the input dataset in accordance with one or more first process parameters values, and apply the second trained artificial-intelligence process to the input dataset in accordance with one or more second process parameters values;
obtain elements of monitoring data characterizing a performance of at least one of the trained first artificial-intelligence process or the trained second artificial-intelligence process during a third temporal interval; and
based on the monitoring data, perform operations that modify at least one of the composition of the input dataset, the one or more first process parameter values, or the one or more second process parameter values.

14. A computer-implemented method, comprising:
receiving, using at least one processor, first interaction data from a computing system, the first interaction data being associated with a first temporal interval;
based on an application of a first trained artificial-intelligence process to an input dataset that includes at least a subset of the first interaction data, generating, using the at least one processor, output data indicative of a predicted likelihood of an occurrence of a target event during a second temporal interval;
based on an application of a second trained artificial-intelligence process to the input dataset, generating, using the at least one processor, explainability data that characterizes the predicted likelihood of the occurrence of the targeted event; and
transmitting, using the at least one processor, notification data that includes the output data and the explainability data to the computing system, the notification data causing the computing system to modify an operation of an executed application program in accordance with at least one of a portion of the output data or a portion of the explainability data.

15. The computer-implemented method of claim 14, wherein:
the first interaction data characterizes a participant in a service during the first temporal interval, the service being provisioned by the computing system;
the target event comprises an attrition event involving the participant and the provisioned service; and
the output data indicates of the predicted likelihood of the occurrence of the attrition event during the second temporal interval.

16. The computer-implemented method of claim 15, wherein the notification data further causes the executed application program to:
generate or modify second interaction data in accordance with the explainability data; and
transmit at least a portion of the second interaction data to a device operable by the participant.

17. The computer-implemented method of claim 14, further comprising:
obtaining, using the at least one processor, (i) data that characterizes a composition of the input dataset and (ii) a value of one or more process parameters that characterize the first trained artificial-intelligence process;
generating, using the at least one processor, the input dataset in accordance with the data that characterizes the composition; and
using the at least one processor, applying the first trained artificial-intelligence process to the input dataset in accordance with the one or more process parameters values.

18. The computer-implemented method of claim 14, wherein:
the second trained artificial-intelligence process comprises a trained clustering process; and
the computer-implemented method further comprises:
obtaining, using the at least one processor, one or more parameter values that characterize the second trained artificial-intelligence process, the one or more parameter values comprising at least one of a (i) feature value or a (ii) range of feature values that characterize each of a plurality of clustered groups;
using the at least one processor, applying the trained second trained artificial-intelligence process to the input dataset in accordance with the one or more parameter values; and
based on the application of the second trained artificial-intelligence process to the input dataset, performing operations, using the at least one processor, that assign the participant to a corresponding one of the clustered groups in accordance with the one or more parameter values.

19. The computer-implemented method of claim 18, wherein:
the interaction data characterizes a participant in a service during the first temporal interval;
the input dataset is associated with the participant and is consistent with the at least one of the feature value or the range of feature values associated with the corresponding one of the clustered groups; and
the explainability data comprises an identifier of the corresponding one of the clustered groups and elements of textual content that characterize the feature value or the range of feature values.

20. An apparatus, comprising:
a memory storing instructions;
a communications interface; and
at least one processor coupled to the memory and to the communications interface, the at least one processor being configured to execute the instructions to:
transmit interaction data to a computing system via the communications interface, the interaction data being associated with a first temporal interval;
receive, from the computing system via the communications interface, (i) output data indicative of a predicted likelihood of an occurrence of a target event during a second temporal interval and (ii) explainability data that characterizes the predicted likelihood of the occurrence of the targeted event, the computing system generating the output data based on an application of a first trained artificial-intelligence process to an input dataset that includes at least a subset of the interaction data, and the computing system generating the explainability data based on an application of a second trained artificial-intelligence process to the input dataset; and
perform operations that modify an operation of an executed application program in accordance with the portion of the output data and the explainability data.
